(19) United States
(12) Patent Application Publication
(10) Pub. No.: US 2025/0172722 A1
(43) Pub. Date: May 29, 2025

(54) METHOD AND APPARATUS FOR AN OPHTHALMIC DEVICE TO REDIRECT LIGHT TO SPECIFIC REGIONS OF AN EYE

(71) Applicant: Atheneum Optical Sciences, LLC, Orange Park, FL (US)

(72) Inventors: W. Anthony Martin, Orange Park, FL (US); Randall Pugh, Jacksonville, FL (US); Ganesh Narayanan Kumar, Ponte Vedra Beach, FL (US)

(73) Assignee: Atheneum Optical Sciences, LLC, Orange Park, FL (US)

(21) Appl. No.: 18/963,974

(22) Filed: Nov. 29, 2024

Related U.S. Application Data
(60) Provisional application No. 63/604,162, filed on Nov. 29, 2023.

(51) Int. Cl. G02B 1/04; B29D 11/00

(52) U.S. Cl. CPC G02B 1/043; B29D 11/00269

(57) ABSTRACT

Improved ophthalmic devices including optical sub-elements with custom design for directing images to specific portions of a patient's retina. The optical sub-elements may be used to direct images along a direction divergent from a central axis of the lens base. By redirecting images along divergent directions, ophthalmic devices according to the present invention allow users with specialized needs, such as low light conditions and/or retinal damage to utilize undamaged regions of the retina to have a higher degree of vision capability.

### CROSS REFERENCE TO RELATED APPLICATIONS

This application claims the benefit of U.S. Provisional application No. 63/604,162, filed on Nov. 29, 2023, and entitled METHOD AND APPARATUS FOR A CONTACT LENS TO REDIRECT LIGHT TO SPECIFIC REGIONS OF AN EYE, the entire disclosure of which is incorporated herein by reference.

### FIELD OF THE INVENTION

The present invention relates to adapting vision for optimal a vision, such as, for low light conditions and for retinal damage care with an ophthalmic lens, and in particular, to methods and apparatus for forming an ophthalmic device by integration of optical sub-elements to achieve the adaptation of vision to specific areas of an eye.

### BACKGROUND OF THE INVENTION

There are numerous types of damage and illnesses which can affect the retina of a human eye. In some examples, structures of the central vision sensing system of the retina may be damaged, which may have profound effects on normal vision. Although the most sensitive and highest acuity regions may be damaged, there may be significant regions of the retina that are not affected by the damage process. Although the central vision is specialized, when it is profoundly damaged, it may be possible to provide an improved vision result if images can be focused away from the damaged areas. It would be desirable to have designs of contact lens that can redirect images away from damage. Furthermore, it would be desirable to have means to produce such lenses.

### SUMMARY OF THE INVENTION

Accordingly, the present invention provides methods and ophthalmic devices for improved vision in cases of retinal damage.

In some embodiments, a method may include obtaining a data record from a retinal scan of a patient with a retinal scan. As described herein there may be numerous types of retinal damage and associated lens-based strategies to improve a level of vision for them. The retinal scan may be used to support the development of models for how a lens may optimally function. Therefore, methods may also include analyzing the data record from the retinal scan and determining at least a first portion of the retina with a minimal amount of damage to project an image upon. The shape of the cornea and parameters of the crystalline lens of a user may be obtained by standard metrology methods as well to use for customized modelling of a lens product to be printed utilizing methods as described herein. Accordingly, the method may also include calculating a structure of an optical sub-element, wherein the structure comprises a means to focus images to the first portion of the retina with a minimal amount of damage. The methods may also include forming a digital model to control a print head to form the lens with the optical sub element.

Some embodiments of the present disclosure may include a method of forming an ophthalmic device via additive manufacturing, the method may include the steps of positioning a substrate at a first position relative to an additive manufacturing printhead and emitting a pattern of deposited droplets of polymerizable mixture from the printhead. Some specific embodiments include the pattern of deposited droplets of polymerizable mixture corresponding with a portion of an energy transmissibility map of an ophthalmic lens being formed.

Some embodiments of the present invention include receiving deposited droplets of polymerizable mixture on a receiving surface, the receiving surface including one or both of: a substrate, and insert, and previously emitted polymerizable mixture. Embodiments may include repositioning the substrate from a first position to a next position (current position plus N) relative to a printhead. Repositioning may be accomplished via movement of one or both of the substrate and the printhead.

Additionally, variants of the present invention may include emitting a next pattern of deposited droplets of polymerizable mixture (first position plus N) corresponding with a next portion of the energy transmissibility map of the ophthalmic lens being formed. Multiple emissions may occur during a pass of the printhead relative to the receiving surface, which may include the substrate.

Some variants of the present invention may include integrating material from deposited droplets of polymerizable mixture on the receiving surface and exposing the integrated material to a pinning process causing partial polymerization of the deposited droplets of polymerizable mixture. Following a pass of the printhead, one or more of gravity, surface tension and microforces, such as Vander Waals forces may be allowed to act on at least some of the deposited droplets to smooth the polymerizable mixture on the receiving surface, such as leveling interstitial spaces between deposited droplets and/or anomalies caused by impact of droplets of polymerizable mixture. Following a pinning process, a partial cure process may also be implemented.

In some embodiments, at least some of the droplets of polymerizable mixture deposited during a current pass may be integrated with polymerizable mixture previously deposited onto the receiving surface to form a same volume, which may include a single volume of polymerizable mixture on the substrate. Embodiments may also include pinning deposited droplets on a receiving surface via partial polymerization of the of deposited droplets and/or partial curing of deposited droplets. A final cure of aggregated deposited droplets of polymerizable mixture may also be performed. Integration of deposited droplets alleviates the disclosed processes from the requirement of a droplet maintaining a particular shape during deposition, upon impact, or following impact.

In some embodiments, a pinning process may include the step of exposing the deposited droplets of polymerizable mixture to a first wavelength of actinic radiation for a limited amount of time sufficient to cause gelation of the deposited droplets of polymerizable mixture, yet not cause curing of the deposited droplets.

A partial cure process may provide actinic conditions sufficient to cause incomplete curing of deposited droplets of polymerizable mixture, such as exposure of deposited droplets of polymerizable mixture for a period of time less than a time required for full polymerization.

Additionally, in some embodiments, a cure process may include a step of exposing deposited droplets of polymerizable mixture to actinic conditions, such as, for example, a second wavelength of actinic radiation for a sufficient time and of sufficient intensity to cause polymerization of deposited droplets of polymerizable mixture deposited in one or multiple cycles of droplet deposition.

In some aspects, the present invention provides for application of a pattern of multiple defined areas included within a single lens, with each area representing an amount of light transmissible through each respective associated area. Each area may have a designated amount of therapeutic agent and/or light transmissibility value based upon a scale, such as an 8 bit, 16 bit, 32 bit, 64 bit, 128 bit, or 256 bit scale (other scales are also within the scope of the present invention).

In some examples, a method of improving a vision capability may include using a digital model of a lens with one or more customized sub optical elements and emitting a first volume of polymerizable mixture from a printhead. The method may also include positioning a receiving surface comprising a substrate at a first position relative to an additive manufacturing printhead. Furthermore, the method may include emitting a first volume of polymerizable mixture from a printhead and receiving the first volume of polymerizable mixture onto a first receiving surface as a first pattern of deposited droplets. In some examples, the method may include performing a pinning process on the first volume of polymerizable mixture deposited onto the substrate forming a first volume of pinned polymerizable mixture.

The method may include emitting a second volume of polymerizable mixture from the printhead, and receiving the second volume of polymerizable mixture onto a second receiving surface comprising the first pattern of deposited droplets, as a second pattern of deposited droplets. In some examples, the method includes integrating the second volume of polymerizable mixture into the first volume of polymerizable mixture and performing an intermittent cure (or pinning process) on the second volume of polymerizable mixture. In some preferred embodiments, an intermittent cure will include formation of one or more polymer chains formed with polymerizable mixture included in the first volume of polymerizable mixture and polymerizable mixture included in the second volume of polymerizable mixture. The polymer chains formed may be included in a combined volume of polymerizable mixture formed from the first volume of polymerizable mixture and the second volume of polymerizable mixture.

Methods of the present invention may also include performing a final cure on the combined volume of polymerizable mixture.

The previous method options may also include examples wherein the second volume of polymerizable mixture is used to form an optical sub-element.

Alternatives may include a second volume of polymerizable mixture that includes a colorant additive, such as, without limitation, one or more of: a pigment, dye, colorant, or other material effecting coloration. In some embodiments, a colorant additive causes a shading level for light passing through the optical sub-element.

Still further examples may include a third volume of polymerizable mixture including a sufficient amount of colorant to create an opaque level for light passing through, and wherein the third volume is used to print upon the portions of the lens not including the optical sub-element.

In some examples, the previous methods may also include alternatives wherein the second volume of polymerizable mixture is used to print a shape that directs images to the first region. In some examples, the previous methods may also include alternatives wherein the second volume of polymerizable mixture is used to print a shape including a component of a Fresnel lens. In some examples, the previous methods may include alternatives wherein a second volume of polymerizable mixture is further processed to vary the second volume of polymerizable mixture's index of refraction.

In some examples, the previous methods may also include the steps of placing the lens upon a user's eye. In some of those examples, the method may further include training a user to recognize the altered presentation of the imagery by the lens.

Some embodiments include methods of improving a vision capability including one or more of the following steps. The method may include obtaining a data record from a retinal scan of a patient with a retinal scan. The method may include analyzing the data record from the retinal scan and determining at least a first portion of the retina with a minimal amount of damage to project an image upon. The method may further include calculating a structure of at least two optical sub-elements, wherein the structure comprises a means to focus images to the first portion of the retina with a minimal amount of damage from different directions.

A digital model may be generated to control a print head to emit multiple volumes of polymerizable mixture in predetermined patterns suitable to form a lens with the at least two optical sub-elements. Accordingly, the method may include emitting a first volume of polymerizable mixture from a printhead and subsequent volumes of polymerizable mixture from the printhead.

The method may also include positioning a receiving surface comprising a substrate at a first position relative to an additive manufacturing printhead. The method may include emitting a first volume of polymerizable mixture from the additive manufacturing printhead as a predefined pattern of droplets. The first volume of polymerizable mixture may be received onto a first receiving surface as a first pattern of deposited droplets.

A pinning process may be performed on the first volume of polymerizable mixture deposited onto the substrate forming a first volume of pinned polymerizable mixture. The method may include emitting a second volume of polymerizable mixture from the printhead. The method may include receiving the second volume of polymerizable mixture onto a second receiving surface comprising the first pattern of deposited droplets, as a second pattern of deposited droplets.

The method may include integrating the second volume of polymerizable mixture into the first volume of polymerizable mixture thereby forming a combined volume of polymerizable mixture. An intermittent cure may be performed on the combined volume of polymerizable mixture. In some preferred embodiments, the intermittent cure will include formation of a polymer chain extending into the polymerizable mixture of the first volume of polymerizable and the second volume of polymerizable mixture. Additional volumes of polymerizable mixture may also be made and integrated into the combined volume of polymerizable mixture via additional polymer chains.

A final cure may be performed on the combined volume.

The various aspects described herein for making a lens with at least one optical sub-element may also be implemented for forming two or more optical sub-elements.

In some aspects, an apparatus for improving a vision capability may result from the various methods described heretofore as well as described in following sections. Devices formed, described as lenses, may include a base lens structure formed of a polymerized mixture. The base lens structure may be formed to have a size to fit upon a user's eye. A lower surface of the base lens structure may include a shape defined by a receiving surface upon which polymerizable mixture is deposited.

Lenses formed according to the present invention may include an optical sub-element incorporated within and/or upon the base lens structure. An optical sub-element may direct light (seen by a patient as images) to a region not centered on a central axis of the base lens structure. The lens, when worn by a user, may also include examples where the base lens and optical sub-element focus images to a portion of the retina not centered upon the central fovea of the user's eye. In some cases, the apparatus for improving a vision capability may also include examples wherein the design of the optical sub-element uses a result from a retinal scan of a user as an input of the designing process.

### BRIEF DESCRIPTION OF THE DRAWINGS

FIG. 1 illustrates a schematic diagram of a lens with a side view, and an elevation view, according to some embodiments of the present invention.

FIG. 1A illustrates an exemplary additive manufacturing apparatus that may be used in some implementations of the present invention.

FIG. 1B illustrates a schematic diagram of mechanisms to introduce tilt into an additive manufacturing system.

FIG. 1C illustrates an exemplary graphical representation of optical powers available in an optical path through an ophthalmic lens according to the present invention.

FIG. 1D illustrates a schematic diagram of a printhead relative to a receiving substrate.

FIG. 1E illustrates electro active devices for providing camber movement to one or both of a printhead and a receiving substrate.

FIG. 2 is a schematic illustration of an alternative 3D printing apparatus according to some embodiments of the present invention.

FIG. 3 illustrates an exemplary energy intensity pattern, represented as a grayscale image, which may be used to generate control protocols for 3D printing apparatus according to some embodiments of the present invention.

FIG. 4 is a schematic illustration of a spherical lens with an identified periphery portion according to some embodiments of the present invention.

FIG. 5 is a schematic illustration of a profile cutaway view of a lens with a periphery portion and a carrier portion supporting an optic zone, according to some embodiments of the present invention.

FIG. 6 illustrates a graphical curve representing an exemplary hydrated surface of an ophthalmic lens that is formable according to the present invention.

FIG. 7 illustrates a graphical curve representing an exemplary unhydrated axial thickness of an ophthalmic lens that is formable according to the present invention.

FIG. 8 is a schematic illustration of a false color image of periphery region.

FIG. 9 is a schematic illustration of a false color image of the full lens thickness profile with a transition region zone.

FIG. 10 illustrates a false color image of a thickness profile for a periphery region zone of an astigmatic lens.

FIG. 11 illustrates a false color image of a thickness profile for an astigmatic lens.

FIG. 12 describes method steps that may be executed while practicing some implementations of the present invention.

FIGS. 13, 13A, and 13B are schematic illustrations of deposited droplets of polymerizable mixture integrating into a volume of polymerizable mixture previously deposited on a substrate.

FIG. 14 is a schematic illustration of an exemplary change in shape of a droplet of polymerizable mixture after release from a printhead.

FIGS. 15 and 15A illustrate a flowchart of method steps that may be executed in some implementations of the present invention.

FIGS. 16A, 16B, and 16C illustrate examples of lens composites including insert components.

FIGS. 17A, 17B, and 17C illustrate examples of lens composites including insert components and channels or regions of facilitated access of gases and liquids.

FIGS. 18A, 18B, and 18C illustrate examples of lens composites including annular insert components.

FIG. 19 illustrates an example of a lens composite including an annular insert, wherein the annular insert includes patterns.

FIG. 20 illustrates an example of a lens composite including an annular insert, wherein the annular insert includes electrically active components.

FIG. 21 illustrates an example of an annular insert, wherein the annular insert includes non-electrical components.

FIG. 22 illustrates an example of an insert, wherein the insert is an isolated component.

FIG. 23 illustrates exemplary methodology for composite lenses with inserts.

FIG. 24 illustrates exemplary methodology for composite lenses with inserts.

FIGS. 25, 25A, 25B, and 25C illustrate exemplary methodology for composite lenses with inserts.

FIGS. 26A-26E illustrate examples of lenses with incorporated therapeutic agents.

FIG. 26F illustrates examples of ophthalmic devices other than an ophthalmic lens.

FIG. 27 illustrates exemplary methodology for lenses incorporating therapeutic agents.

FIG. 28 illustrates exemplary methodology for lenses incorporating therapeutic agents.

FIG. 29 illustrates exemplary methodology for lenses incorporating therapeutic agents.

FIG. 30 illustrates exemplary methodology for lenses incorporating therapeutic agents.

FIG. 31 illustrates exemplary methodology for lenses incorporating therapeutic agents.

FIG. 32 illustrates exemplary methodology for lenses incorporating therapeutic agents.

FIGS. 33A-33S illustrate exemplary aspects of retinal damage cases.

FIGS. 34A-33I illustrate exemplary aspects of lens related treatment of retinal damage cases.

### DETAILED DESCRIPTION OF THE INVENTION

According to the present invention, new methods for forming an ophthalmic lens with one or more optical sub-elements are provided and novel ophthalmic lens devices that include a hydrogel structure formed via additive manufacturing to produce a lens with one or more optical sub-elements are also included. Lenses conducive to addressing various types of retina damage cases are disclosed in concert with devices related to improving vision capability associated with these damage cases.

The processes and apparatus of the present invention may generate a hydrogel optical device via successive application of a polymerizable mixture in one or more predefined patterns. A surface of the ophthalmic lens of the present invention may be a generally planar surface; an arcuate surface; or a complex variable surface.

In some embodiments, droplets of polymerizable mixture applied to a receiving surface accumulate into a pattern of polymerizable mixture replicating a map of energy transmissibility. Following deposition of polymerizable mixture onto a receiving surface, the deposited polymerizable mixture may be processed via a pinning process, such as exposure to a limited amount of actinic conditions, such as radiation (limited in intensity and/duration) and/or thermal energy. Exposure to the limited amount of actinic radiation is appropriate to pin the applied polymerizable mixture and reduce flow of the deposited polymerizable mixture.

In some embodiments, an insert may be placed onto and/or into the deposited polymerizable mixture. Subsequent application of additional polymerizable mixture may be effective to secure the insert in the polymerizable mixture and/or encompass the insert in polymerizable mixture. Following placement of the insert in the polymerizable mixture, the polymerizable mixture may be cured into a hydrogel.

Polymerizable mixture that has been pinned may act as a subsequent receiving surface for an inserted item and receive additional polymerizable mixture applied in a specific pattern, such as, for example, a pattern to securely hold the inserted item, encompass the inserted item, or according to a pattern of energy transmissibility. Additional polymerizable mixture received on the subsequent receiving surface may integrate with the polymerizable mixture comprising the receiving surface to form a combined volume. The combined volume may receive actinic radiation to form polymer chains including the additional polymerizable mixture and the polymerizable mixture actin as a receiving surface.

After a final application of polymerizable mixture, the polymerizable mixture accumulated on the receiving surface may be exposed to sufficient actinic conditions (e.g., radiation and thermal energy) to cure the accumulated polymerizable mixture into a polymer.

An atmosphere encompassing the droplets of polymerizable mixture during application onto the receiving surface and during pendency on the receiving surface prior to cure, may be carefully controlled in order to achieve a consistent optical quality of a device formed by the cured polymerizable mixture.

Embodiments that include a combination of a RGP and a hydrogel item may include one or more of: a hybrid lens, and a RGB lens “piggybacked” on a hydrogel base. A hybrid lens may include an RGP center for vision correction and a soft hydrogel outer skirt for comfort. These lenses can be an excellent choice for individuals who find RGP lenses uncomfortable but still need the visual benefits they offer. A softer hydrogel skirt may preferably include a high content of aqueous solution and/or high oxygen permeability.

A hybrid lens may also include an RGP lens encapsulated with a hydrogel structure formed by multiple applications of patterns of polymerizable mixture forming a combined volume. The combined volume may be pinned to generate polymer chains with polymerizable mixture of disparate applications of the polymerizable mixture, also processed for final polymerization. The encapsulating hydrogel may have plano design or include one or more optical lenses of sub-lenses. In some embodiments, the encapsulating hydrogel may preferably include a high content of aqueous solution and/or high oxygen permeability.

A lens with a combined RGP lens and hydrogel according to the present invention may be designed to be effective in correcting corneal irregularities of a specific patient, such as astigmatism, keratoconus, and irregular corneal scars. The lenses provide a smooth and uniform optical surface, compensating for the irregularities and improving visual clarity. Lenses according to the present invention may be customized and fitted for an individual's unique eye shape and prescription. This customization ensures precise vision correction and a comfortable fit. Lenses of hydrogel combined with an RGP lens according to the present invention also provide improved durability and resistance to physical damage, such as tearing. Such resistance to deformation allows lenses according to the present invention to maintain their shape on the eye, offering stable vision correction.

According to the present invention, it is also possible that hydrogel used for piggybacking and/or encapsulating may include different portions with different characteristics. For example, some portions may include a hydrogel material with a higher or lower modulus, oxygen permeability, lubriciousness, antimicrobial resistance, or other characteristics. Use of multiple passes of a printhead depositing polymerizable material, allow for selected passes to deposit a first polymerizable mixture in a first pattern and other passes to deposit a second polymerizable mixture in a second pattern.

### Glossary

In this description and claims directed to the presented invention, various terms may be used for which the following definitions will apply:

“About” as used herein, unless designated otherwise in regard to a specific metric, the term “about” will mean within 10% of a stated parameter.

“Actinic Radiation” as used herein, refers to emission of energy that is capable of initiating a chemical reaction in an associated Polymerizable Mixture. In some embodiments, actinic radiation includes radiation with a wavelength of energy in a range of 280-450 nm. In some more specific examples embodiments, an actinic radiation corresponding to UVA and blue light includes an energy with a wavelength in the range of 315-450 nm, some preferred embodiments include energy in the 365 nm to 400 nm range.

“Addition Based Manufacture” (sometimes referred to herein as “additive manufacturing” means a process during which units of material are added to a structure being formed via the aggregation of the units of material into a shape.

“Arcuate” as used herein, refers to a geometric shape including a curved portion.

“Cure” as used herein refers to expose a polymerizable mixture to actinic conditions which may include Fixing Radiation and/or thermal energy of sufficient intensity and for a sufficient duration of time to crosslink a majority of Polymerizable mixture.

“Diopter” as used herein, refers to a unit of refractive power that is equal to a reciprocal of a focal length (usually in meters) of a given optical sub-element.

“Fixing Radiation” as used herein, refers to Actinic Radiation of appropriate wavelength, and sufficient intensity and duration to crosslink a majority of Polymerizable mixture exposed to the Fixing Radiation.

“Gelling” or “Gelation” refers to a degree of polymerization sufficient to stop or substantially slow movement of polymerizable mixture deposited on a receiving surface while allowing subsequent droplets to meld or otherwise integrate with previously deposited polymerizable mixture and form a structure with a single mass of polymerizable mixture without distortion. Gelled polymerizable mixture moves to a higher viscosity state, but stops short of full cure. Pinning or gelation (or gelling) enhances the management of flow and form, and provides a high-quality surface.

“Gel Point” as used herein shall refer to a point in a polymerization process at which a gel or insoluble fraction is formed. Gel point may be considered the extent of conversion at which the liquid polymerization mixture becomes a high viscous material that is immobile on a stationary surface. Gel point can be determined, for example, using a Soxhlet experiment: Polymer reaction is stopped at different time points and a resulting polymer is analyzed to determine a weight fraction of residual insoluble polymer. The data can be extrapolated to a point where no gel is yet present. This point, where some polymer reaction has occurred, but no gel is present, is the gel point. The gel point may also be determined by analyzing a viscosity of a polymerizable mixture during a reaction. The viscosity can be measured using a parallel plate rheometer, with the polymerizable mixture between the plates. At least one plate should be transparent to radiation at the wavelength used for polymerization. The point at which the viscosity approaches infinity is the gel point. Gel point may generally be considered to occur at the same degree of conversion for a given polymer system and specified reaction conditions.

“Inhibitor” as used herein refers to a chemical reactant or process that slows or halts a chemical reaction.

“Initiator” as used herein refers to a substance that initiates a chain reaction or polymerization.

“Integrate” as used herein (and sometimes referred to as “meld”) means to merge together droplets of polymerizable mixture from two or more volumes so that they become a single volume with polymer chains that include polymerizable mixture from a first volume and polymerizable mixture from a second volume. To meld or integrate may include polymer chains of one deposition of polymerizable material with polymerizable mixture of another deposition of polymerizable mixture.

“Intensity” as used herein refers to an amount of power transferred per unit area, where the area is measured on a plane perpendicular to a direction of propagation of the energy (e.g., watts per square meter (W/m²)).

“Meld” (sometimes referred to integrate) as used herein means to merge together droplets of polymerizable mixture from two or more volumes (which may include, for example, separate depositions) so that they become a single volume with polymer chains that include polymerizable mixture from a first volume and polymerizable mixture from a second volume. To meld or integrate may include polymer chains of one deposition of polymerizable material with polymerizable mixture of another deposition of polymerizable mixture.

“Ophthalmic Lens” as used herein refers to an ophthalmic device that resides in or on the eye. These devices can provide optical correction or may be cosmetic. For example, the term lens can refer to a contact lens, intraocular lens, overlay lens, ocular insert, optical insert, or other similar device through which vision is corrected or modified, or through which eye physiology is cosmetically enhanced (e.g., iris color) without impeding vision.

“Optical” as used herein refers to a characteristic modifying or relating to a behavior or property of light.

“Optical Interface” as used herein refers to an object, or portion of an object that affects a behavior or property of light.

“Pinning” as used herein refers to the application of actinic conditions, such as exposure to limited actinic radiation, to a polymerizable mixture in an amount sufficient to perform a gelation process or gelling, but not cause the polymerizable mixture to cure.

“Polymerizable Mixture” (sometimes referred to as “PM” or “polymerizable mixture”) as used herein, refers to a liquid mixture of components (reactive and possibly also non-reactive components) which upon exposure to an external energy (e.g., actinic radiation in a range of 280-450 nm (e.g., UV-light or blue light or heat) is capable of undergoing polymerization to form a polymer or polymer network. A polymerizable mixture may include a monomer or prepolymer material which can be cured and/or crosslinked to form an ophthalmic lens or modify an existing lens or lens blank. Various embodiments can include Polymerizable Mixtures with one or more additives such as: UV blockers, bonding agents, tints, photo initiators or catalysts, and other additives one might desire in an ophthalmic lenses such as, contact, or intraocular lenses. In some embodiments, a Polymerizable Mixture may also be a Hydrogel Precursor.

“Rigid Gas Permeable Lens” (“RGP”) as used herein, refers to an optical lens formed from a material that has a higher modulus than a hydrogel lens. Exemplary materials for an RGP lens include one or both of silicone acrylate or fluorosilicone acrylate or other material that allows oxygen to pass through to the cornea, promoting eye health and comfort.

“Optical sub-element” as used herein, refers to a portion of an Ophthalmic Lens that forms an Optical Interface.

When used herein, the expression oxygen equilibrium concentration of the polymerizable mixture of X is intended to mean the oxygen concentration in the polymerizable mixture obtained if the mixture hypothetically is allowed to equilibrate at 1.0 atmospheres (1013 millibar) with an atmosphere having an oxygen concentration of X %.

When used herein, the term optical element is intended to include but not limited to ophthalmic devices, lenses used in industrial applications, lenses for endoscopes, inspection devices, fiber optics devices, camera lenses, telescopic lenses etc. Currently particularly interesting embodiments hereof are ophthalmic devices.

In some embodiments, an optical element has one or more objects embedded therein, e.g., a solid object selected from inserts, electronics, and functional additive releasing reservoirs or depots.

In other embodiments, an optical element includes one or more functionally active substances including biologically active substances.

As used herein, an ophthalmic device includes any device which is in front of the eye or resides in or on the eye or any part of the eye, including the cornea, cyclids, and ocular glands. These devices can provide optical correction, cosmetic enhancement (e.g. for iris color), vision enhancement, therapeutic benefit (for example as bandage lenses) or devices which deliver therapeutic agents such as lubricants, wetting agents, active pharmaceutical ingredients (which may sometimes be referred to as “API”) and biological agents which may be anti-inflammatory, anti-allergy, anti-bacterial, anti-infective, anti-hypertensive, etc. or delivery of nutraceuticals, vitamins and antioxidants for ocular health or a combination of any of the foregoing. Illustrative examples of ophthalmic devices include those selected from a spectacle lens, a contact lens (e.g., a soft contact lens or a hard contact lens), an implantable contact lens, an intraocular lens, an overlay lens, a corneal implant, such as a corneal inlay implant, and an ophthalmic/ocular insert.

In some embodiments, the ophthalmic device is a contact lens, in particular a soft contact lens, such as a contact lens of a hydrogel material, other embodiments may include an intraocular lens of hydrogel material.

The term hydrogel refers to crosslinked polymers which have absorbed water (swelled) to a water content of at least 10 weight-% thereof. Preferably such hydrogel materials have a water content of at least 20 weight-%, such as at least 25 weight-%, and up to 70 to 90 weight-%.

When used herein, the term polymerizable mixture refers to a liquid mixture of components (reactive and possibly also non-reactive components) which upon exposure to an external energy (e.g., actinic radiation 280-450 nm (like UV-light or blue light) or heat) is capable of undergoing polymerization to form a polymer or polymer network. Typically, the mixture comprises reactive components such as monomers, macromers, prepolymers, cross-linkers, and initiators.

Moreover, polymerizable mixture may further include other ingredients such as, by way of non-limiting example, one or more of: additives such as wetting agents, release agents, dyes, light absorbing compounds such as UV absorbers and photochromic compounds, any of which may be reactive or non-reactive but are capable of being retained within the resulting ophthalmic device, as well as one or more: pharmaceuticals, vitamins, antioxidants, and nutraceutical compounds. It will be appreciated that a wide range of additives may be added based upon the ophthalmic device, how the ophthalmic device is made, and the ophthalmic device's intended use.

A mixture may be considered a polymerizable mixture if one or more constituents of the mixture (such as, for example, monomer, macromers, prepolymers, crosslinkers, etc.) includes at least one polymerizable functional group, such as an ethylenically unsaturated group, such as, by way of non-limiting example: (meth)acrylate, (meth)acrylamide, vinyl, N-vinyl lactam, N-vinylamide, and styryl functional groups.

In some embodiments, a Polymerizable Mixture contains at least one hydrophilic component. In some embodiments, hydrophilic components included in a Polymerizable Mixture may be selected from the hydrophilic monomers, e.g., those known to be useful to prepare hydrogels.

In some exemplary and specific embodiments, hydrophilic means that at least 5 grams of a compound(s) are soluble in 100 mL of deionized water at 25° C. under weakly acidic (pH between 5 and 7) or basic conditions (pH form 7 to 9), and in some embodiments 10 grams of the compound(s) are soluble in 100 mL of deionized water at 25° C. under weakly acidic or basic conditions. Other embodiments are also within the scope of the invention. In addition, in other uses the “hydrophilic” may be ascertained by methods other than solubility, and the term may be used as a condition and/or a modifier.

In some exemplary and specific embodiments, “hydrophobic” means that 5 grams of hydrophobic compound does not fully dissolve in 100 mL of deionized water at 25° C. under weakly acidic or basic conditions. The solubility of the compounds can be confirmed by visual observation, with any visible precipitants or turbidity indicating that the compound is hydrophobic. Solubility may be determined, for example, in some embodiments, after about eight hours of mixing or stirring. Other embodiments are also within the scope of the invention. In addition, in other uses the condition of “hydrophobic” may be ascertained by methods other than solubility, and the term may be used as a condition and/or a modifier.

One class of suitable hydrophilic monomers includes acrylic- or vinyl-containing monomers. Such hydrophilic monomers may themselves be used as crosslinking agents, however, where hydrophilic monomers having more than one polymerizable functional group are used, their concentration should be limited as discussed above to provide a contact lens having the desired modulus.

The term vinyl-type or vinyl-containing monomers refer to monomers containing the vinyl grouping (—CH═CH2) and that are capable of polymerizing. Examples of hydrophilic vinyl-containing monomers include, but are not limited to, monomers such as N-vinyl amides, N-vinyl lactams (e.g., N-vinylpyrrolidone (NVP)), N-vinyl-N-methyl acetamide, N-vinyl-N-ethyl acetamide, and N-vinyl-N-ethyl formamide, N-vinyl formamide. Alternative vinyl-containing monomers include, but are not limited to, 1-methyl-3-methylene-2-pyrrolidone, 1-methyl-5-methylene-2-pyrrolidone, and 5-methyl-3-methylene-2-pyrrolidone.

Acrylic-type or acrylic-containing monomers are those monomers containing the acrylic group: (CH2═CRCOX) wherein R is H or CH3, and X is O or N, which are also known to polymerize readily, such as N,N-dimethyl acrylamide (DMA), 2-hydroxyethyl methacrylate (HEMA), glycerol methacrylate, 2-hydroxyethyl methacrylamide, polyethyleneglycol monomethacrylate, methacrylic acid, and mixtures thereof.

Other hydrophilic monomers that can be employed in the invention include, but are not limited to, polyoxyethylene polyols having one or more of the terminal hydroxyl groups replaced with a functional group containing a polymerizable double bond. Examples include polyethylene glycol, cthoxylated C1-20 alkyl glucosides, and ethoxylated bisphenol A reacted with one or more molar equivalents of an end-capping group such as isocyanatocthyl methacrylate, methacrylic anhydride, methacryloyl chloride, vinylbenzoyl chloride, or the like, to produce a polyethylene polyol having one or more terminal polymerizable olefinic groups bonded to the polyethylene polyol through linking moieties such as carbamate or ester groups. Other suitable hydrophilic monomers will be apparent to one skilled in the art.

In some exemplary and nonlimiting embodiments, the hydrophilic component comprises at least one hydrophilic monomer such as DMA, HEMA, glycerol methacrylate, 2-hydroxyethyl methacrylamide, NVP, N-vinyl-N-methyl acrylamide, polyethyleneglycol monomethacrylate, and combinations thereof. In another embodiment, the hydrophilic monomers comprise at least one of DMA, HEMA, NVP and N-vinyl-N-methyl acrylamide and mixtures thereof. In another embodiment, the hydrophilic monomer comprises DMA and/or HEMA.

Hydrophilic component(s) (e.g., hydrophilic monomer(s)) may be present in a wide range of amounts, depending upon the specific balance of properties desired. In some embodiments, the amount of the hydrophilic component is up to 60 weight-%, such as from 5 to 40 weight-% based upon all reactive components.

Hydrophobic silicone-containing components (or silicone components) may be considered those that contain at least one [—Si—O—Si] group in a monomer, macromer or prepolymer. In some embodiments, the Si and attached O are present in the silicone-containing component in an amount greater than 20 weight percent, such as greater than 30 weight percent of the total molecular weight of the silicone-containing component. Useful silicone-containing components include polymerizable functional groups such as acrylate, methacrylate, acrylamide, methacrylamide, N-vinyl lactam, N-vinylamide, and styryl functional groups.

Also, in some exemplary and nonlimiting embodiments, cross-linking monomers may be employed, cither singly or in combination, and may include ethylene glycol dimethacrylate, trimethylolpropane trimethacrylate, glycerol trimethacrylate, polyethylene glycol dimethacrylate (wherein the polyethylene glycol has a molecular weight up to, e.g., 400), and other polyacrylate and polymethacrylate esters. The cross-linking monomer may be used in the usual amounts, e.g., from 0.1 to 5, and preferably in amounts of from 0.2 to 3, parts by weight per 100 parts by weight of the polymerizable mixture.

Another monomer that may also be used in some exemplary and nonlimiting embodiments, includes methacrylic acid, which may be used to influence an amount of water that a hydrogel may absorb at equilibrium. Methacrylic acid is usually employed in amounts of from 0.2 to 8 parts by weight per 100 parts of the hydrophilic monomers like HEMA. Other monomers that can be present in the polymerization mixture include methoxyethyl methacrylate, acrylic acid, and the like.

In some exemplary and nonlimiting embodiments, the polymerizable mixture comprises hydroxyethyl methacrylate (HEMA) or hydroxyethyl acrylate (HEA) monomers, preferably hydroxyethyl methacrylate (HEMA) monomers.

In some exemplary and nonlimiting embodiments, the polymerizable mixture comprises methacrylate or acrylate monomers not being hydroxyethyl methacrylate or hydroxyethyl acrylate monomers.

In some exemplary and nonlimiting embodiments, the polymerizable mixture comprises reactive silicone monomers or oligomers.

In some further some exemplary and nonlimiting embodiments, the polymerizable mixture after polymerization may provide a polymer which is non-swellable in water, e.g., a polymer that is not able to take up a water content of more than 2 weight-%.

One or more polymerization initiators may be included in the polymerizable mixture. Examples of polymerization initiators include, but are not limited to, compounds such as lauryl peroxide, benzoyl peroxide, isopropyl percarbonate, azobisisobutyronitrile, and the like, which generate free radicals at moderately elevated temperatures, and photo-initiator systems such as aromatic alpha-hydroxy ketones, alkoxyoxybenzoins, acetophenones, acylphosphine oxides, bisacylphosphine oxides, and a tertiary amine plus a diketone, mixtures thereof and the like. Illustrative examples of photo-initiators are 1-hydroxycyclohexyl phenyl ketone, 2-hydroxy-2-methyl-1-phenyl-propan-1-one,bis(2,6-dimethoxybenzoyl)-2,4-4-trimethylpentyl phosphine oxide (DMBAPO), bis(2,4,6-trimethylbenzoyl)-phenyl phosphineoxide (Irgacure 819), 2,4,6-trimethylbenzyldiphenyl phosphine oxide and 2,4,6-trimethylbenzoyl diphenylphosphine oxide, benzoin methyl ester and a combination of camphorquinone and ethyl 4-(N,N-dimethylamino)benzoate. Commercially available ultra-violet and visible light initiator systems include, but are not limited to, Irgacure 819® and Irgacure 1700® (from Ciba Specialty Chemicals) and Lucirin TPO initiator (available from BASF). Commercially available UV photo-initiators include Irgacure 651, Darocur 1173 and Darocur 2959 (Ciba Specialty Chemicals). These and other photo-initiators which may be used are disclosed in Volume III, Photoinitiators for Free Radical Cationic & Anionic Photopolymerization, 2nd Edition by J. V. Crivello & K. Dictliker; edited by G. Bradley; John Wiley and Sons; New York; 1998.

In some embodiments, a polymerization initiator is included in a polymerizable mixture in amounts capable of initiating polymerization of the polymerizable mixture, such as 0.1 to 2 weight-%. Polymerization of the polymerizable mixture can be initiated using the appropriate choice of heat or visible or ultraviolet light, or other energy, depending upon a polymerization initiator used. Alternatively, in some embodiments, initiation can be conducted without a photo-initiator using, for example, e-beam. However, when a photo-initiator is used, the preferred initiators are bisacylphosphine oxides, such as bis(2,4,6-trimethylbenzoyl)-phenyl phosphine oxide (Irgacure 819®) or a combination of 1-hydroxycyclohexyl phenyl ketone and DMBAPO, and in another embodiment the method of polymerization initiation is via visible light activation.

In some embodiments, a polymerizable mixture may include one or more internal wetting agents. Internal wetting agents may include, but are not limited to, high molecular weight, hydrophilic polymers. Examples of internal wetting agents include, but are not limited to, polyamides such as poly(N-vinyl pyrrolidone) and poly(N-vinyl-N-methyl acetamide).

The internal wetting agent(s) may be present in a wide range of amounts, depending upon the specific parameter desired. In some embodiments, the amount of the wetting agent(s) is up to 50 weight-%, such as from 5 to 40 weight-%, such as from 6 to 30 weight-% based upon all reactive components.

Moreover, a polymerizable mixture may contain one or more auxiliary components selected from, but not limited to, chelating agents, polymerization inhibitors, viscosity regulating agents, surface tension regulating agents, glass transition regulating agents, compatibilizing components, ultra-violet absorbing compounds, medicinal agents like ophthalmic pharmaceutical agents, ophthalmic demulcents, excipients, antimicrobial compounds, copolymerizable and non-polymerizable dyes, release agents, reactive tints, pigments, and chelating agents, and combinations thereof. In some embodiments, the sum of such auxiliary components may be up to 20 weight-%. Preferred embodiments may include photo initiators that create reactive species when exposed to one or more of: visible light, ultraviolet light, red light, and infrared light, and may include one or more of a: visible light, ultraviolet light, red light, and infrared light absorbing moiety,

A polymerizable mixture may be prepared, for example, by simple mixing of the constituents of the mixture. In some embodiments, reactive components (e.g., hydrophilic monomers, wetting agents, and/or other components) are mixed together with an inert diluent to form the polymerizable mixture. Such diluents may have the effect of controlling expansion of an ophthalmic device formed upon hydration, assisting in solubility of components, and regulating a glass transition temperature. Other embodiments may exclude the inert diluent.

Classes of suitable diluents include, without limitation, alcohols having 3 to 20 carbons, amides having 10 to 20 carbon atoms derived from primary amines, ethers, polyethers, ketones having 3 to 10 carbon atoms, and carboxylic acids having 8 to 20 carbon atoms. As the number of carbons increases, the number of polar moieties may also be increased to provide the desired level of water miscibility. In some embodiments, primary and tertiary alcohols are preferred. Preferred classes include alcohols having 4 to 20 carbons and carboxylic acids having 10 to 20 carbon atoms.

In some embodiments, the diluents are selected from 1,2-octanediol, t-amyl alcohol, 3-methyl-3-pentanol, decanoic acid, 3,7-dimethyl-3-octanol, 2-methyl-2-pentanol, 2-ethyl-1-butanol, 3,3-dimethyl-2-butanol, tripropylene methyl ether (TPME), butoxy ethyl acetate, mixtures thereof and the like.

In some embodiments, the diluents are selected from those that have some degree of solubility in water. In some embodiments at least about three percent of the diluent is miscible with water. Examples of water soluble diluents include, but are not limited to, 1-octanol, 1-pentanol, 1-hexanol, 2-hexanol, 2-octanol, 3-methyl-3-pentanol, 2-pentanol, t-amyl alcohol, tert-butanol, 2-butanol, 1-butanol, ethanol, decanoic acid, octanoic acid, dodecanoic acid, 1-ethoxy-2-propanol, 1-tert-butoxy-2-propanol, EH-5 (commercially available from Ethox Chemicals), 2,3,6,7-tetrahydroxy-2,3,6,7-tetramethyl octane, 9-(1-methylethyl)-2,5,8,10,13,16-hexaoxaheptadecane, 3,5,7,9,11,13-hexamethoxy-1-tetradecanol, mixtures thereof and the like. Esters of alcohols, such as boric acid esters of alcohols, are other embodiments of diluents.

In some embodiments, an amount of diluent preferred is typically up to 60 weight-%, such as from 10 to 60 weight-%, such as from 20 to 50 weight-%, based upon the complete polymerizable mixture.

In another aspect, in some embodiments, a polymerizable mixture includes one or more cross-linkers in an amount of 0.5 to 5.0 weight-%, one or more non-reactive diluents (such as polyhydric alcohols, esters of polyhydric alcohols or ethers of polyhydric alcohols, e.g. glycerols and glycerol esters) in an amount of 0 to 60.0 weight-%, and one or more polymerization inhibitors in an amount of less than 100.0 ppm and preferably less than 50.0 ppm, based on the weight of the polymerizable mixture. In some preferred embodiments, a viscosity of the polymerizable mixture may be adjusted to 1-25 cP, such as 2-15 cP, in particular 3-10 cP, although other viscosities are within the scope of the present invention.

As mentioned above, the oxygen equilibrium concentration of the polymerizable mixture is preferably 0.05-8.0 volume-%, e.g., 0.2-6.0 volume-%, e.g., in the range of 0.5-6 volume-%. The lower limits (such as 0.05%, 0.1%, 0.2% etc.) are stated for practical reasons and it is quite possible to achieve even lower concentrations.

An oxygen content of a polymerizable mixture may be adjusted to a desired level (X) by exposing the polymerizable mixture (previously being mixed under an ambient atmosphere (1013 mbar, 21 volume-% O2)) to a reduced pressure P, where P=X*1013/21 mbar. Subsequently the reduced pressure (sometimes referred to as a “vacuum”) can be released and the oxygen-adjusted polymerizable mixture can be stored under an atmosphere having an oxygen concentration corresponding to a suitable atmosphere having an oxygen concentration of X.

In some preferred embodiments, the oxygen concentration in a controlled atmosphere ambient to deposited polymerizable mixture, and a substrate in contact with the polymerizable mixture is lower than the oxygen equilibrium concentration in the polymerizable mixture.

### Three-Dimensional Printing Device

The deposition of a plurality of droplets is typically achieved by breaking a volume of Polymerizable Mixture into droplets and propelling the droplets in a desired direction at a predetermined velocity. In some embodiments, such generation of droplets of Polymerizable Mixture and propelling of the droplets in a given direction at a predetermined velocity may be accomplished via operation of an additive manufacturing printhead. Such printheads are capable of simultaneous deposition of a plurality of droplets of a liquid either in a one-dimensional pattern (e.g.; in the form of lines) or in a two-dimensional pattern. In some embodiments, a droplet is preferably in a smaller range for additive manufacturing, such as, for example, in a picolitre range, such as between about 3 picolitres and 20 picolitres per droplet and preferably 10 to 30 passes of a printhead in relation to a substrate. In some embodiments, an ophthalmic lens is formed via 14 to 18 passes of a printhead expelling droplets in a desired pattern relative to a receiving surface.

In some embodiments, a desired speed and accuracy of a deposition of the plurality of droplets may be accomplished with an additive manufacturing printhead capable of simultaneous deposition of a two-dimensional pattern of polymerizable mixture so that a pattern (or multiple successive patterns) of droplets of the polymerizable mixture representing an integer map of energy transmissibility (e.g.; a grayscale image) of a desired article (such as an ophthalmic lens) can be printed.

In some preferred embodiments, dispersion and propulsion of droplets forming a two-dimensional pattern representing an integer map of energy transmissibility in the form of a grayscale image is achievable in a single pass of a printhead depositing droplets in an area at least the size of the ophthalmic device. Commercially available printing heads suitable for this purpose include the Samba™ printhead from Fujifilm, e.g., Samba™ G3L Printhead which has 2048 nozzles per module and is capable of deposition of liquids in the order of 2.4 picolitre for native drop size to 13.2 picolitre maximum drop size at a 1200 native dpi accuracy.

A pattern of each pass of droplets expelled, propelled, and deposited by the 3D printing device, may be determined in relation to a desired transmissibility pattern of an optical lens to be formed. A shape of the optical lens being formed that correlates with the transmissibility pattern. For example (in case of an ophthalmic device), data gathered from measuring a patient's eye may be used to generate input. Data may include, for example, optical characteristics, surface properties, size and shape dimensions and observations of an ocular disease state.

Three-dimensional printable models may be created, by way of non-limiting example, based upon a computer aided design (CAD) software, or a scan of a patient's eye. Patient eye scanning may include collecting and analyzing digital data representative of a shape and appearance of the patient's eye. Based on collected data, a three-dimensional model of a target ophthalmic device may be produced. The 3D printable model may be processed by software to convert the model into instructions for a 3D printer. For example, in some embodiments, a grayscale image (or other energy intensity mapping) may be referenced to generate a printer control instruction. Printer control instructions may include a file containing digital values tailored to a specific type of droplet expulsion devices, such as, for example, a 3D printer to repeatedly deposit polymerizable mixture according to the grayscale image or other energy transmissibility pattern.

### Substrate

The present invention provides for depositing a plurality of droplets of polymerizable mixture onto a surface of a substrate. Suitable materials for the substrate include one or more of: glass, polyolefins like polypropylene, polystyrene, and other smooth materials.

In some preferred embodiments, a form of a polymerizable mixture droplet receiving substrate represents a shape of one side of a resulting (non-hydrated) ophthalmic device, e.g., the substrate may include at least a portion that is arcuate or otherwise curved in a shape and size suitable for a contact lens fitting a human eye. Similarly, a substrate may include apportion that is relatively flat fan din a size and shape suitable for an intraocular lens insertable into a human eye via surgery.

A size of the substrate is preferably adjusted to fit a required dimension of a finished hydrated ophthalmic device. A substrate with a rotational axis may be formed by one or more of: lathing, grinding, injection molding, and additive manufacturing. A substrate that is not constrained to shapes with a rotational axis may be prepared, for example, via 3D printing. A substrate may therefore include an optical surface shape that is not spherical, such as a substrate surface shape duplicating, modeled after, or based upon a portion of a patient's eye exposed to air.

In some embodiments, in order to adjust wettability of a surface of a substrate that will receive polymerizable mixture, a surface of the substrate may be pre-treated with one or more of: a surfactant; exposed to UV; exposed to ozone; and exposed to plasma treatment; or a combination of such treatments. In some preferred embodiments, a receiving surface of a glass or polymer substrate may be pre-treated with Tween® 80 or a silicone surfactant such as Dow Corning™ Additive 67, Additive 14, Additive 57, Xiameter OFX-0193 etc. In some implementations of the present invention, a surfactant is included in the polymerizable mixture.

In some embodiments, a method of manufacture of an ophthalmic lens includes bringing an oxygen concentration in the substrate into equilibrium with an oxygen concentration in the controlled atmosphere. Similarly, in some preferred embodiments, an oxygen concentration in the substrate is the same or less than an oxygen content of a polymerizable mixture deposited on the substrate.

In order to obtain an oxygen concentration in the substrate which is in equilibrium with the oxygen concentration in the controlled atmosphere, the substrate may be allowed to be exposed to the controlled atmosphere (or a corresponding atmosphere) prior to the deposition of the droplets, e.g., for a period of at least 8 hours.

In some embodiments, a substrate may only be capable of a limited amount of oxygen within it, hence, it may not be necessary to take any particular precautions with respect to the oxygen concentration in the substrate.

In an alternative embodiment, the substrate is in itself an ophthalmic device (such as, for example, a regular commercial contact lens), that is modified by the methods described herein so as to form a final ophthalmic device, such as, for example, an ophthalmic device modified to have one or more of: different optical properties; an ophthalmic device with modified color patterns; and an ophthalmic device with different physical properties.

### Controlled Atmosphere

In some embodiments, an ambient atmosphere in which the deposition printing described herein takes place may be controlled. A controlled ambient atmosphere may include, by way of non-limiting example, one or both of: defined ranges of a specified gas, defined ranges of particulate and controlled wavelengths of light or other energy wavelengths. In some preferred embodiments, a suitably low concentration of oxygen is achieved in an atmosphere encompassing the polymerizable mixture such that an oxygen content of the polymerizable mixture is appropriately controlled. In some embodiments, the receiving surface of the substrate may be contained within the controlled ambient atmosphere.

By way of specific non-limiting example, in some embodiments, a controlled atmosphere has an oxygen concentration of at the most 5.0 volume-%. In some embodiments, such as those including etafilcon A as an ophthalmic lens material, an oxygen concentration in a controlled atmosphere is at most 2.0 volume-%, e.g., 0.01-2.0 volume-%, such as 0.03-1.5 volume-%, e.g., in the range of 0.05-1.2 volume-%, such as 0.1-1.1 volume-%, and more preferably at the most 1.0 volume-%. The lower limits (such as 0.01%, 0.03%, 0.05% etc.) are stated for practical reasons and it is quite possible to achieve even lower concentrations.

In another aspect, in some embodiments, a controlled atmosphere under which deposition of a polymerizable mixture takes place is most conveniently at a pressure of 1.0 atm. (1013 mbar) which corresponds to an oxygen concentration of 21 volume-%. A lower oxygen concentration than the 21 volume-% found in a normal atmosphere may suitably be obtained by mixing of atmospheric air with another gas, such as, in some preferred embodiments, an inert gas such as, one or more of: nitrogen, helium, argon, or other inert gas.

In some embodiments, a controlled atmosphere may include an inert gas, such as nitrogen, mixed in specific amounts with pure oxygen. One preferred approach for controlled atmosphere uses nitrogen as the inert gas to displace atmospheric oxygen and thereby achieve an oxygen concentration of a desired level.

An oxygen concentration may be monitored by an oxygen meter and regulated at one or more of: prior to an additive manufacturing process, at a start of an additive manufacturing procedure, and during the manufacturing procedure and preferably also intermittently or continuously controlled during a process preparing one or both of: an optical element and a substrate.

### Depositing Additive Droplets and Curing

The methods of the present invention include depositing successive passes of a plurality of droplets of a polymerizable mixture onto a receiving surface that may include one or more of: a substrate, an insert, and previously deposited droplets, under a controlled atmosphere. The droplets of polymerizable mixture are preferably emitted from a printhead and deposited based upon a two-dimensional pattern representative of an energy transmissibility pattern, such as a grayscale image (or other light map representing light intensity). Following a deposition of droplets of the polymerizable mixture, the droplets may be exposed to controlled amounts of actinic radiation to cause a gelation process that pins the droplets of polymerizable mixture in place relative to the substrate.

A polymerizable mixture is typically deposited using a 3D printing device, such as, for example, the printing devices described herein. In embodiments, individual droplets have a volume of 0.5-50 pico liters (PL), such as 1-40 pL or 1.5-30 pL, and preferably 2.0-15 pL.

In some embodiments, each plurality of droplets of the polymerizable mixture is deposited onto a surface relative to a substrate. The surface relative to the substrate may include one or more of: an upper surface of the substrate; droplets previously deposited; and an article placed upon one or both of the substrate and the previously deposited droplets of polymerizable mixture. Polymerizable mixture that is deposited onto previously deposited polymerizable mixture may integrate into previously deposited polymerizable mixture such that a single mass of polymerizable mixture forms on the substrate with no discernable layers. The single mass of polymerizable mixture may include multiple optical interfaces and/or optical sub-elements formed by respective series of one or more steps of: deposition, integration, melding, gelling, and pinning of polymerizable mixture.

Droplets of polymerizable mixture deposited upon an article may attach to the article. The article may have a surface treated with a wetting agent. After coming into contact with the receiving surface, the polymerizable mixture may subsequently be exposed to limited actinic radiation or heat after the deposition of the final of the successive layers of droplets for forming the ophthalmic device.

In variations of the present invention where successive layers of deposited polymerizable mixture are exposed to actinic radiation (e.g., UV light), the polymerizable mixture may include a photo-initiator. In the variants of the present invention where the polymerizable material deposited in successive passes are exposed to heat, the polymerizable mixture may include a thermal initiator.

In some variants of the present invention, successive patterns of polymerizable mixture are exposed to intermittent radiation (e.g., UV light) after each deposition of a layer of droplets of the polymerizable mixture. A degree of polymerization obtained by such intermittent exposure to actinic radiation is typically the degree required for the purpose of pinning, or otherwise obtaining gelation of, the polymerizable mixture. Such obtaining of gelation may be used to control migration of deposited droplets from a first position on the receiving surface to another position on the receiving surface (and/or to control migration of the deposited polymerizable mixture off of the receiving surface).

In preferred embodiments, such control of migration allows for limited flow of deposited polymerizable mixture, but prevents unmitigated rearranging of the deposited polymerizable mixture. For example, in some embodiments, controlled migration allows gravity and other natural forces, such as surface tension and/or intermolecular forces to coalesce and smooth a surface of deposited polymerizable mixture. Deposited polymerizable mixture will also integrate deposited droplets with previously deposited polymerizable mixture, and meld into a smoothed surface of polymerizable mixture that may then be pinned in place with a gelation process.

In some embodiments of the present invention, droplets of polymerizable mixture are deposited onto a surface that includes one or more of the substrate, an insert, and previously deposited polymerizable mixture, thereby forming a pattern of polymerizable mixture with energy transmissibility properties based upon an integer map representing energy transmissibility. The integer map representing energy transmissibility may include a two-dimensional grayscale image that is referenced by a software program used to control the printhead and make the printhead operative to dispel droplets of polymerizable mixture.

Deposited polymerizable mixture is preferably exposed to pinning actinic radiation after each pass (or after a predetermined number of passes) of the printhead depositing the polymerizable mixture, and ultimately exposed to curing actinic radiation after a deposition of a final pass of a printhead depositing droplets polymerizable mixture to form the optical element.

A pass of the printhead may include one or both of: the printhead moving relative to a substrate onto which polymerizable mixture is received, a substrate and previously deposited polymerizable mixture) moving relative to a printhead; and/or a printhead and a substrate moving relative to each other as the polymerizable mixture is deposited.

In some preferred embodiments, at least a portion of a pattern of polymerizable mixture deposited via a pass subsequent to a first pass of the printhead, combines with, and integrates into, previously deposited polymerizable mixture, thereby forming a single volume of polymerizable mixture. Gravity induces a limited movement of the deposited polymerizable mixture resulting in a smoothing of the surface of the deposited polymerizable mixture. Movement of deposited polymerizable mixture based upon gravity may be limited by surface tension forces and micro forces. Preferably the single volume of polymerizable mixture is pinned and/or gelled by exposure to a limited amount of actinic radiation thereby limiting additional movement following the smoothing effect of gravity induced movement.

In some variants of the present invention, a series of successive passes of a printhead, such as, for example, between two to twenty (2-20) passes of polymerizable mixture are deposited before exposing the deposited polymerizable mixture to intermittent actinic radiation that is effective to pin and/or gel the deposited polymerizable mixture. Prior to exposure to the intermittent actinic radiation, the deposited polymerizable mixture may undergo limited migration as a single volume of polymerizable mixture.

In some embodiments, a thickness of polymerizable mixture deposited in a pass of the printhead relative to a receiving surface, on any particular portion of the receiving surface, may be up to 50 μm (fifty micrometers), but preferably a maximum of 25 μm (twenty-five micrometers). Some embodiments may include up to 10 μm of polymerizable mixture deposited in a single pass of the printhead relative to the receiving surface (which may include one or more of: a substrate, previously deposited polymerizable mixture, an insert, and a formed ophthalmic lens).

In some variants of the present invention, a polymerizable mixture includes a plurality of photo-initiators, with two or more photoinitiators having responsiveness to different wavelengths of actinic radiation. This is particularly interesting when it is desirable to utilize UV light at one wavelength for the intermittent exposure (for pinning or gelation) and another wavelength for final curing of deposited polymerizable mixture to form the optical element. Accordingly, in some variants of the present invention, a first polymerization initiator is used (in conjunction with exposure to an appropriate first actinic radiation) to create a construct of partially polymerized polymerizable mixture, and a second polymerization initiator is used (in conjunction with exposure to an appropriate second actinic radiation) to complete a curing process.

In addition to controlling a level of oxygen in the polymerizable mixture to within a desired range of oxygen content, some embodiments of the present invention include controlling polymerization of the deposited polymerizable mixture such that as an optical element is being fabricated using the processes described in this disclosure, a degree of polymerization of deposited polymerizable mixture within a specified timeframe following deposition is limited to a degree of gelation to stop, or substantially slow, a movement of the polymerization mixture while allowing droplets from subsequent passes to meld into previously deposited polymerizable mixture and form a structure for an optical element with limited distortion.

A process for intermittent gelation may sometimes be referred to as pinning or gelling of the deposited polymerizable mixture. In some variants of the present invention, a pinning process may include applying a dose of actinic radiation in an intensity, wavelength, and length of time suitable to cause gelation, such as, for example, application of ultraviolet (UV) light to a UV curable polymerizable mixture and/or ink (UV ink). Actinic radiation wavelengths may be matched to photochemical properties of a polymerizable mixture and/or UV ink used in a manufacturing process. The actinic radiation may be any radiation that produces a desired photochemical activity, which in this case is polymerization of the polymerizable material.

As a result of the intermittent gelation, deposited polymerizable mixture and/or ink droplets move to a higher viscosity state, but do progress to full cure. Variants of the present invention that include pinning or gelation (or gelling) have enhanced ability to manage a flow and form of deposited polymerizable mixture, which in turn provides high optical qualities in an optical element formed via final cure of the deposited polymerizable mixture. For example, sufficient flow to allow gravity and/or other natural forces, such as, without limitation: surface tension and microforces to smooth a surface of the gelled polymerizable mixture but not significantly change a shape of an optical element is preferred. In some variants, other forces, such as, for example, centrifugal force may be used to form a surface shape.

Processes for gelation and cure may be modified based upon a selection and/or a concentration of one or more of: photo-initiators, cross-linkers, source of actinic radiation (e.g., UV light source), intensity of actinic radiation and duration of exposure. Examples of sources of actinic radiation may include light emitting diodes (LED) or light bulbs, lasers, and other emitters.

In some specific embodiments, a polymerizable mixture may include two photo-initiators absorbing energy at two different wavelengths. The polymerizable mixture is used with corresponding UV LED light sources (e.g., at 365 nm and at 400 nm). One initiator may be present in a concentration capable of starting gelation of the polymerizable mixture but insufficient to complete the polymerization. This enables individual deposits of polymerizable mixture to come to a same (or similar) relative degree of conversion prior to final cure. A final polymerization throughout an article formed by multiple subsequent depositions and pinning of polymerizable mixture (e.g.; an optical element) may be done as a separate step using another photo-initiator/UV LED light combination (e.g.; second photoinitiator's actinic radiation energy, or third photoinitiator's etc.) actinic radiation energy resulting in a uniform polymer network required for optical function.

As an alternative hereto, a thermal initiator that is active at or above a Tg may be used instead of, or in addition to, the second (or other) photo-initiator to complete curing of the deposited polymerizable mixture. The present invention also provides that without control of an oxygen content of deposited polymerizable mixture throughout deposition process steps, and during a final curing step, the oxygen inhibition effects would adversely impact the uniformity of the polymer network and may lead to creation of incompletely cured polymer and therefore a device with a tacky surface.

In some embodiments, a polymerizable mixture is deposited onto a curved surface, a first deposition, or multiple depositions, may be deposited as patterns of droplets of polymerizable mixture onto a curved surface, according to the methods described herein. The patterns of droplets include a volume and distribution that permits surface tension to maintain the patterns of droplets of polymerizable mixture with limited flow or other movement until partially cured with a gelation process, thereby pinning the deposited polymerizable mixture in place (and limiting flow).

Subsequent deposition of additional droplets from the printhead may fill in spaces left by a first deposition or subsequent layers until a surface of a receiving substrate is completely covered with polymerizable mixture and the deposited polymerizable mixture establishes a foundation to build an optical element upon. Alternatives to dot patterns include deposition of droplets to form a very thin layer (e.g.; 1 micron to 8 microns) and building an optical element upon such very thin layer with the processes disclosed herein.

In some embodiments, it is useful to isolate a printhead containing monomer from receiving actinic radiation, such as UV radiation in order to prevent premature gelation or polymerization of monomers in a printhead which may render the printhead inoperable, or operable at diminished performance levels.

Isolation from actinic radiation may be accomplished using reactive monomers with low levels of inhibitors and/or using a printhead in an environment with low oxygen levels. Isolation may be accomplished, for example, via physical separation of the printhead and actinic radiation.

In order to achieve concurrent printing and pinning of a material to stop or slow the movement of deposited ink or polymerizable mixture once deposited, some embodiments of the present invention include apparatus operative to isolate a source of actinic radiation (e.g., UV light source) from the printhead to essentially eliminate or substantially reduce a potential of gelation/polymerization of polymerizable mixture in the printhead. Isolating the printhead from a source of actinic radiation and controlling both oxygen levels and movement of polymerization mixture, enables the fabrication of precise shapes and optical devices without artifacts in the matrix that adversely affect an optical performance of a final lens that is fabricated.

In some embodiments, it is preferred that to wash gelled deposited polymerizable mixture with a solvent or water, e.g., to remove excess monomers, after multiple depositions of polymerizable mixture(s) and gelation processes have been completed, but before a final curing process is performed.

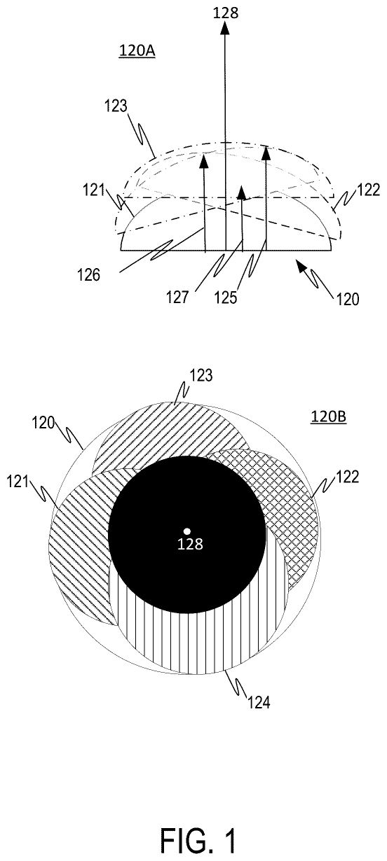

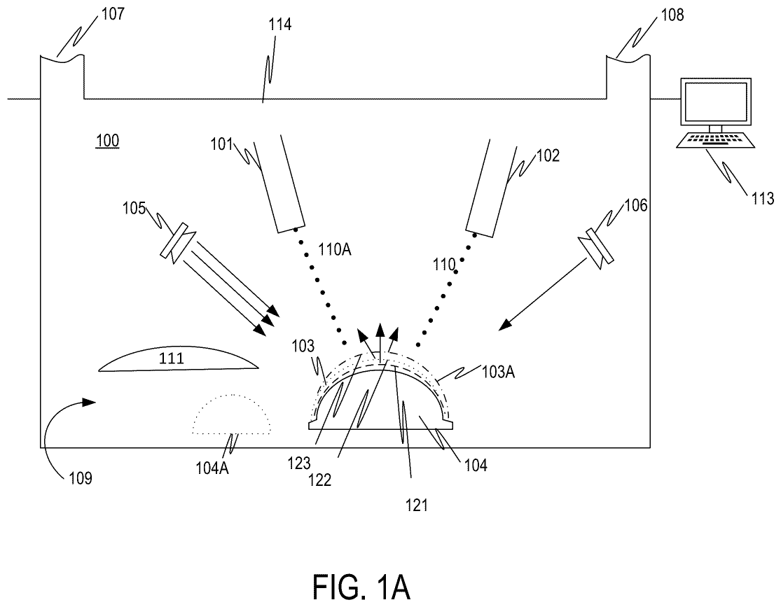

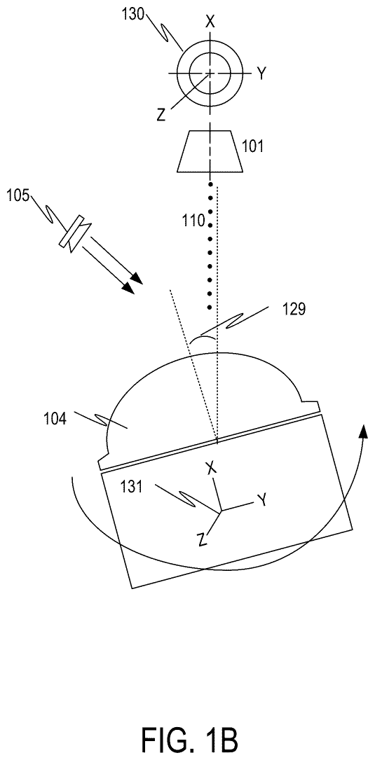

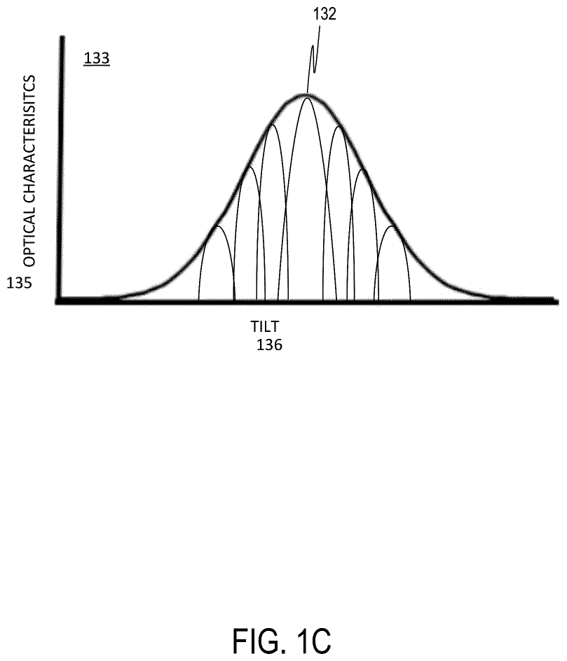

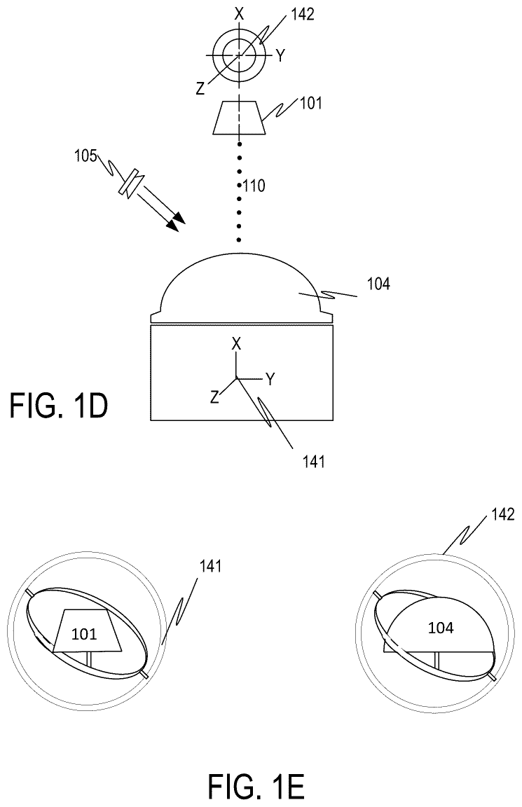

Referring now to FIG. 1, a side view 120A of a multifocal lens 120 with multiple optical interfaces that may result from optical sub-elements 121, 122, 123, 124 along a given optical path 128 through the multifocal lens 120. Each optical interface which may result from an optical sub-element 121, 122, 123, 124 will have an associated optical power such that a person (or automation) looking through the multifocal lens 120 may ascertain an image conveyed as an energy pattern in the visible light spectrum modified by one of the optical sub-elements 121, 122, 123, 124. Typically, modification of an image conveyed as energy in the visible light spectrum is described as an optical power, such as a minus 2.0 diopter; plus 1.25 diopter; or 0 diopter (sometimes referred to as a plano lens). An optical interface resulting from an optical sub-element 121, 122, 123, 124 may be unique within the multifocal lens 120 or repeated at different optical sub-elements 121, 122, 123, 124. A diopter may generally be considered to refer to a unit of refractive power that is equal to a reciprocal of a focal length (usually in meters) of a given optical sub-element 121, 122, 123, 124.

A person looking through the multifocal lens 120 along an optical path 125-128 may neurologically select an image as modified by one (or more) optical sub-element 121, 122, 123, 124.

In a healthy person with fully functional eyes, a state of the person's ciliary muscle will change when the person observes distant or close objects. When looking at a distant object, the ciliary muscle relaxes, the zonular fibers are tightened, and their lens is flattened. In this state the refractive power of the person's natural lens is enough to form an image of the focused object on the retina. To focus on a close object, inner structures of the eye adapt through a process of accommodation, which may be referred to as the accommodation reflex.

An accommodation reflex typically includes one or more of three responses: a) increase of the curvature of the lens; b) constriction of the pupil; and c) convergence of the eyes. During normal sight of a person in optimal ocular health, accommodation will cycle through the three responses. The cycling will quickly present multiple optical variations of energy in the visible light spectrum to the retina and optic nerve. A person will neurologically ascertain an image presented as the image to consciously register with the brain. Normal biological progression (such as via aging) limits each person's accommodation reflex and therefore limits optical variations of energy in the visible light spectrum presented to the person's optic nerve.

The present invention simultaneously presents multiple optical variations of energy in the visible light spectrum to the optic nerve. The simultaneous presentation of multiple optical variations of energy in the visible light spectrum to the optic nerve does not exactly replicate a human accommodation reflex since simultaneous presentation of multiple optical variations of energy does not involve physical motion. However, the simultaneous presentation of the multiple optical variations of energy in the visible light spectrum to the optic nerve allows a person to neurologically select an image presented as the image to consciously register with the brain in a fashion that is very similar to neurologically selecting an image from a sequence of images normally presented in a vision progression.

On a high level, a normal reflex pathway in a healthy person with functional accommodation may generally be considered to include: the optic nerve, visual and frontal cortex, oculomotor and accessory oculomotor nuclei and oculomotor nerve (CN III). In need of accommodation, the optic nerve sends initial impulses to the primary visual cortex through the lateral geniculate body and the optic radiation. From here, an impulse travels to an accessory/Edinger-Westphal nucleus of the oculomotor nucleus in the midbrain, through a visual association cortex.

An action of ciliary muscle is instructed by parasympathetic fibers originating from the accessory/Edinger-Westphal nucleus of oculomotor nucleus in the midbrain. The contraction of this muscle loosens zonular fibers, allowing the lens to relax. When the lens relaxes, the lens's degree of curvature increases, making it rounder. In this manner, a refractive power of a natural lens is increased allowing creation of sharply focused images of near objects on the retina.

A multi-focal lens provided herein allows for diminished functioning of the mechanical movement that is included as part of the accommodation reflex in a fully functioning healthy eye by simultaneously presenting multiple images to the retina and allowing the person to neurologically ascertain which image to cognitively process at a given moment in time.

Referring to top-down view 120B, in some embodiments, multiple disparate optical sub-elements 121-124 are formed by additive manufacturing processes that repeatedly apply a pattern of droplets (illustrated as a spherical pattern) with a different center point 132 position. Optical sub-elements 121-124 may be spherical or non-spherical, and may use the center point 132 or other calculated position for alignment. As illustrated, an offset of respective center points is exaggerated to emphasize relative positions of disparate optical sub-elements 121-124. In some exemplary embodiments, an offset may be between 100 nanometers and 1000 nanometers, and preferably between 400 nanometers and 600 nanometers, or between 40 microns and 60 microns.

Referring now to FIG. 1A, a schematic diagram illustrates an example of apparatus and underlying software forming an additive manufacturing system 100 with the, which when executed, the software makes the apparatus operative. As illustrated, the additive manufacturing system 100 includes one or more additive manufacturing print devices 101-102 that are operative to deposit droplets 110 of a polymerizable mixture 103 in a pattern of energy intensity and/or energy transmissibility (e.g., a grayscale pattern) onto a receiving surface 103A supported by a substrate 104. The deposit of droplets 110 may be accomplished, for example, via emitting a first volume of polymerizable mixture 110A in the form of droplets in a predefined pattern. A receiving surface for the droplets 110 included in the volume of polymerizable mixture 110A may include one or both of a receiving substrate 104 and previously deposited polymerizable mixture 103. Additional volumes of polymerizable mixture 110A, such as a second, third, and a desired number of additional deposits, such as, for example 12 to 22 volumes of polymerizable mixture 110A.

The receiving portion 104A of the substrate 104 may be smooth and arcuate in a manner making it suitable as a back curve of a contact lens. The receiving surface 103A may include one or both of the designated receiving portion 104A of the substrate 104 and previously deposited polymerizable mixture 103.

One or more actinic radiation source(s) 105 and 106 (which may contain LEDs emitting a same or different wavelengths of energy) receive control commands from one or more controllers 113. The controller includes a processor in logical communication with executable software commands stored on a digital storage. The executable software is executable upon command to operate the actinic radiation sources, and may also control relative movement of the additive manufacturing print devices 101-102 and a receiving surface 103A.

Some variants of the present invention include an enclosure 114 with one or more ports 107 and 108 for providing a controlled atmosphere 109 within the enclosure 114. The enclosure 114 may contain an atmosphere that is ambient to and encompassing one or more of: the substrate 104, print devices 101-102, droplets 110 polymerizable mixture (which are positioned to form an ophthalmic lens, such as a contact lens) from deposited polymerizable mixture 103 which has been built up on the substrate, and a source of actinic radiation 105-106.

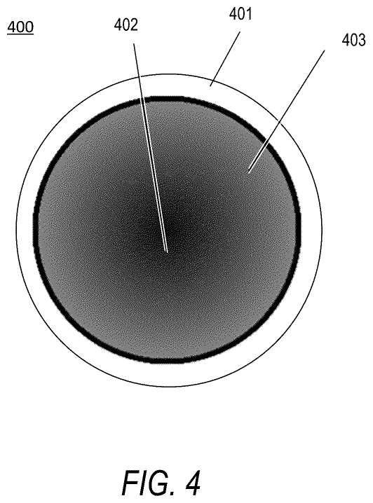

In some embodiments, the substrate 104 may be positioned proximate to, such as beneath, at least one 3D printing device 101-102 (as used in this sentence, “proximate to” refers to a distance suitable for a dispensed droplet to be emitted from a print device 101-102 and be accurately placed upon the substrate). The relationship of beneath or underneath may be derived from a direction of gravity. The print devices 101-102 are operative to dispense droplets of polymerizable mixture 110 onto a receiving surface 103A. The receiving surface 103A may include one or more of: a surface of the receiving portion 104A of the substrate 104; a surface of previously deposited polymerizable mixture 103; and a receiving portion of an insert, such as a RGP lens or an electronic device. The droplets are deposited in a pattern that reproduces an energy transmissibility pattern, such as a grayscale image. Successive depositions of the pattern are aggregated to form a volume of polymerizable mixture in a desired shape of a target optical element (e.g., see FIGS. 4,-5).

Following the application of the droplets of polymerizable mixture 110 to the receiving surface 103A to form a volume of polymerizable mixture 103, the polymerizable mixture may be exposed to a first dose (frequency, intensity, and length of time) of actinic radiation (which will be in a first range of wavelengths and for a first duration of time and a first intensity (such as, for example, ultraviolet or blue light). In some embodiments, the first dose of actinic radiation may be supplied to the deposited polymerizable mixture via a first source of actinic radiation 105. Final cure can be accomplished via exposure of the aggregated polymerizable mixture to a second dose of actinic radiation (which includes a second range of wavelengths, a second duration of time and a second intensity) and may be sourced from a same source of actinic radiation 105 or different source of actinic radiation 106. Final cure will allow a formed article. The formed article, such as an ophthalmic lens 111, may be removed from the substrate.

In some variants of the present invention, a final cure process step may additionally be performed in an environment with a controlled temperature, such as, for example, a temperature elevated above an ambient room temperature and/or a temperature maintained within a specified range.

According to some embodiments, a first printhead 101 of the system 100 may provide a first polymerizable mixture and a second printhead 102 may provide a second polymerizable mixture which may be compositionally the same or different from the first polymerizable mixture. One or both of the polymerizable mixtures may include functional additives or a non-polymerizable mixture (e.g., functional additives or solvents containing functional additives).

Ambient conditions within the system 100 may be controlled, such as, in particular with respect to an atmospheric gas (e.g., oxygen) content in a controlled atmosphere 109. In addition, in some embodiments, one or more of: temperature, ambient light, amount of particulate, size of particulate, circulation or other ambient atmosphere movement, and almost any variable that may affect one or more of: a movement of unpinned and unpolymerized deposited polymerizable mixture, polymerization of the deposited polymerizable mixture, and a shape of a device formed by polymerization of the deposited polymerizable mixture may be controlled.

In conditions where a substrate 104 is capable of transmitting actinic radiation or is transparent to actinic radiation, sources of radiation 105 and 106 may both, or either, individually or in alternate combinations, be located beneath or at an angle to substrate 104 as well as that shown in FIG. 1. In addition, a shutter or other actinic radiation shield may be located above or on a lateral side of a receiving surface. The shutter or other actinic radiation shield is positioned and functional to shield the printhead from actinic radiation or other actinic conditions.

The nature of the ambient gaseous environment can be controlled, for example, through the use of purging nitrogen gas though the inlets 107-108. Purging can be performed to increase or reduce oxygen partial pressure to predetermined levels.

Referring now to FIG. 1B, in some embodiments, disparate optical sub-elements 121-124 may be formed by emitting a same pattern of droplets during multiple passes of a printhead 101 relative to a receiving substrate 104 with a tilt 129 being introduced of the printhead 101 relative to the receiving substrate 104. A pass of the printhead 101 relative to the receiving substrate 104 may include movement of one or both of the printhead 101 and the receiving substrate 104.

In other embodiments, a tilt 129 is introduced via software adjustment to a pattern of droplets deposited. Additionally, in some embodiments, a pattern of droplets may be modified based upon a corneal topography. The corneal topography may be measured for example, with a SW-6000 corneal topographer by Suoer or an Atlas corneal topographer by Zeiss.

Preferably a tilt 129 is imparted after a conclusion of a pass of the printhead 101 relative to the receiving substrate 104. A tilt 129 may include, by way of non-limiting example about 500 nanometers (or fifty microns) of movement, plus or minus 20%. A tilt mechanism 130-131 may include a servo, a gimble, or other electro-mechanical or mechanical device capable of precise movement.

Referring now to FIG. 1C, a graph 133 illustrates an exemplary change in optical characteristic 135 relative to an amount of tilt 136 of a given pattern from a center point position 132.

Referring now to FIG. 1D, a schematic diagram illustrates a printhead 101 relative to a substrate 104 and dispensed droplets 110 of polymerizable mixture in the presence of a source of actinic radiation 105. One or both of the printhead 101 and the substrate 104 are in mechanical communication with a respective actuator 141-142. A substrate camber actuator 141 may be operative via that mechanical communication to provide an inclination or tilt to the substrate relative to a stream of dispensed droplets 110 and the printhead 101. Similarly, a printhead camber actuator 142 may be operative via mechanical communication with a printhead 101 to provide an inclination or tilt to the printhead 101 relative to a substrate 104 or other receiving surface (e.g., previously deposited droplets of polymerizable mixture that may have been pinned, or pre-polymerization).

Referring now to FIG. 1E, a substrate camber actuator 141 and/or a printhead camber actuator 142, which may include a servo 141-142, or multiple servos 141-142 in collaboration to provide camber movement or tilt to one or both of the substrate 104, and the printhead 101. The schematic illustration portrays the servos as a gimble to represent the multi-direction movement capabilities, however, any type of electro-mechanical, or electro device that provide appropriate movement may be used, such as for example, a shape memory alloy to other electro active material.

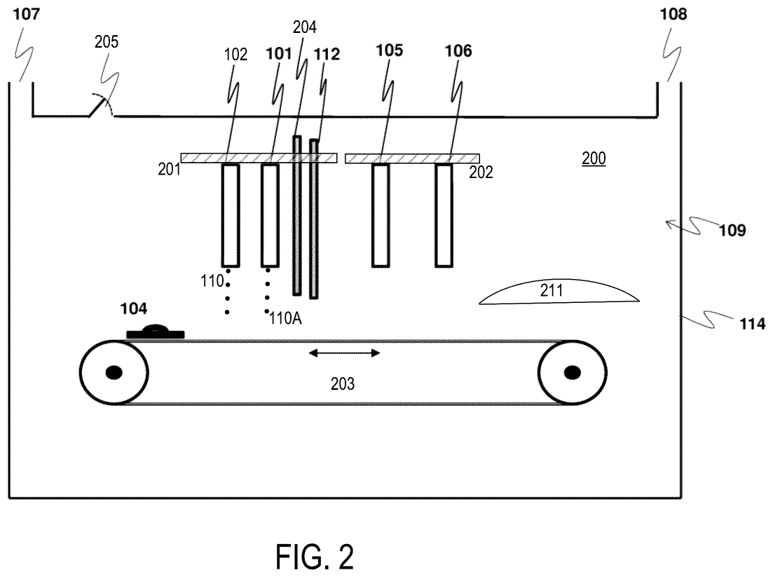

Referring now to FIG. 2, a schematic diagram illustrates some alternative aspects that may be incorporated into a 3D additive manufacturing system 200. Some of same reference numbers are used as for FIG. 1 (e.g., 3D printheads 101-102, actinic radiation source(s) 105 and 106, substrate 104, an enclosure 114 with one or more ports 107 and 108, and a controlled atmosphere ambient to deposited polymerizable mixture 110). Additionally, the embodiments illustrated in FIG. 2 include an oxygen sensor 204, gate 205 for moving components in and out of the enclosure 114, a UV blocking screen 112 and an actuation structure 203 (e.g., a belt drive or stepper motor linear drive) configured to provide movement relative to the substrate 104 and the one or more 3D printhead 101-102 and/or movement relative to one or more actinic radiation source 105-106.

The 3D printing system 200 illustrated is similar to that of FIG. 1, as illustrated in FIG. 2, also includes one or more actuators 201-203 configured (and operative) to provide relative movement between the substrate 104 and the one or more of: the 3D printhead(s) 101-102; actinic radiation source(s) 105-106; and the actinic radiation source(s) 105-106, and in some embodiments, blocking screens 112 and/or enclosures. In some embodiments, a printhead actuator 201 is configured (and operative) to move one or more of the printheads 101-102 relative to the substrate 104. Similarly, a radiation source actuator 203 is configured (and/or operative) to move one or more actinic radiation sources 105-106 relative to the substrate 104. A substrate actuator 203 is configured (and/or operative) to move the substrate 104 relative to one or both of the printheads 101-102 and the actinic radiation sources 105-106. Although a belt drive 203A is illustrated as actuation structure 203 and a stepper motor track illustrated as actuation structures 201-202, other devices and apparatus are within the scope of the present invention. The actuation structures 201-203 may be synchronized such that relative movement between one or more of: the substrate 104, printheads 101-102, and actinic radiation sources 105-106 can be coordinated with deposition of polymerizable material 110 from the printhead(s) 101-102.

The processes presented herein may be practiced on the systems 100 and 200 described to form an optical element 211. The process may include operation of one or more printheads 101-102 with a first printhead 101 dispensing droplets 110 of a first polymerizable mixture and one or more additional printhead(s) 102 dispensing droplets 110A of compositions that may include: a first polymerizable mixture, a second polymerizable mixture which is compositionally different from said first polymerizable mixture, and a non-polymerizable substance or mixture.

In some embodiments, one or more of: the first polymerizable mixture, the second polymerizable mixture, and the non-polymerizable mixture include one or more functionally active substance, such as, for example, a substance in dissolved form.

In the disclosure herein, ophthalmic devices (and/or contact lenses) are used for illustrative and discussion purposes, however the principles are applicable for the formation of articles of manufacture in general and the teachings presented may be broadly used in any optical element (or other article) for which precise dimensional shapes; optical properties; and/or similar uniform polymer properties are preferred, such as, for example, intraocular lenses.

According to the present invention, in some embodiments, a polymerizable mixture is delivered in the form of extremely small droplets of typically 1-15 picolitre amounts at high velocities through a gaseous atmosphere with relatively high surface to volume ratios. A large number of droplets (estimated to be between 1.5 and 9 million) are required to form a 25-milligram lens. In delivering each droplet to a proper place during manufacturing, several factors may be considered. The factors may include, but are not limited to, one or more of: exposure of the droplet to ambient process conditions; a thickness of a resulting layer of material when the droplets impact a surface comprising one or both of a substrate and previously deposited polymerizable mixture; an interaction with a receiving surface comprising the substrate and/or previously deposited polymerizable mixture, such as wetting of the receiving substrate surface and merging with the previously deposited polymerizable mixture; effects of impinging droplets; pinning via an exposure time to actinic radiation and/or atmospheric gases between subsequent layers of droplets of polymerizable mixture; and curing/polymerization of deposited polymerizable mixture.

During the additive manufacturing process. there is significant opportunity for exposure of the polymerizable mixture to (and uptake of) an ambient gas, such as oxygen, from one or more of: an ambient process atmosphere (sometimes referred to as a controlled atmosphere); a receiving substrate surface; and previously deposited droplets of polymerizable mixture; if such factors are not accurately controlled, surface and bulk properties of a resulting ophthalmic lens (including optical properties) will be adversely affected.

The influence of oxygen is particularly acute in lenses produced using hydrogel materials such as 2-hydroxyethyl methacrylate (HEMA) or other monomers used in soft contact lenses and soft intraocular lenses. In these materials, variations caused by exposure to oxygen are more obvious in a final cured lens after the lens has absorbed water. In preferred embodiments therefore, exposure to oxygen may be considered to have a negative influence.

Typically, surface or skin portions of a lens formed with more oxygen present contain more polymer network defects than a bulk portion allowing more water to be absorbed in the areas formed with more oxygen present. The resulting distortion in these skin regions usually has a negative impact on the overall mechanical properties (modulus, tensile strength, elongation), optical properties (light transmission, refractive index etc.), shape, and part to part repeatability.

The present invention teaches control of, and adjusting of an oxygen content of the polymerizable mixture in relation to the oxygen content of the controlled atmosphere (as described herein) in order for the effects of oxygen to be controlled to an extent that the properties of an optical element formed are not significantly impacted.

In those embodiments that include the formation of ophthalmic devices, (e.g., contact lenses; intraocular lenses; and spectacle lenses), the ability to create an optical prescription is highly dependent on precise shapes of curved surfaces. Producing these required surfaces on these and other non-ophthalmic optical elements can be achieved by using the principles claimed in this invention, thus enabling the benefits of using 3D deposition printing such as simplicity, efficiency, more degrees of freedom in design, lower time requirements, and costs.

In some embodiments, the present invention provides apparatus and methods of operating the apparatus for three-dimensional deposition manufacture of an ophthalmic device in which a plurality of droplets of polymerizable mixture are deposited onto the surface of a substrate (and/or previously deposited polymerizable mixture) under a controlled atmosphere thereby forming a layer of polymerizable mixture into a pattern replicating a map of energy transmissibility (such as a grayscale image).

In some embodiments of the present invention, an oxygen concentration in polymerizable mixture may be adjusted in relation to one or more of: an oxygen concentration of the controlled atmosphere to which the polymerizable mixture is exposed; an oxygen concentration in other parts of the environment (such as, for example a substrate receiving droplets of polymerizable mixture) so that migration of oxygen from one source to the other is avoided or at least suppressed to a degree that is insignificant to the polymerization of the polymerizable mixture.

Release of the Ophthalmic Device from the Substrate and Post-Treatment

Following sufficient deposition of polymerizable mixture 103 to form an optical element 211 (e.g., ophthalmic device) and performance of a curing process, the optical element 211 is typically released from the substrate. It is preferable that the polymerizable mixture 103 deposited in a specific pattern to form the optical element 211 is sufficiently physically bound to the substrate 104 during preparation of the optical element 211 to prevent unwanted movement relative to the substrate 104, however, the polymerizable mixture 103 should not be bound so securely that removal of the optical element 211 from the substrate 104 damages the optical element 211. For example, in some embodiments, care should be taken that no covalent bonds are formed between the polymerizable mixture 103 and the substrate 104 during preparation of the optical element 211, including the curing of the polymerizable mixture 103.

The ophthalmic device 211 may be released (or otherwise removed) from the substrate 104 by physical means so as to be able to manipulate the optical element 211 in various ways. For example, the optical element may be manipulated via one or more of: washing the optical element 211 to remove by-products, soaking the optical element 211 in buffered saline, tinting, marking, and packaging the optical element 211. For example, in some variants of the present invention, such as when the optical element 211 is formed with a hydrogel polymer, the optical element 211 may be soaked with one or both of: water, and a solution, such as a buffered saline solution, sufficiently to cause the optical element 211 to expand. The expansion facilitates release of the optical element 211 from the substrate 104. A solution may also include one or more release agents. Release agents may include compounds, or mixtures of compounds, which, when combined with water, decrease a time required to release an optical element 211 from the substrate 104, as compared to a time required to release such an optical element 211 using an aqueous solution that does not include the release agent(s).

Although typically preferred, it is not strictly necessary that the curing of optical element 211 is completed before release from the substrate 104.

In some embodiments, after curing, the optical element 211 is subjected to one or more extraction process steps to remove unreacted components from the optical element 211. The extraction process steps may be executed using one or more of: conventional extraction fluids, organic solvents, alcohols; water (or aqueous solutions such as buffered saline). In various embodiments, extraction can be accomplished, for example, via immersion of the lens in an aqueous solution or exposing the lens to a flow of an aqueous solution. In various embodiments, extraction can also include, for example, one or more of: heating the aqueous solution; stirring the aqueous solution; increasing the level of release aid in the aqueous solution to a level sufficient to cause release of the lens; mechanical or ultrasonic agitation of the lens; and incorporating at least one leach aid in the aqueous solution to a level sufficient to facilitate adequate removal of unreacted components from the lens. The foregoing may be conducted in batch or continuous processes, with or without the addition of heat, agitation, or both. The ophthalmic device may also be sterilized by known means such as, but not limited to, autoclaving and radiation sterilization. Sterilization may take place before or after packaging the optical element 211 in a suitable storage container, preferably after packaging. In some preferred embodiments, the optical element 211 is packaged in an aqueous solution.

For optical elements 211 formed with hydrogels, the packing may include packing in a physiological saline solution with around 0.9% sodium chloride and suitable buffering agents such as phosphate or borate buffer systems. In addition, the packing solution may include one or more functionally active substances including biologically active substances.

Aqueous solutions may also include additional water-soluble components such as release agents, wetting agents, lubricating agents, active pharmaceutical ingredients, vitamins, antioxidants and nutraceutical components, combinations thereof and the like. In some embodiments, the aqueous solutions comprise less than 10 weight-%, and in others less than 5 weight-% organic solvents such as isopropyl alcohol, and in another embodiment are free from organic solvents. Depending upon a composition of the aqueous solution. The aqueous solution may or may not require special handling, such as purification, recycling, or special disposal procedures.

In some embodiments, an aqueous content of a hydrogel optical element 211 includes at least 30 weight-% water, in some embodiments at least 50 weight-% water, in some embodiments at least 70 weight-% water and in others at least 90 weight-% water.

In variants of the present invention, a polymerizable mixture 110 comprises hydroxyethyl methacrylate (HEMA) monomers, and the method comprises the subsequent step of swelling the optical element, preferably an ophthalmic device, in water, whereby the optical element obtains a water content from 10 to 80 weight-%, and preferably from 35 to 70 weight-%.

In embodiments, the polymerizable mixture 110 comprises acrylate monomers not including HEMA monomers, and the method comprises the subsequent step of swelling the optical element, preferably an ophthalmic device, in water, whereby the optical element obtains a water content from 10 to 80 weight-%, and preferably from 35 to 70 weight-%.

In embodiments, the polymerizable mixture 110 comprises reactive silicone precursors, and the method comprises the subsequent step of swelling the optical element, preferably an ophthalmic device, in water, whereby the optical element obtains a water content from 5 to 70 weight-%, and preferably from 10 to 50 weight-%.

### Novel Ophthalmic Devices

The methods and apparatus of the present invention enable the formation of an optical element 211 with previously unobtainable designs, such as, by way of non-limiting example, one or more of: a contact lens or intraocular lens with a non-rotationally symmetrical surface, with corresponding optical corrections, including very steep radii of curvature and very high spherical and cylindrical corrective components; a contact lens or intraocular lens including multiple spherical and cylindrical corrections within the same lens as opposed to a single spherical corrective power reflecting the power distribution map of the eye and not just the average corrective power of refractive power from a phoropter or refractometer; and a contact lens or intraocular lens capable of (due to non-rotational symmetry) correcting optical aberrations resulting from poor surgical outcomes of PRK or LASIK or LASEK surgery or from aberrations due to an unusual corneal surface.

### Repetitive Grayscale Image Based Additive Manufacture

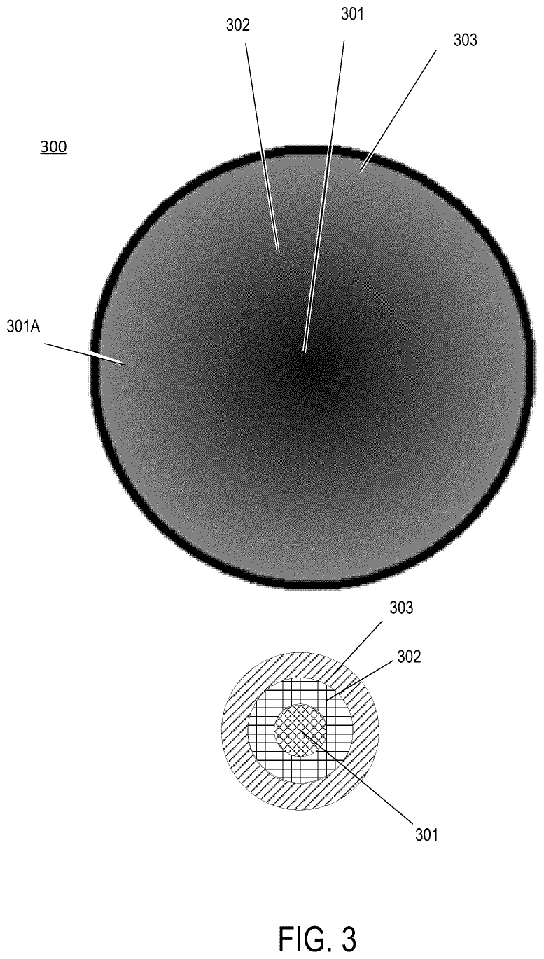

Referring now to FIG. 3, an exemplary energy transmissibility pattern, such as a grayscale image 300, may be used to create additive manufacturing control commands to control release of droplets of polymerizable mixture in a pattern that replicates the grayscale image 300.

For example, in some embodiments, a map of data that either directly or through conversion represents an amount of deposition of polymerizable mixture at a given location that corresponds with data values associated with pixels included in a grayscale image 300, such as, for example, an integer map. In other embodiments, a value associated with a pixel may be a float point or other expression of a whole number of a real number. The data values may correspond with an amount of energy transmissibility at a pixel location and the data values may be accessed electronically and a processor executing software commands may convert the data values to additive manufacturing printhead control commands. The printhead control commands are executable to control a deposition of a polymerizable mixture at locations that correspond to the pattern replicating the grayscale image 300 on a pixel by pixel basis. For example, a data value with a relatively larger digital number may correspond with a lighter area of the grayscale image 300 and may correspond with an emission of a lesser amount of polymerizable mixture from a printhead than an emission corresponding with smaller number and a darker area of the grayscale image.

A greater amount of polymerizable mixture may correlate with a thicker deposit 301 and a value of a control command may be assigned by conversion of a grayscale value at the location of a thicker deposit 301 to a control command value of the printhead for a thicker deposit 301. Likewise, a lighter value included in the grayscale may correspond to a thinner deposit 301A and a value of a suitable printhead control command may be assigned by conversion of the lighter grayscale value to an appropriate control command value for a thinner deposit 301A.

In some examples, the thicker deposit 301 may be formed by printing a relatively larger amount of polymerizable mixture on a particular location of a receiving surface during a pass of 3D printhead over the receiving surface being printed upon, and a thinner deposit 301A may correspond with printing a relatively lesser amount of polymerizable mixture at a position of a thinner deposit 301A. A thicker deposit 301 may correspond with a relatively darker portion of a grayscale image 300 and a thinner amount 301A may correspond with a relatively lighter portion of the grayscale image 300.

According to the present invention, following each pass of the printhead and associated polymerizable mixture deposition, the deposited polymerizable mixture may be allowed to “sit” for a short period during which the material will be acted upon by physical forces, such as for example one or more of: gravity, surface tension and microforces to modify surface characteristics. Modifying surface characteristics may include, by way of non-limiting example, one or more of: leveling out high and low areas formed during the deposition process; smoothing a surface of the deposited polymerizable mixture; flowing deposited polymerizable mixture into interstitial areas; and form a uniform edge of deposited polymerizable mixture.

Essentially, the present invention allows for an upper surface 302 that is formed by physical forces existing in nature, as opposed to a manufactured surface, such as a mold surface and/or a lathed surface. Gravity will smooth an upper surface of deposited polymerizable mixture prior to the deposited polymerizable mixture undergoing a gelation process, such as, for example, the deposited polymerizable mixture being pinned by exposure to a controlled amount of actinic radiation.

In some variants of the present invention, a control command may be used to determine how many passes a 3D printhead has made over a receiving surface. A number of passes of the 3D printhead may correlate with a thickness of polymerizable mixture deposited and also correlate with an amount of energy transmissibility at particular locations of a pattern of deposited polymerizable mixture. In this manner, deposited polymerizable mixture may be deposited, pinned and ultimately cured in a shape and volume suitable to form an ophthalmic lens with desired ophthalmic qualities. Deposited polymerizable mixture achieves sufficient thickness and suitable shape by repeated application of a corresponding grayscale image.

In some variants of the present invention, each pass of the 3D printhead may print a pattern of polymerizable mixture corresponding with a same grayscale image, in other embodiments, a different pass of the 3D printhead may correspond with a different grayscale image than a previous pass. As mentioned previously, in some variants of the present invention, each pass of a 3D printhead depositing polymerizable mixture may be followed by exposures of the polymerizable mixture to a gelation process, such as an amount of actinic radiation, thermal activation, or the like, that is sufficient to partially polymerize the deposited polymerizable mixture. A curing process may be performed after a final pass of polymerizable mixture is performed. In various embodiments, a final layer may be exposed to a pinning step, and/or move directly to a full curing process.

Curing and/or pinning may be facilitated by inclusion of one or more photo initiators with the deposited monomer. Photoinitiators may include, by way of non-limiting example, initiators activated by energy of or about 392 nM and 400 nM.

In some examples, an energy transmissibility pattern (e.g., a grayscale image) may be derived from optical modelling and/or mathematical models descriptive of desired optical qualities.

In some other embodiments, an article in physical form that may be processed, such as via an optical scanning process, image capture process, or photographing process, to capture the energy transmissibility data into an electronic form, such as, for example, a digital data value, and the electronic form may be converted to control commands.

Some variants of the present invention include a grayscale image with a generally spherical shape, where the darker values are associated with thicker deposits. Thus, a different conversion protocol may be assigned to different grayscale images depending on which values correspond to thick and thin deposits, respectively.

In some examples, a single grayscale image may be used to represent a desired product lens and its associated control commands. The single grayscale image is repeatedly deposited in successive passes of the 3D printhead, one pass following another until a desired optical quality is embodied in the deposited polymerizable mixture which may be cured to form an article that also meets physical parameters suitable for wearing on an eye of a patient.

In other examples, a series including two or more different grayscale images may be assembled to create multiple sets of control commands. The control commands may result in deposit of different shape designs and physically create an additive composite of the images. In other examples, multiple grayscale images may be combined and processed before any processing occurs. In some examples, a combination of multiple images may be normalized to correspond with upper and lower thickness factors.

In some examples, different features such as edge profiles 303, alignment features, and the like, may be programmed into an optical element command protocol by the addition of grayscale images to a lens profile.

In some examples, a refractive element 301A may be designed at a location on a surface plane as an array of grayscale values, where the values correspond to an added thickness or range of thickness in the printing process. In a similar example, a constant grayscale value may equate to a plano lens element with no refractive power added to any underlying structure.

In some examples, a grayscale image may be referenced from numerous filetypes such as, by way of non-limiting example, one or more of: jpeg, tiff, bmp, png and the like, may be used to create a control command protocol to print a desired article, such as an ophthalmic lens article, by varying an amount of polymerizable mixture that is deposited at disparate locations thereby resulting in with more polymerizable mixture deposition in areas targeted for thicker deposits. The result of printing an entire pattern may result in an article with no interstitial areas.

In some variants of the present invention, a grayscale in an image or additive combination of images, may correspond to processing of multiple disparate passes of a 3D printhead, wherein an amount of polymerizable mixture deposited in specific locations and subjected to a pinning process before a next deposition pass is completed. A polymerizable mixture deposited during a printing process pass may be a monomer mixture with various included photo initiators. One of the photo initiators may be associated with a wavelength of actinic radiation exposure during an associated pinning processes. After multiple printing passes have been processed, an entire volume of polymerizable mixture deposited on a receiving substrate may be subjected to a curing process. In some examples, the curing process may be exposure to actinic radiation of a different wavelength and exposure time, intensity, and the like.

In another aspect, in some embodiments, a grayscale pattern or an energy transmissibility pattern may be dithered via a dithering process or algorithm prior to generation of a control command for the printhead based upon the grayscale or energy transmissibility pattern in order to generate a smoother image deposited via expulsion of droplets from the printhead and accumulation prior to curing. Dithering may include, way of non-limiting example, processes consistent with Floyd-Steinberg, Burkes, Sierra, Two Row Sierra, Jarvis, Stevenson, Arce, or other process.

Referring now to FIG. 4, an optical element 400 is illustrated according to some embodiments of the present invention. The optical element 400 includes a periphery portion 401 that may be printed or otherwise formed before an optical zone portion 402 of the optical element 400. A lens carrier portion 403 may transition the optical zone portion 402 and the periphery portion 401. The carrier portion 403 is preferably of a size and shape conducive to comfortably maintaining a completed lens in place on a wearer's eye. During additive manufacturing of the optical element 400, polymerizable mixture included in the periphery portion 401 may be deposited and pinned, but not fully polymerized, before the polymerizable mixture included in the optical zone portion 402 is printed and pinned. In some preferred embodiments, the periphery portion 401 may include a greater mass so that as the polymerizable mixture cures into a polymer, stresses resulting from the polymerization process will not deform the optical zone portion 402 due to stabilizing influence of the greater mass of the periphery portion 401.

In some embodiments, the periphery portion 401 may remain with the optical element 400 and form a comfortable edge feature. In other embodiments, some or all of a periphery portion 401 may be removed, such as, for example, via laser trimming.

Embodiments that include a higher mass periphery zone portion 401 may be formed via the steps of: a) printing or otherwise depositing polymerizable mixture in the periphery zone portion (which, for a spherical lens may have a generally annular, and other lenses a corresponding perimeter shape such as an oval shape or almond shape); b) pinning the polymerizable mixture in the periphery zone portion 401, wherein pinning will preferably occur after each pass of a print head depositing monomer; c) printing or otherwise depositing polymerizable mixture in an optic zone; pinning the polymerizable mixture in the optic zone; and curing the deposited polymerizable mixture. Some embodiments may additionally include placing a cap in the optic zone to provide an optic quality.

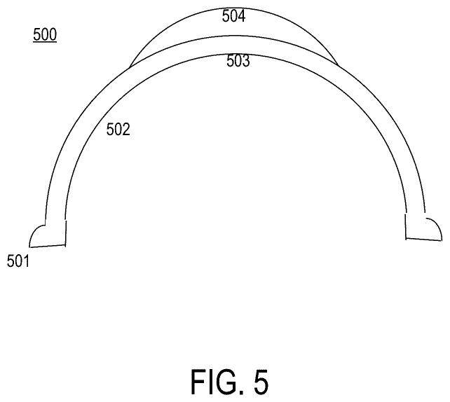

Referring now to FIG. 5, a profile cutaway view with a periphery portion 501 and a carrier portion 502 supporting an optic zone 503 and an optic insert or cap 504. In some embodiments of the present invention, the periphery portion 501 may include a higher mass than a carrier portion 502 and/or optic zone 503 portion of the lens 500.

### Axial Thickness Profile Generation

The hydrated contact lens front surface radius of curvature (R_{F}) is generated from the thick lens formula using the in-air lens power (P), lens index of refraction (n), center thickness (CT), and back surface radius of curvature (R_{B}).

The thick lens formula may include, by way of non-limiting example:

$$The effective focal length for a thick \\ lens with respect to the principal planes is given by$$

$$\frac{1}{f} = ( n - 1 ) [ \frac{1}{{R}_{1}} - \frac{1}{{R}_{2}} + \frac{( n - 1 ) d}{{nR}_{1} {R}_{2}} ]$$

$$and the distances from the lens vertices to the principal planes are$$

$${h}_{1} = - \frac{f ( n - 1 ) d}{{R}_{2} n} {h}_{2} = - \frac{f ( n - 1 ) d}{{R}_{1} n}$$

For an ophthalmic lens, exemplary variables may include:

$${R}_{1} = {R}_{F} ( m )$$

$${h}_{1} = {h}_{F}$$

$${R}_{2} = {R}_{B} ( m )$$

$${h}_{2} = {h}_{B}$$

$$d = CT ( m )$$

$$\frac{1}{f} = P$$

### R_{F}.

$${R}_{F} = \frac{( n - 1 ) ( n {R}_{B} + ( n - 1 ) C T )}{n {R}_{B} P + n ( n - 1 )}$$

Front and back optic zone surfaces may be generated from front and back radii of curvature and center thickness of the ophthalmic lens other optical element.

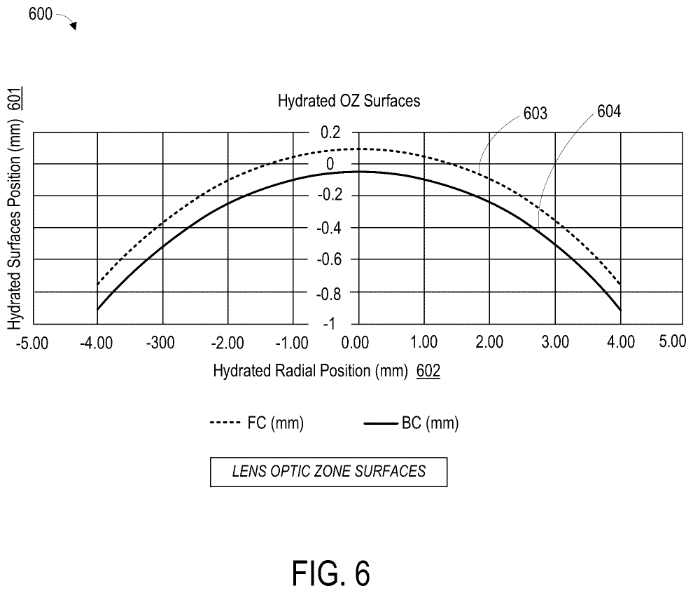

Exemplary surfaces are shown for a −3.0D design with a 0.1008 mm center thickness, a 9.1 mm back radius of curvature and an index of refraction of 1.4055 are shown in FIG. 6.

In some embodiments, an axial thickness profile may be generated by subtracting a back surface position from a front surface position for multiple radial positions.

A ratio of a hydrated lens to an unhydrated lens may vary based upon the lens material and hydrated lens is 1.4 times larger in each direction than the un-hydrated lens. Therefore, an un-hydrated axial thickness profile may be about 1.4 times smaller than an axial thickness profile generated from the hydrated lens front and back surfaces (as used herein, the term about may be within 10% of a stated amount). Also, radial positions may be about 1.4 times smaller for the un-hydrated lens.

Referring now to FIG. 6, a graphical representation 600 of an optical zone front curve surface 603 and back curve surface 604 of a hydrated ophthalmic lens is illustrated.

The graphical representation 600 includes a first axis with a scale of a hydrated surface position 601 and a second scale with a hydrated radial position 602. A first curve maps values of a front curve 603 and a second curve maps values of a back curve 604 of an ophthalmic lens optic zone.

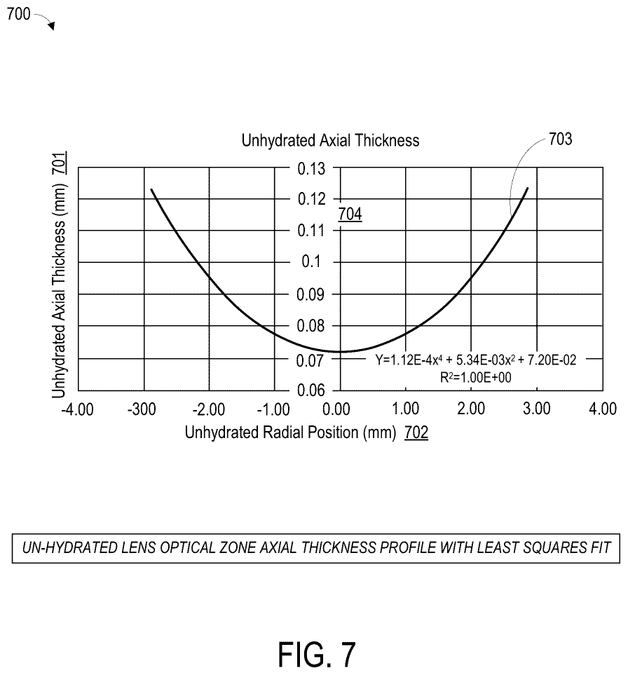

Referring now to FIG. 7, a graphical representation 700 of an un-hydrated ophthalmic lens optical zone axial thickness profile 703 is illustrated. In preferred embodiments, an axial thickness profile may be adequately described by an even 4^{th} order polynomial. The coefficients from this model may be referenced to generate an optical zone portion of grayscale print pattern, or other energy transmissibility or energy intensity map pattern.

The graphical representation 700 includes a first axis with a scale of an unhydrated axial thickness 701 and a second scale with an unhydrated radial position 702. A curve maps values of axial thickness 703 of an ophthalmic lens optic zone, with numerical values correlating with the thickness 704 displayed in the middle of the graphical representation 700.

For astigmatic lenses, optical power is different for different directions (meridians) in the optical zone. For example, a −2.75D/−4.5DX90 has a power of −2.75D in a vertical direction and −7.5D in a horizontal direction. A resulting axial thickness profile may vary meridian within the optical zone and is ‘flattest’ in the vertical direction and ‘steepest’ in the horizontal direction.

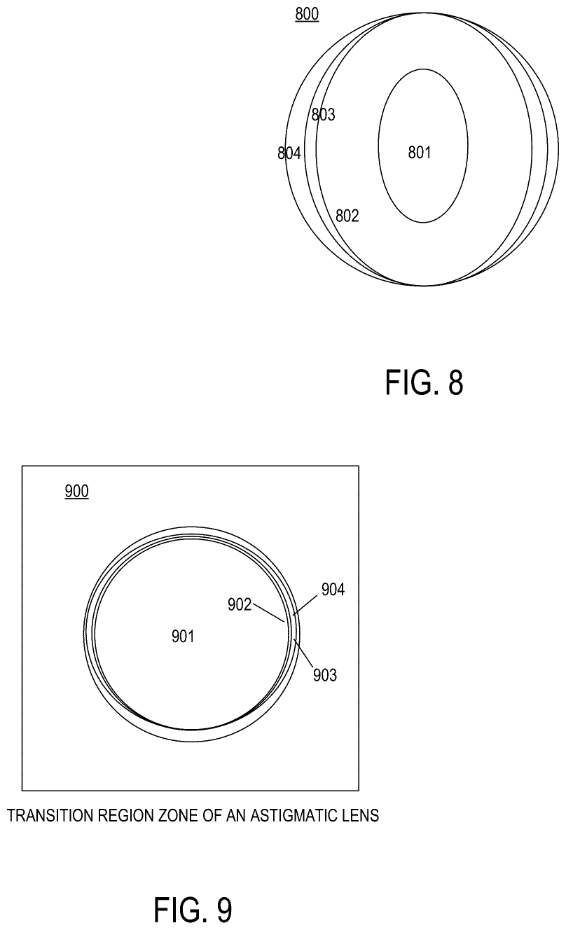

Referring now to FIG. 8, a false color image of a thickness profile 800 is illustrated for an optic zone, where ‘a first intensity 801 represents small thickness, and fourth intensity 804 represents an area with a relatively large thickness. One or more intermediate thicknesses 802-803 may also be included, such as a first intermediate thickness 802 and a second intermediate thickness 803. Each thickness may be achieved by depositing an appropriate amount of polymerizable mixture in the respective positions indicated by the thickness profile 800, allowing the polymerizable mixture to settle, pinning the settled polymerizable mixture in place via a gelation process, and finally curing the deposited and pinned polymerizable mixture.

A horizontal (most negative power) and vertical (most positive power) axial thickness profiles may be modeled by even 4^{th} order polynomials and the coefficients used to generate an optical zone grayscale print pattern represented by the thickness profile 800.

### Energy Transmissibility Print Pattern Generation

In some embodiments, an energy transmissibility print pattern (which may be a grayscale print pattern or other representation of energy intensity) may include two (2) or more regions: an optical zone 801-804 (as illustratively defined by the axial thickness profile); and a periphery (not pictured). Other regions may also be included, such as a region that contains a medicament or other leachable substance. Each region may be defined by various methods. For example, by way of non-limiting example, a pixel size of the print pattern may be specified to be about 0.021 mm. An un-hydrated lens diameter may be, for example: 10.0 mm. A number of pixels in the X & Y directions is defined by the relationship:

$${n}_{p i x e l s} = 2 * round ( \frac{Diameter}{2 * pixel size} ) + 1$$

This definition ensures that nₚᵢₓₑₗₛ is odd, so that the center of the lens is at a center of a print pattern.

A number of grayscale levels may also be specified, such as, for example, a print pattern of 8 bits (255 gray levels.) It is within the scope of this invention for both of these values to be changed which may affect the quality of a printed lens.

### Spheres

A spherical lens includes an optical zone that is generally rotationally symmetric (within 10% of symmetry) and may be defined, for example, by using an un-hydrated lens center thickness, and the coefficients from the even 4^{th} order model:

$$thickness ( mm ) ( x , y ) = C T ( mm ) + {C}_{2} ( {mm}^{- 1} ) {r ( mm )}^{2} + {C}_{4} ( {mm}^{- 3} ) {r ( mm )}^{4} ,$$

$$r ( mm ) = p i x e l S i z e ( mm ) * sqr t ( {( x - {x}_{0} )}^{2} + {( y - {y}_{0} )}^{2} ) ,$$

where (x₀, yₓ) is the print pattern center. Other variations are also within the scope of the invention.

A center thickness (CT) used to generate a thickness profile may be based upon a hydrated thickness to the number of layers to be printed times the layer thickness. Thus, if a hydrated lens CT is 0.120 mm, the number of layers to print is 6, and the layer thickness is 0.012 mm, the CT used to generate the print pattern is 0.120 mm−0.72 mm=0.048 mm.

In some preferred embodiments, this may be done to ensure that a ratio of a ‘brightest’ to ‘darkest’ pixel in the pattern remains in an acceptable range for printing. In other embodiments, images may be converted by print head controller software to binary images. If a range of grayscales is too large, ‘bright’ regions may not have enough ‘dark’ pixels to create a smooth lens surface.

A thickness may be calculated for pixels where r is less than the un-hydrated optical zone semi-diameter (rₘₐₓ), typically 4.0 mm/1.4(˜2.857 mm.)

A periphery is the region where r(mm) is outside the optical zone 801-804, but within a lens diameter. Many different methods may be used to define a thickness profile of the periphery. For example, in some preferred embodiments, patterns use a thickness at the edge of the optical zone for all pixels in the periphery. Alternate methods may include one or more of: linearly tapering the thickness from the value at the edge of the optical to a value defined at the ‘edge’ of the lens; and tapering the thickness from the value at the edge of the optical to a value defined at the ‘edge’ of the lens using a higher order polynomial, or conic section; adding a ‘stiffening’ ring to the periphery to improve lens handling; tapering using different methods in different zones of the periphery; and a combination of tapering and a ‘stiffening’ ring.

### Torics (Astigmatic Lenses)

An optical zone may not be rotationally symmetric and may be defined using an un-hydrated lens center thickness, the two (2) sets of coefficients from the even 4^{th} order models of the most positive and most negative power meridians, and a desired angle in a print pattern of a most positive power meridian.

For example, in some embodiments, print patterns may be generated vis calculating the ‘effective’ 2^{nd} order coefficient for each principle meridian:

$${C}_{2 , effective} ( {mm}^{- 1} ) = {C}_{2} ( {mm}^{- 1} ) + 0.5 {C}_{4} ( {mm}^{- 3} ) {{r}_{max} ( mm )}^{4}$$

The ‘equivalent’ r₂ coefficient is defined as the average of the two (2) effective coefficients. The astigmatic coefficient is defined as:

$${C}_{2 , 2} ( {mm}^{- 1} ) = 0.5 ( {C}_{2 , effective , minus} ( {mm}^{- 1} ) - {C}_{2 , effective , plus} ( {mm}^{- 1} ) ) ,$$

where C_{2,effective,plus} is the effective second coefficient of the most positive meridian, and
C_{2,effective,minus} is the effective second coefficient of the most negative meridian.
   For each pixel in the lens print pattern, the distance from the lens center (r(x,y)) and the angle in standard Cartesian coordinates (θ(x,y)) are calculated.

An optical zone thickness may be defined as:

$$thickness ( mm ) ( x , y ) = CT ( mm ) + ( {C}_{2 , equivalent} ( {mm}^{- 1} ) + {C}_{2 , 2} ( {mm}^{- 1} ) cos ( ϑ ( x , y ) + φ ) ) r ( mm ) {( x , y )}^{2} ,$$

where φ is the angle of the most positive meridian.

A thickness at the edge of the optical zone varies with angle. For toric print patterns, a transition zone may be generated to produce a single thickness value for all angles. The transition zone may be an annulus 0.5 mm wide for the hydrated lens (0.5 mm/1.4 for the un-hydrated lens.) A target thickness for the transition may be equal to a minimum thickness at the optical zone boundary and may essentially be equal to:

$${thickness}_{target} ( mm ) = C T ( mm ) + ( {C}_{2 , equivalent} ( {mm}^{- 1} ) + {C}_{2 , 2} ( {mm}^{- 1} ) ) {{r}_{OZ} ( mm )}^{2}$$

The thickness for each pixel in the transition region is defined as a linear function of its radial position. The thickness at the optical zone edge is defined for each pixel in the transition region as:

$${thickness}_{OZ Edge} ( mm ) ( x , y ) = CT ( mm ) + ( {C}_{2 , equivalent} ( {mm}^{- 1} ) cos ( ϑ ( x , y ) + φ ) ) {r}_{OZ Edge} ( mm ) {( x , y )}^{2}$$

A slope for each point is defined as:

$$slope ( x , y ) = \frac{{thickness}_{OZ Edge} ( mm ) ( x , y ) - {thickness}_{target} ( mm )}{{width}_{transition} ( mm )}$$

The intercept for each point is defined as:

$$intercept ( mm ) ( x , y ) = {thickness}_{target} ( mm ) - ( x , y ) {r}_{transition end} ( mm )$$

A thickness for each point in the transition region is:

$$thickness ( mm ) ( x , y ) = intercept ( mm ) ( x , y ) + slope ( x , y ) r ( mm ) ( x , y )$$

Referring now to FIG. 9, an exemplary graphical image of a transition region is illustrated. A periphery axial thickness profile 900 is defined by a linear change from the end of the transition zone 904 to a minimum axial thickness in the optical zone 901. The slopes and intercepts for the periphery points 902-903 are defined in the same manner as was used to define the transition zone, only using the end of the transition zone and minimum thickness for the edge of the optical zone thickness and the end of the transition zone thickness, respectively. All pixels outside the lens diameter may be set to 0.

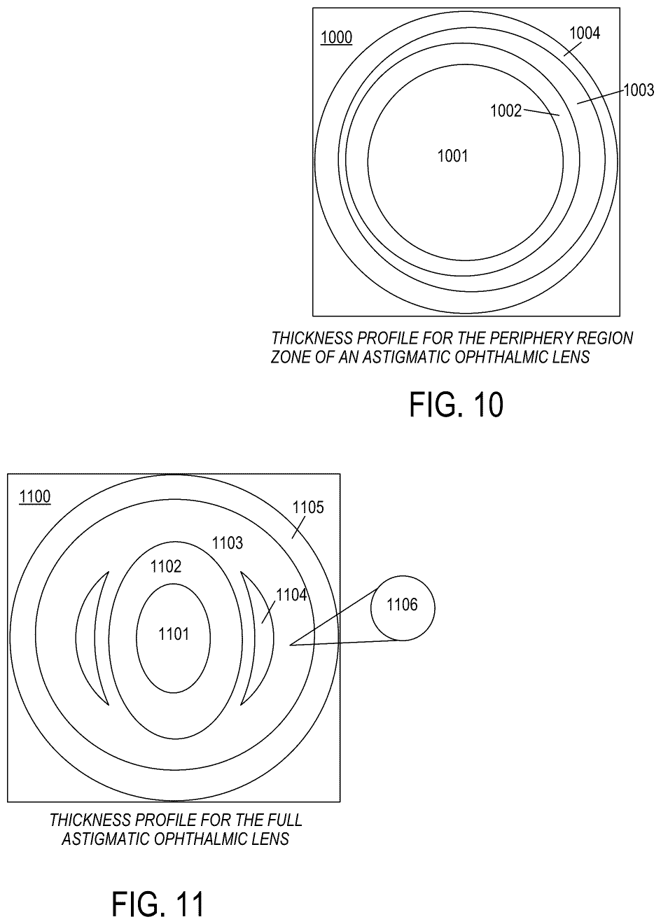

FIG. 10 illustrates a thickness profile for a periphery region 1000 of an ophthalmic lens with multiple variant thicknesses 1002-1004 on the periphery region of an optic zone 1001.

FIG. 11 illustrates a thickness profile of a full ophthalmic lens 1100. The illustrated thickness profile includes lens portions 1101-1105 that comprise an optic zone 1101-1104 and a periphery region 1105. Each of the lens portions 1101-1105 include one or more pixels 1106 (shown in a blown-up view). Each pixel 1106 may be associated with a thickness.

### Print Pattern

In some embodiments of an energy transmissibility pattern (e.g., and energy intensity pattern or grayscale pattern) that correspond with a print pattern, ‘bright’ pixels may represent unprinted areas and ‘dark’ pixels represent areas which receive deposited polymerizable mixture. An ‘intensity’ of ‘dark’ pixels corresponds to a desired thickness of a resulting ophthalmic lens at that position.

In some exemplary embodiments, a print pattern ‘intensity’ of the lens may be defined as:

$$intensity ( x , y ) = 255 - floor ( \frac{255 * thickness ( mm ) ( x , y )}{max ( thickness ( mm ) ( x , y ) )} ) ,$$

where floor( ) converts the value to the smallest integer.

All pixels outside the lens may be set to 255, such that a smaller intensity value corresponds to a larger thickness, and a smallest value corresponds to a smallest thickness.

The value of 255 corresponds to an 8 bit image. If more than 255 gray levels are used, the value of 255 is replaced with the number of gray levels. For example, for a 10 bit image, the value would be 1023.

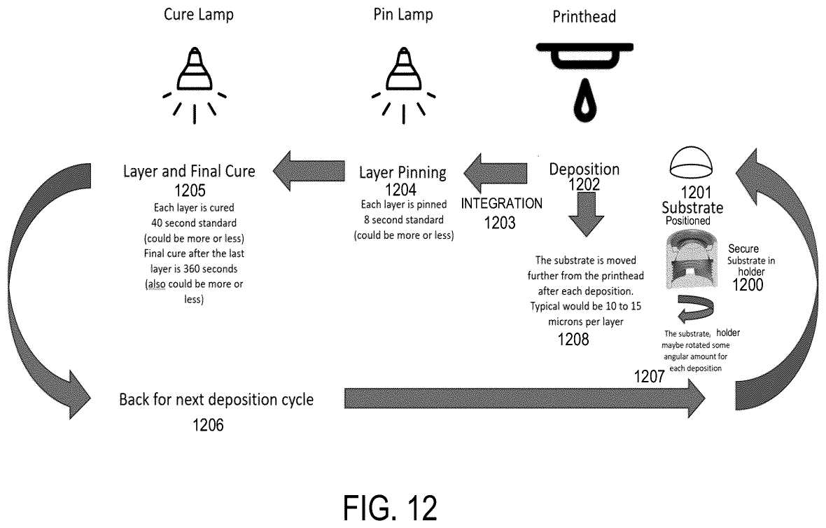

Referring now to FIG. 12, a schematic diagram illustrates method steps that may be performed to for an ophthalmic lens, according to some embodiments of the present disclosure. At step 1200, a substrate that acts as a first receiving surface is secured in a holder. In some embodiments, the substrate may be prepared, for example, by treating a surface of the substrate that will receive polymerizable mixture deposited as droplets from an additive manufacture print head. Preparation may include, by way of non-limiting example, one or more of: cleaning with a solvent, such as isopropyl alcohol; purging oxygen from the substrate, such as via storage in an environment of inert gas, such as nitrogen; and applying a hydrophilic coating on the substrate. In some embodiments, a holder may include a peripheral mask that sets a boundary for an edge of the receiving surface used to form the optical lens.

At step 1201, the substrate is positioned at a first position relative to an additive manufacturing printhead. The substrate may include a receiving portion that may be planar or arcuate. The receiving portion may act as a receiving surface for a first pass of a printhead depositing polymerizable mixture. After a first pass, the receiving surface will typically include at least some areas with previously deposited polymerizable mixture. At step 1202, a deposition of polymerizable mixture onto the substrate takes place. The deposition may include emitting a first pattern of deposited droplets of polymerizable mixture from the printhead, the pattern of deposited droplets of polymerizable mixture corresponding with a first portion of an energy transmissibility map of an ophthalmic lens being formed. The pattern is preferably a two-dimensional image that represents light intensity through a desired optic. The droplets with emitted at a time designation, such as T1, which may be relative to other time designations. In preferred embodiments, the two-dimensional representation will have a numerical value associated with an X,Y position (or other coordinate designation). The numerical value will represent an amount of light that passes through an optical element at a position specified by an X,Y axis designation. A print pattern may be based upon the numerical value, such that, in some embodiments, an amount of polymerizable mixture deposited at a position on a receiving surface corresponding the X, Y pattern correlates with the numerical value (e.g., lighter areas will have a lower X, Y numerical value and will receive less polymerizable mixture, and darker areas will have a higher X, Y numerical value and will receive more polymerizable mixture).

Design of an optical element may be accomplished via analysis of a ray trace pattern of how light passes through the optical element. In some embodiments, an X, Y numerical value in turn may be derived from a mathematical model of a desired optical element three-dimensional shape.

The method may also include receiving deposited droplets of polymerizable mixture onto a receiving surface, the receiving surface may include one or more of: the substrate; an aggregation of polymerizable mixture formed from previously emitted droplets of polymerizable mixture; and an insert. The insert may include, for example, an optical insert, a passive electronic device, an active electronic device; and/or a power source, such as a battery, harvesting device, or antenna.

At step 1203, a surface of deposited polymerizable mixture may smooth out as a result of being acted upon by natural forces, such as, by way of non-limiting example, one or more of: Vander Waals forces (e.g., Keesom force, Debye force, and London dispersion force); Ion-dipole forces; ion induced dipole forces; beta bonding; and dipole-dipole bonding force (e.g., hydrogen bonding).

At step 1204, at a second time (T2) deposited droplets of polymerizable mixture on the receiving surface may be exposed to a pinning process. The pinning process will cause partial polymerization of the deposited droplets of polymerizable mixture. Preferably the partial polymerization results in a viscous aggregation of partially polymerized mixture that is resistant to flow but may integrate with subsequently deposited polymerizable mixture. In some embodiments, a pinning step may include exposure to actinic radiation with a wavelength of between 380 nM and 425 nM and preferably about 405 nM. Exposure to the actinic radiation may be for about 4 seconds to 12 seconds and preferably about 8 seconds.

At step 1205, a curing step may be implemented. The during step may include an intermittent cure (sometimes referred to as a “layer cure”) involving only some of the polymerizable material ultimately used to form the lens; or a ‘final cure” involving all of the deposited polymerizable material.

For example, in some embodiments, with a polymerizable mixture comprising etafilcon, a layer cure may include exposure of the deposited and pinned polymerizable mixture to actinic radiation of between about 360 nM and 400 nM and preferably about 380 nM for a period of about 40 seconds. A final may include exposure to actinic radiation of between about 360 nM and 400 nM and preferably about 380 nM for a period of about 360 seconds. Other polymerizable mixtures including other materials may have curing steps of different wavelengths and lengths of time.

At step 1206, the substrate may be repositioned for a next cycle of deposition of polymerizable mixture.

At step 1207, in some embodiments, one or both of the substrate and the substrate holder may be rotated prior to receiving a next deposition of polymerizable mixture. Other embodiments may rotate the printhead, and still other embodiments may have the orientation of the printhead and the substrate constant through multiple deposition cycles.

At step 1208, in some embodiments, the substrate and deposited polymerizable mixture may be moved to a distance further from the printhead, such as, by way of non-limiting example, to a position with a greater vertical distance relative to a direction of gravity. In some non-limiting examples, vertical movement may include between about 10 to 15 microns. The vertical movement will create a greater distance between a surface of the deposited polymerizable mixture and the printhead that essentially is equal to a thickness of accumulated polymerizable mixture.

In various implementations of the present invention, the method may include repeating one or more steps multiple times. For example, there may be multiple passes of the printhead relative to the substrate, and multiple dwell times allowing gravity and other natural forces such as, for example, surface tension and microforces, to act on at least some of the deposited droplets of polymerizable mixture to smooth a surface of the deposited polymerizable mixture and fill interstitial spaces between the deposited droplets and aggregating of deposited material with material already deposited and pinned. Accordingly, a next pattern of droplets of polymerizable material may be emitted. The pattern may be the same pattern as a previous pattern or a different pattern.

In some embodiments, polymerizable material deposited in a current pass of a printhead may be integrated with material on the receiving surface, such as material previously deposited. In some embodiments, the integrated material may form a single volume of polymerizable mixture on the substrate.

In some embodiments, one or both of natural occurring forces and gravity may be allowed to act on at least some of the deposited droplets of polymerizable mixture to smooth a surface of the deposited polymerizable mixture and fill interstitial spaces between the deposited droplets and integrating and/or aggregating of deposited material with material already deposited and pinned.

In some embodiments, a pinning process may include exposing the deposited droplets of polymerizable mixture to a first wavelength of actinic radiation for a limited amount of time sufficient to case gelation of the deposited droplets of polymerizable mixture and not cause curing of the deposited droplets of polymerizable mixture. Similarly, in some embodiments, a cure process may include exposing deposited polymerizable mixture to a second wavelength of actinic radiation for a sufficient time and of sufficient intensity to cause polymerization of the deposited droplets of polymerizable mixture. Some embodiments may also include facilitating a cure process by an increase in ambient temperature.

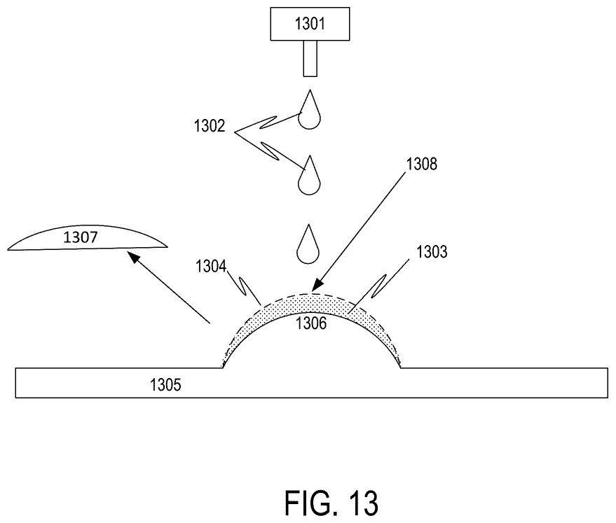

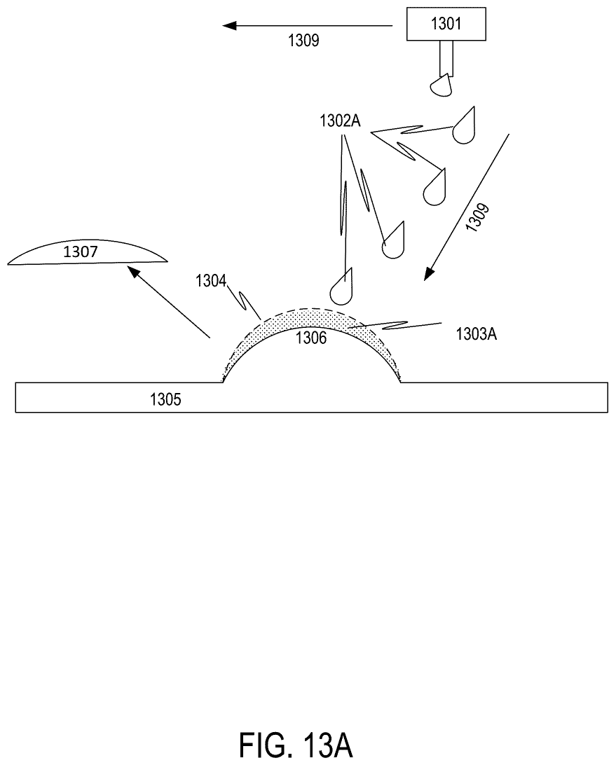

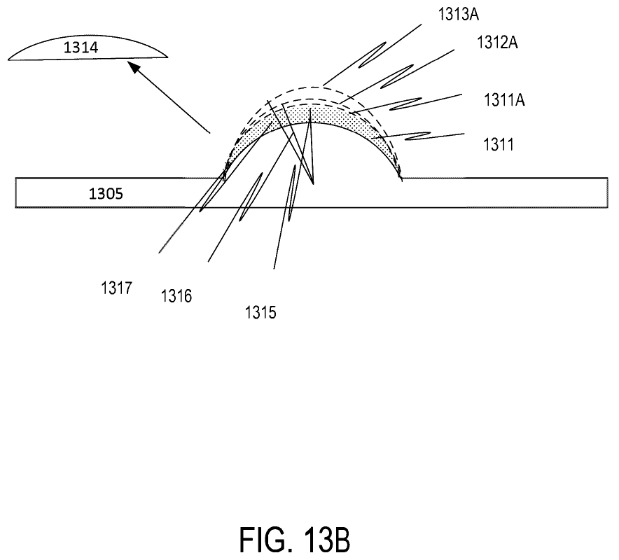

Referring now to FIG. 13, a schematic diagram illustrates deposition of one or more polymerizable mixtures 1302 from one or more printhead(s) 1301 to form an ophthalmic lens 1307. The printhead 1301 deposits polymerizable mixture 1302 until a volume of polymerizable mixture 1303 is formed on a receiving area 1306 of the substrate 1305 in a pattern that replicates a 2D pattern used to generate control commands for each pass of the printhead 1301 in relation to a position of the substrate 1305. At least some of the receiving area 1306 of the substrate 1305 will act as a receiving surface of the deposited polymerizable mixture 1302 until a volume of deposited polymerizable mixture 1303 covers a footprint area for a design of the ophthalmic lens 1307.

As stated herein, in some preferred embodiments relating to optical elements, amounts of polymerizable mixtures 1302 deposited from a printhead 1301 to form an ophthalmic lens 1307, vary in accordance with a two-dimensional pattern that represents an integer map of energy intensity (which may represent transmissibility of energy through the ophthalmic lens).

The pattern is preferably a two-dimensional image that represents light intensity through a desired ophthalmic lens 1307. In preferred embodiments, the two-dimensional representation will have a respective numerical value associated with multiple X,Y positions. The numerical value may represent an amount of light that passes through the ophthalmic lens 1307 at a given position specified by an X,Y axis designation.

Control commands to the printhead cause the printhead 1301 to deposit polymerizable mixture 1302 based upon a two-dimensional print pattern specifying an amount of polymerizable mixture 1302 deposited at a given X,Y position. After multiple successive passes of depositing the polymerizable mixture 1302, a volume of polymerizable mixture 1303 on the substrate 1305 possesses a three-dimensional shape representative of the mathematical model of the desired ophthalmic lens.

The two dimensional print pattern of an amount of polymerizable mixture that represents an amount of light that passes through the ophthalmic lens 1307 at a given position specified by an X,Y axis designation may also correlate with an amount of polymerizable mixture 1302 deposited at a position on the receiving surface 1304 (e.g., lighter areas of the two dimensional print pattern will have a lower X,Y numerical value and will receive less polymerizable mixture, and darker areas will have a higher X, Y numerical value and will receive more polymerizable mixture).

In some embodiments, a design of an ophthalmic lens may be accomplished via analysis of a ray trace pattern of how light passes through the ophthalmic lens. Preferably, an X, Y numerical value in turn may be derived from a mathematical model of a three-dimensional shape of a desired ophthalmic lens.

According to the present invention, the two-dimensional print pattern specifying an amount of polymerizable mixture deposited at a given X, Y position is printed multiple times in successive passes of the printhead relative to the substrate 1305. Deposited polymerizable mixture 1302 is received onto a receiving surface 1304. The receiving surface 1304 may include one or both of: a volume of previously deposited polymerizable mixture 1303, and a receiving area 1306 of the substrate 1305.

Deposited polymerizable mixture 1303 undergoes a pinning and/or gelation process to form a volume of gelled polymerizable mixture 1303. The volume of gelled polymerizable mixture 1303 is polymerized sufficiently to prevent (or at least substantially slow a movement of) the polymerizable mixture that has been received onto the receiving surface while allowing subsequently deposited polymerizable mixture 1302 to meld with previously deposited (and pinned) volume of polymerizable mixture 1303 and form a structure with a single mass of polymerizable mixture. In preferred embodiments, melding may include intermingling with, or becoming interspersed with, the volume of previously deposited and pinned polymerizable mixture 1303 such that individual layers or striations of deposited polymerizable mixture 1302 are not discernable in a volume of polymerizable mixture 1303 formed on a receiving area 1306 of the substrate 1305 once the volume of polymerizable mixture 1303 is cured. Such embodiments may be preferred since unwanted diffraction may be an optical quality resulting from successive steps or other interlayer artifacts associated with disparate layers of polymerized material being present in an ophthalmic lens.

Prior to pinning, naturally occurring forces may be given a specified period of time to act upon a surface 1304 of the volume of polymerizable mixture 1303 to smooth the surface 1304 and/or fill interstitial aberrations in the surface and thereby improve optical qualities of a resulting ophthalmic device (as compared to a surface of a machined lens and/or a lens formed from a machined mold part). Naturally occurring forces may include, for example, without limitation, one or more of: Vander Waals forces (e.g., Keesom force, Debye force, and London dispersion force); Ion-dipole forces; ion induced dipole forces; beta bonding; and dipole-dipole bonding force (e.g., hydrogen bonding).

Curing of the volume of polymerizable mixture 1303 follows disposition of droplets polymerizable mixture 1302 during a final pass of the printhead 1301 and the substrate 1305. Curing may be processed by exposure of the volume of polymerizable mixture 1303 to actinic radiation and/or heat sufficient to cause a substantially complete polymerization of the volume of polymerizable material 1303.

As illustrated, FIG. 13 shows a printhead 1301 that is essentially perpendicular to an apex 1308 of deposited polymerizable mixture 1303. In various embodiments, droplets polymerizable mixture 1302 may (or may not) follow a trajectory that is perpendicular to the apex 1308 of a receiving surface, which may include one or more of: the substrate 1305, a receiving area 1306 and a surface of the previously deposited polymerizable mixture 1303.

Referring now to FIG. 13A, a printhead 1301 illustrated moving in a direction 1309 of a printing path. Deposited droplets of polymerizable mixture 1302A will follow a droplet trajectory 1309 influenced by the speed and direction of the printhead 1301 at a time of release of the droplets of polymerizable mixture 1302A. The droplet trajectory 1309 will have a speed and direction of its own. According to the present invention, in some embodiments, a printhead 1301 and a droplet trajectory 1309 may be at an angle other than a right angle to the surface of the apex of a receiving surface 1304. At least a portion (e.g., which may be a majority) of deposited droplets of polymerizable mixture 1302A will integrate and/or meld into previously deposited polymerizable mixture 1303A. Following integration, the deposited polymerizable mixture 1302A may be exposed to actinic conditions, such as sufficient actinic radiation to cause gelation and/or pinning; and ultimately cured. In this manner, the present process differs over previously known processes that require a small portion of additive manufacture material to be placed on a surface in an incremental manner and not become integrated into previously deposited material before being cured.

Referring now to FIG. 13B, a substrate 1305 is illustrated with a receiving area and polymerizable mixture deposited from a first deposition event 1311; polymerizable mixture deposited from a second deposition event 1312; and polymerizable mixture deposited from a third deposition event 1313. Each deposition event may include emitting of a pattern of polymerizable mixture from the printhead. The pattern of polymerizable mixture may be emitted during relative movement of the printhead and the substrate 1305; or while the printhead is stationary relative to the substrate 1305. It should be noted that while polymerizable mixture from only three deposition events is illustrated, the present invention is not limited to a maximum number of deposition events that may be optimal to form a desired object. For example, in some embodiments, 8, 12, 16, 20 or 24 deposition events may be optimal to form an ophthalmic device. In other embodiments, 64 or more deposition events may be optimal to form an optical device for use other than on or in the cyc. Movement of a printhead relative to the substrate 1305 may include one or both of rotational movement and lateral movement.

Following a deposition event, deposited polymerizable mixture 1311-1313 may meld, and a gelation or pinning process may be caused by exposure to actinic conditions. After a final deposition event, a curing process may be performed to cure the deposited polymerizable mixture 1311-1313.

Final cure of the deposited polymerizable mixture 1311-1313 will form an ophthalmic device 1314 or other article of manufacture.

During successive deposition events of deposited polymerizable material 1311-1313, successive receiving surfaces 1311a, 1312a, 1313a formed by each deposition event of polymerizable material may be positioned such that a respective receiving surface 1311a, 1312a, 1313a becomes both a receiving surface for a subsequent deposition event, and a back curve to a subsequent optical sub-element formed by a subsequent polymerizable material deposition event. Each addition of polymerizable material may increase a back curve diameter 1315, 1316, 1317 of an optical sub-element (as compared to parameters of other back curves formed via previous polymerizable material events).

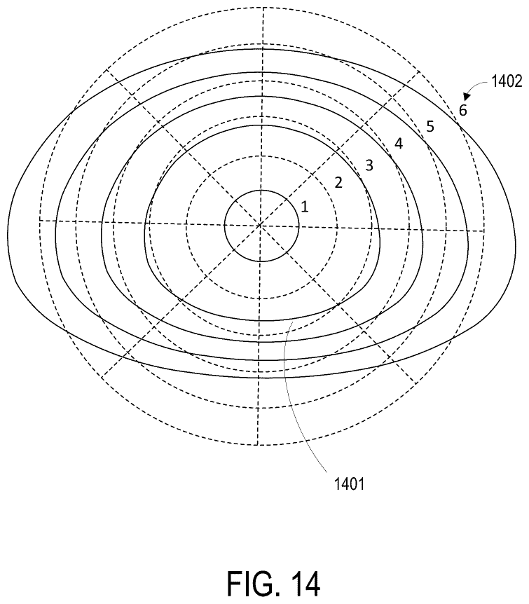

Referring now to FIG. 14, an exemplary dynamic shape of a droplet of polymerizable mixture 1401 is illustrated at various times 1402 after release from a printhead. According to the present invention, the shape of the droplet 1401 may vary based upon a speed of travel of the droplet 1401 through an ambient atmosphere. In some preferred embodiments, an article formed by the processes disclosed herein are generally not influenced by a shape of the droplet of polymerizable material 1401. The relatively small mass of each droplet 1401 and the integration of droplet into other polymerizable material on a receiving surface essentially make a shape of a manufactured article unaffected by a shape of individual droplets 1401, or a changing shape of the droplet 1401 at various times 1402 after release by the printhead (not shown in FIG. 14).

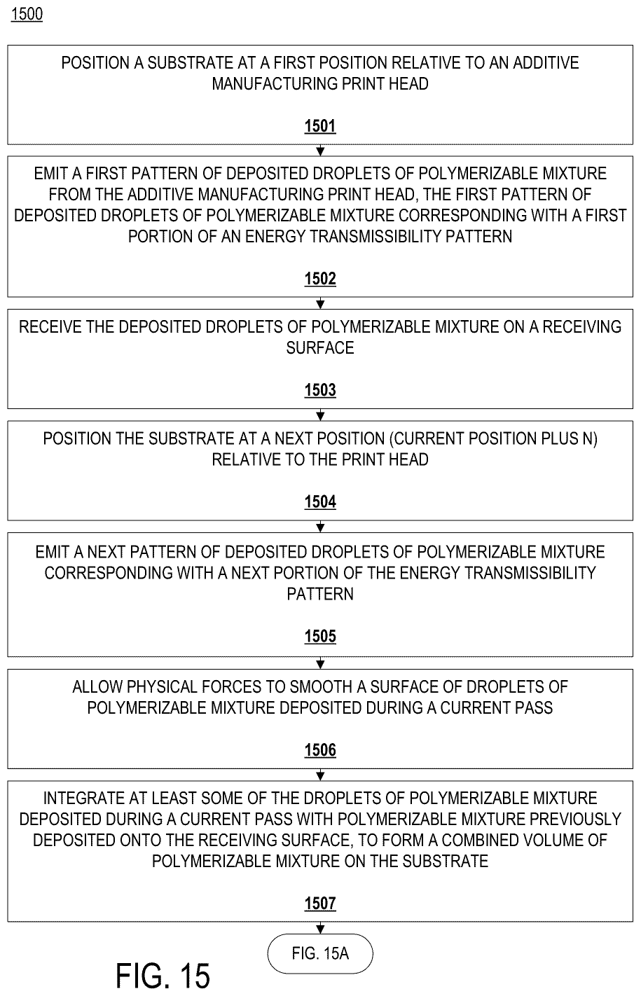

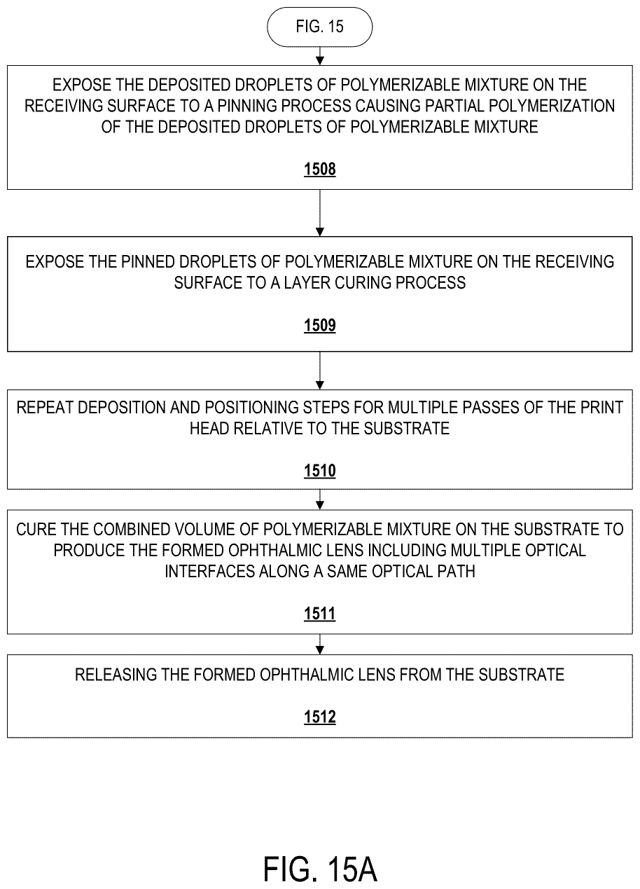

Referring now to FIG. 15, a flowchart 1500 illustrates exemplary method steps that may be executed in some implementations of the present invention.

At step 1501 the process may include positioning a substrate at first position relative to an additive manufacturing printhead.

At step 1502 the process may include emitting a first pattern of deposited droplets of polymerizable mixture from a printhead, the first pattern of deposited droplets of polymerizable mixture corresponding with a first portion of a grayscale image.

At step 1503, the process may include receiving the deposited droplets of polymerizable mixture on a receiving surface, the receiving surface may include one or more of: the substrate; previously emitted droplets of polymerizable mixture; and an inserted article. The inserted article may include, by way of non-limiting example, one or more of: an optical element, such as a rigid permeable lens, an electronic device, and a power source.

At step 1504, the process may include repositioning the substrate to a next position relative to the printhead. Repositioning may include moving one or both of the substrate and the printhead relative to the other.

At step 1505, the process may include emitting a next pattern of deposited droplets of polymerizable mixture from the printhead corresponding with a next portion of the grayscale image.

At step 1506, the process may include allowing physical forces to act on the deposited droplets of polymerizable mixture. Physical forces may include, by way of non-limiting example, one or more of: Vander Waals forces (e.g., Keesom force, Debye force, and London dispersion force); Ion-dipole forces; ion induced dipole forces; beta bonding; and dipole-dipole bonding force (e.g., hydrogen bonding).

At step 1507, the process may include integrating at least some of the droplets to form a combined volume of polymerizable mixture on the substrate.

At step 1508, the process may include exposing the deposited droplets of polymerizable mixture on the receiving surface to a pinning process causing partial polymerization of the deposited droplets of polymerizable mixture.

At step 1510, the process may include exposing the deposited droplets of polymerizable mixture on the receiving surface to a layer cure that allows for partial curing of the deposited polymerizable mixture, but still allows for polymer chains to be subsequently formed that penetrate the layer cured polymerizable mixture.

At step 1510, the process may include repeating positioning and deposition steps for multiple passes of the printhead relative to the substrate.

At step 1511, the process may include curing the combined volume of polymerizable mixture to form an ophthalmic lens with multiple optical sub-elements along a same optical path.

The process may include, following each pass of the printhead relative to the substrate, integrating at least some of the droplets of polymerizable mixture deposited during a current pass with polymerizable mixture previously deposited onto the receiving surface to form a combined volume of polymerizable mixture on the substrate. Integration may allow for polymer chains to form from monomer included in the polymerizable mixture deposited in disparate deposition actions such that the monomer is included in disparate volumes of deposited polymerizable mixture.

At step 1512, the process may include releasing a formed ophthalmic lens from the substrate. In some embodiments, release may be accomplished by way of non-limiting example, via immersion of the formed ophthalmic lens and substrate in a hydrating solution. Hydration may expand the ophthalmic lens and detach it from the substrate. Embodiments may also include a release process that includes exposing one or both of: a formed ophthalmic lens temperature and an associated substrate to temperature variations. Temperature variations may include heating and/or cooling the lens and/or the substrate.

Optical Devices with Inserted Components

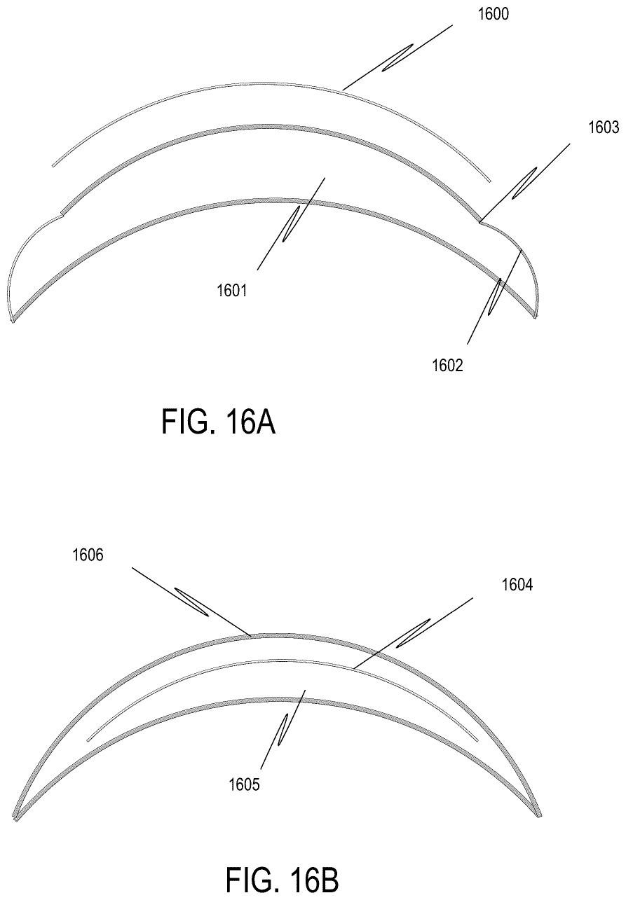

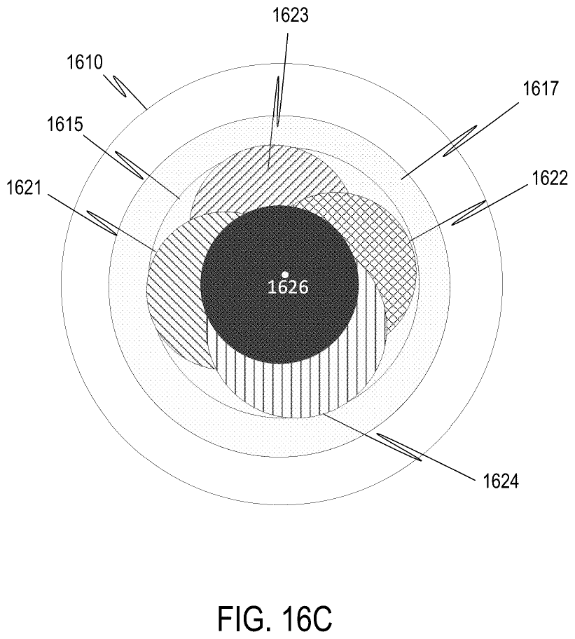

Referring now to FIGS. 16 and 16A, in some embodiments, the processes included of the present invention may be used to form novel optical devices with characteristics not previously available. According to some embodiments of the present invention, a lens element produced according to the present disclosure may include an insert component. Non-limiting examples of lenses with inserts that have different fundamental aspects are discussed in the following descriptions.

Printed Base Elements for Composite Lenses with Lens Inserts

In some non-limiting examples, an insert into a lens formed via the methods described herein may be a formed lens element in and of itself. The formed lens element may include a same or different material than a lens body. Accordingly, the lens insert may include, one or more of rigid, semi-rigid, or soft construction. In some examples, an insert may be formed with glass lenses or hard or semi-rigid polymeric lenses. In other examples, a soft formed lens element may be utilized. In these exemplary cases, a discrete formed lens element that includes a lens insert may be placed upon a second base lens element. Although, the second base lens element may be formed in many different ways, in some preferred examples, the methods and apparatus as have been described herein may be employed to print the second base lens element.

In some examples, where the second base element is printed by the methods described herein for the purpose of supporting a formed lens element, there may be numerous features that the printing process may impart to the second base element. Referring to FIG. 16A, an exemplary composite lens is illustrated. The composite lens may include a first lens element, an insert 1600 of a formed lens, which may be placed upon a second base lens element 1601. The second base lens element 1601 may be formed by printing as has been described herein. In other examples, the second base element may be formed in other manners such as with use of a mold, formation with stereolithographic methods, mechanical machining, and the like. In the various methods of formation, edge features 1602. In some examples, the second base element may include a thin body region which may support the formed lens element and provide a buffer region between the formed lens element and the surface of the eye of a user.

In some examples, the thin body regions may include aspects that improve the comfort of the composite lens comprising the formed lens element and the second base element such as having a material composition of lens hydrogel materials engineered for comfort on wear.

In some examples, the second base element may also include formed features on the periphery of its base structure such as edge features 1602. For example, a knife edge type region on the periphery may improve wearing characteristics of a composite lens over that experienced of the formed lens element alone. In further examples, a ring of material 1603 may be formed near or at the edge or periphery of the second base element with the function to capture or position the formed lens element. In some examples, the formed lens element may have optical rotational symmetry, and the edge ring may help with positioning and holding the formed lens element in a general sense.

In some other examples, the formed lens element may not only have a center to its optic zone, which should be held in place relative to the second base element, but also may have axial aspects. Accordingly, there may be aspects of the formed lens element that function to orient the axis of the formed lens element in a certain perspective on the eye. For example, the formed lens element may have elements peripheral to the optic zone that orient the formed lens element by interaction with gravity or with the eye lids of the user. In some such examples, a ring of material may loosely engage the formed element in such a manner that the lens body is constrained in translational movement but has a degree of freedom nonetheless to rotate while included in the composite lens.

### Encapsulated Formed Lens Elements Including Printed Elements

In some examples, a formed lens element may be incorporated into an encapsulated structure to form a composite lens.

Referring to FIG. 16B, an example with an encapsulated structure is illustrated. The formed lens element 1604 may have a shape that corrects a user's vision. In some examples, the formed lens may be placed upon a printed base element 1605 as described herein. The lens may then be encapsulated 1606 by further printing. In these types of examples, the printed base element may be formed with the various different aspects as have been described. In some examples, the additional printing upon the inserted formed lens may be carried out to form an encapsulating layer without any alteration of the optical properties of the composite lens.

Combine hydrogel portions and RGP portions may, for example, provide lenses that correct not only common refractive errors like myopia, hyperopia, and astigmatism, but also higher-order aberrations. Higher-order aberrations may be complex optical imperfections that go beyond the ability of typical eyeglasses or soft contact lenses to correct. Higher-order aberrations may affect a quality of vision of a patient and cause detrimental vision experiences, such as, by way of non-limiting example, one or more of: glare, halos, and reduced contrast sensitivity. Lenses according to the present invention, which combine RGP, and hydrogel materials reduce or eliminate such aberrations and provide improved visual experiences to a wearer.

In cases involving keratoconus, the present invention provides highly customizable lenses that may be specific to a wearer and thereby provide excellent fit and visual correction by creating a smooth, uniform optical surface over an irregular cornea. Lenses manufactured according to the present invention may be designed and created to provide stability, durability, and good oxygen permeability specific to the wearer.

Referring now to FIG. 16C, in some embodiments, such as those illustrated in FIG. 16C, an optical lens 1610 (which may be an ophthalmic lens) may include additional material(s) added via additive manufacturing, such as via the processes described herein. Three-dimensional printing, or other additive manufacturing, may be performed upon a formed lens insert 1615. The three-dimensional printing may, for example, form an encapsulating layer 1617. However, additional printing may also be performed to impart various optical aspects. For example, an optical lens may be formed with a first optical interface 1621, a second optical interface 1622, a third optical interface 1623 and a fourth optical interface 1624 in a non-limiting example. Optical sub-elements formed by these interfaces may share an optical path at 1626, or have separate disparate optical paths. Many different designs with various optical effects may be formed in this manner and more complicated lenses with additional features may be formed by printing different designs in multiple printing passes.

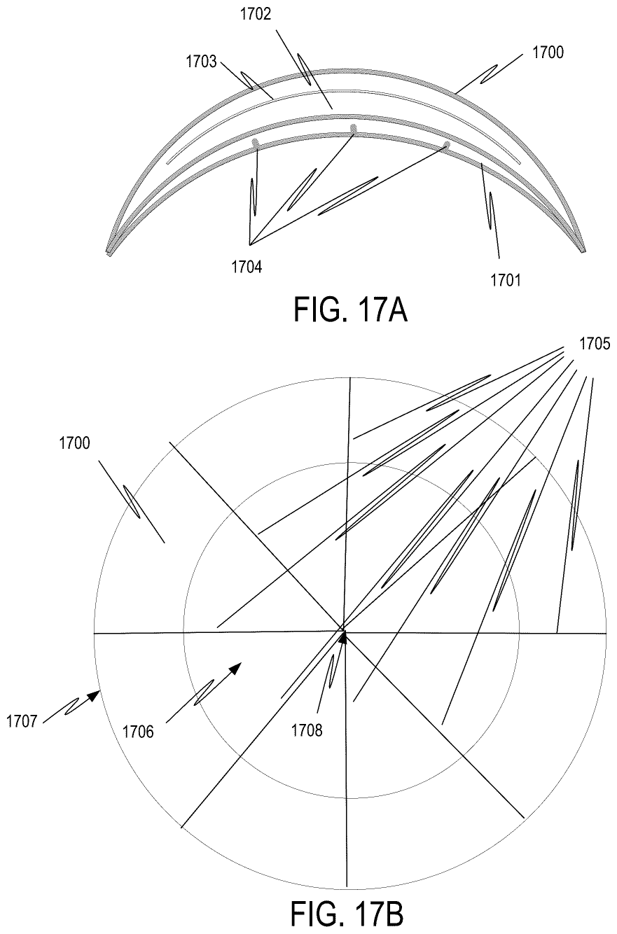

Referring now to FIG. 17A, a cross section schematic diagram of some embodiments of the present invention illustrates an optical lens 1700 (which may be an ophthalmic lens) that includes a previously formed optical lens 1701 (which may be an ophthalmic lens) that is utilized as a receiving surface upon which a lens element 1702 is formed according to the present invention. The formed lens element 1702 may have one or more of: generic prescription aspects, optical elements customized for a specific purpose, optical elements customized to a specific patient (or group of patients), or other design constructs.

Additive manufacturing may be used to form a portion of an optical lens 1700 and/or a deposit of polymerizable mixture upon a top of the previously formed optical lens 1701. In some examples, the deposit of polymerizable mixture may generate customized aspects to the lens such as a tailored prescription of a therapeutic agent. In some other examples, the deposit of polymerizable mixture may include multiple different regions that receive various therapeutic agents upon a surface of or integrated into the lens 1700.

In addition to optically active deposits, a printed deposit may also have functions such as physically constraining or holding a lens insert 1703 to an underlying base layer. In some embodiments, the lens insert may include a previously formed dose of a therapeutic agent 1701.

As described above, in some embodiments, a deposit of polymerizable mixture and a therapeutic agent may be made upon a lens insert 1703 that includes a previously formed optical lens 1701. The previously formed optical lens 1701 may include one more of: a same material as the material used to form the optical lens 1700, a different material as the material used to form the optical lens 1700, a rigid lens, a semi-rigid lens, and glass insert.

In some examples, layers added via additive manufacturing may be added upon a formed lens element for therapeutic purposes, such as for patients with a physical injury, surgery, disease state, or simple fatigue or dryness. In some examples, additive manufacturing, such as 3D printing of therapeutic agents in colored regions in a pattern that indicates one or more of a type of therapeutic agent added to a lens, an amount of therapeutic agent remaining on a lens; a time period (such as a time period during which the therapeutic agent was added to the lens and/or a time period the therapeutic may diminish in its efficacious purpose, and an expiration period).

In still further examples, lens media used in the printing process may include tinting constituents that may allow a pattern of identifying numbers or other characters to be printed in the lens body. Some embodiments may also include non-realistic coloring, such as colors chosen to match a type of therapeutic agent and/or time period associated with the therapeutic agent.

In another aspect, in some embodiments, a portion of an optical lens 1700 may include a therapeutic agent infused material 1704, or a material with another desired physical attribute. For example, one or more channels or regions of different crosslinking density may be formed during the printing process, in varied patterns and/or material dispensed during passes of a printing element relative to an optical lens 1700 being formed with a crosslinking density conducive to receiving and/or dispensing a particular therapeutic agent, or a rate of dispensing a therapeutic agent embedded or otherwise integrated into the material with a specified crosslinking density.

In some embodiments, a first pass may print a pattern of the channels upon a starting substrate using a polymerizable mixture that has a different cross-linking density to other material deposited. In addition, a deposit of polymerizable material may result in a portion of material, or a printed structure, which is soluble in subsequent processing steps. A soluble material may include a therapeutic agent and dispense the therapeutic agent when exposed to a predetermined environment.

In addition to an open channel or void, a portion of high oxygen permeability may include regions of different crosslinking patterns and/or density that may, for example, allow for passage of tear fluid and may also facilitate passage of oxygen along an interface of the lens 1700 with a user's eye surface.

Referring now to FIG. 17B, an exemplary top down view of a lens 1700 of channels 1705 may be found in FIG. 17B. In this example, a radial pattern including multiple veins 1706 may be used to conduct beneficial aspects such as oxygen, tear fluid, therapeutic agents, medicaments, or other therapeutic agent, from an edge 1707 of a lens body to a middle of the lens 1708. A hard or semi-rigid insert may impede or block the flow of these beneficial aspects across its body. The channels or regions of different cross linking may help to overcome the blocking of the flow. In other examples, the channels or regions of different cross-linking density or character may be designed into different patterns.

Referring now to FIG. 17C, another example illustrates channels 1710 which head radially from the edge of the lens towards the center, but stop short of the center region. The center region may include an optic zone located where light proceeds through to be received at the retina of the user.

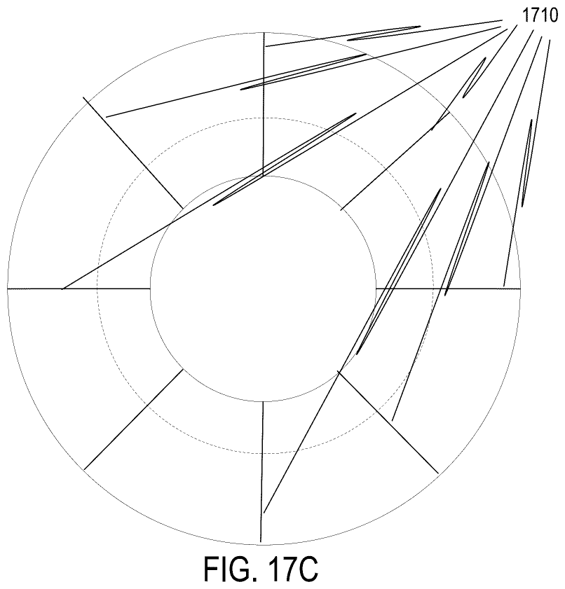

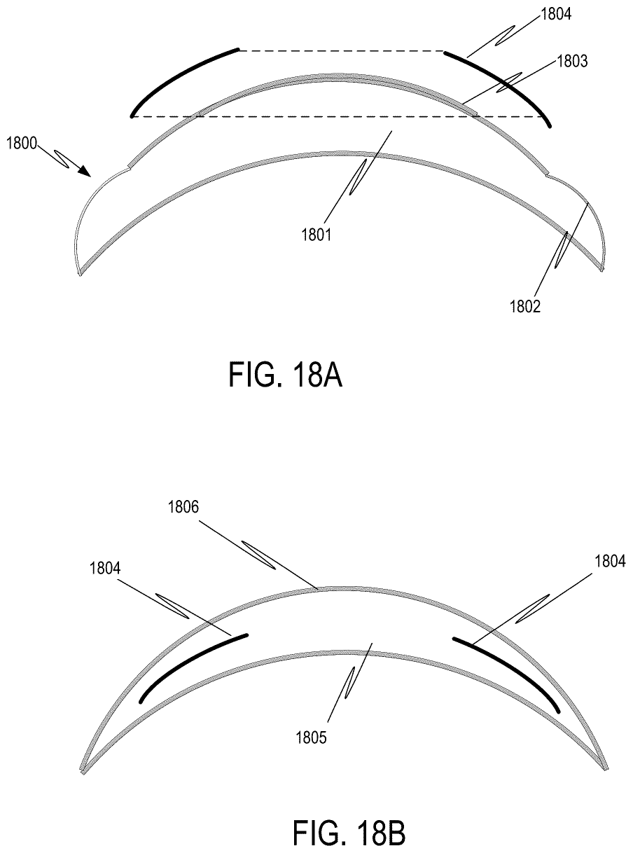

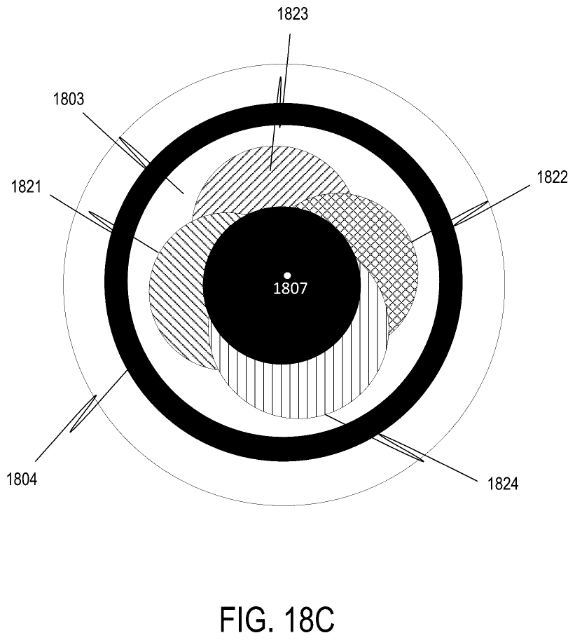

Referring now to FIG. 18A, in some embodiments, 3-D printing of polymerizable mixture may be performed upon inserts that are non-lens elements, such as, for example, inserts that include therapeutic agents. In some embodiments, an insert 1800 may include an annular shaped structure that is added upon a lens base 1801. Preferred embodiments include affixing the insert 1800 to areas of the lens base 1802 that are outside of an optic zone 1803 of the lens structure. As in some previous examples, the lens base 1801 may be created by many methods including the printed methods herein and may have numerous features such as an edge feature 1802 to aide in comfort for a user. In some examples, an annular shaped insert 1800 may be added upon a lens base 1801 without overlying material or structure.

Referring now to FIG. 18B, in some embodiments, an insert 1804, which may be annular or other shape, may be encapsulated within lens material of the composite lens 1800 between a base portion 1805 and a subsequently printed lens body 1806. The insert 1804 may include a therapeutic agent. The subsequently printed lens body 1806 may provide encapsulation for the insert 1804 or otherwise bind the insert to the lens body 1806. The insert 1804 may include an optical aspect in the optic zone in some examples, and alternatively, the insert may not have an optical aspect in the optic zone.

In the various types of annular inserts or inserts otherwise positioned in a periphery region outside of an optic zone of a lens, printing may be performed in the various manners as have been described. In some examples, the printing may be useful to affix an insert, such as an annular insert, to a lens body 1806 of a formed lens structure.

Referring now to FIG. 18C, various printed patterns of therapeutic agents with an optical affect in the optic zone may be added with the addition of an annular insert. Multiple optical interfaces 1821-1824 may be added upon the optic zone 1803 of the composite lens with annular insert 1803. In some embodiments, rays of energy may proceed through the optic zone and multiple active optic interfaces may share an overlap region around point 1807.

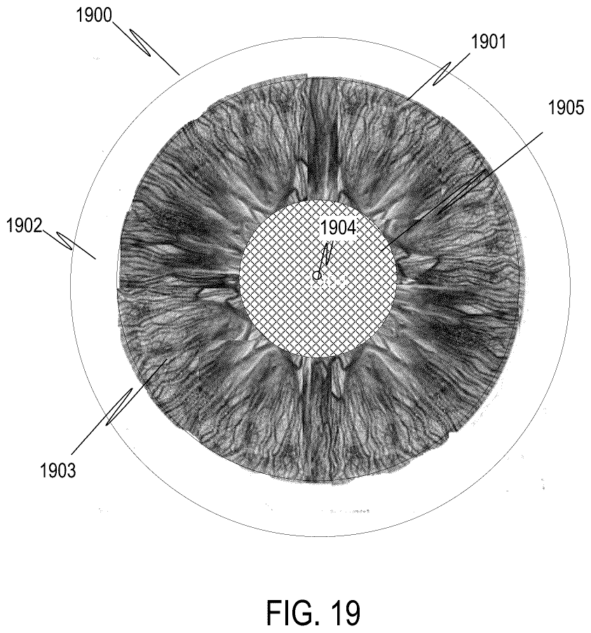

Referring to FIG. 19, in some embodiments, a lens 1900 with an annular insert 1901 may include a pattern, such as an iris pattern, and the pattern may include a therapeutic agent. As illustrated, the annular insert 1901 may have an iris pattern 1903 of therapeutic agent and/or other pattern and may be concentric around a point 1904. In some embodiments, the point 1904 will be in a center of a spherical lens or an oval lens. Some embodiments may include a non-circular or oval shaped lens and may include insert placed at another desired location.

In some embodiments, an insert with an iris pattern of therapeutic agent may cover an underlying iris of the wearer, or an aberration in the wearer's eye, such as a scar. The optic zone 1905 may have optically active features (not illustrated in FIG. 19) sharing a region of the optic zone 1905. As in the previous examples, a relatively complicated multipattern optical feature set may be printed, but it may be possible to provide a singular optical feature or no optical features as well.

In some embodiments, multiple inserts may be placed within the lens 1900. For example, an annular insert 1901 including a therapeutic agent may be added before an optical lens element is also added as another insert. Each of the inserts 1901 may be added in an order conducive to a purpose allocated to the insert.

In some other embodiments, an annular insert 1901 may be added before a lens element is printed. In some examples, a formed lens 1900 comprising an optic zone 1905 and a base structure may have an annular insert 1902 added upon a formed lens element 1902. In each of these examples, it may be practical to perform printing steps as have been described within upon the lens element with annular insert elements. These additional steps may be performed for one or more of adding optically active regions upon the lens surface, or to adhere or otherwise encapsulate the added insert or inserts to the formed lens element.

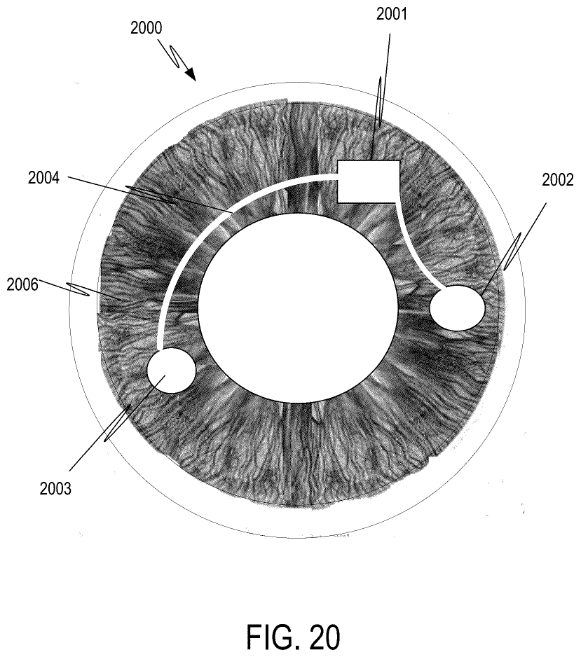

Referring now to FIG. 20, in some embodiments, an optical lens (which may comprise an ophthalmic lens) may include one or more inserts 2000 that may be operative to perform one or more of: logical, electrical, and electro-mechanical functions. Some embodiments may include inserts that are operative to dispense a therapeutic agent. For example, an annular insert 2000 may include electrically active components 2001-2004 that surround an optic zone of a lens element and are operative based upon a logical instruction via software and/or provision of power to dispense a therapeutic agent. An insert 2000 with a printed pattern 2006 may also include electrically active components 2001-2004 placed upon or within lens material of an optical lens. In some embodiments, the printed pattern may aesthetically make the presence of the electrical elements less noticeable. Some embodiments may also include a printed pattern that may be used to convey one or more of: a logical digital pattern, an analog signal, and electrical power.

In some non-limiting embodiments, electrically active components 2001-2004 may include a power source 2002 which may include one or more of: a battery element, a capacitive storage element, ambient energy harvesters of various kinds such as an antenna, and a photocell as non-limiting examples. The electrically active components 2001-2004 may also include switching or pumping or other dispensing modality elements that allow for activation of the insert to perform one or more functions.

In some examples, the insert may include controllers 2001 that may be powered by a power source 2002 and control other elements such as a sensor 2003 in a non-limiting example. In other examples and in addition, the electrically active annular insert may include various integrated circuits for performing various functions from control to communication or activation as non-limiting examples.

Still further non-limiting examples include electrical components that may be used to project images to a retina of a user from the periphery of the optic zone or upon a display across the optic zone. The electrical components may also be used to project light for clinical reasons, such as, for example, the projection of therapeutic energy waves (e.g., blue light) to treat various ailments.

Sensor 2003 elements may measure various conditions of the ophthalmic environment including but not limited to measuring temperatures of the eye environment, measuring pressures, light levels and such aspects as may be sensed. A therapeutic agent may be dispensed based upon a condition quantified in the ophthalmic environment. In some examples, sensors may sense aspects such as in non-limiting examples, glucose monitoring, measuring other biological analytes, infection state monitoring, temperature monitoring, chemical monitoring, and light level monitoring. In some examples, the sensors may have the capability of monitoring into the internal regions of the user's eye.

In still further examples, the electrical devices added to the annual insert may have medicinal function such as the treatment with a therapeutic agent, such as, for example, one or more of: a pharmaceutical, a lubricant, a nutritional, or other beneficial substance in a controlled manner. A power source may be used to power a controller to cause a storage element to release the therapeutic agent in a controlled manner.

There may also be examples where an insert 2100, such as an annular insert, has a function to disperse a medicament in a controlled manner without requirements of electrical devices, such as by controlled dissolution to release the said medicament.

Referring to FIG. 21, an illustration of an annular insert 2100 with a non-powered component 2101 is provided. The annular insert may be added to a lens base and/or encapsulated as has been described. The non-powered component 2101 may have various functions in different examples. In an example of a medicament treatment device, the non-powered component 2101 may be formed in such a manner that once a lens including the annular insert 2100 is placed upon an eye, interaction with tear fluid of a user may activate a timed-release action of elements within the non-powered component 2101.

In some slightly varied examples, an electrical component, sensing element, or non-electrical component 2203 may be added as “an insert” itself.

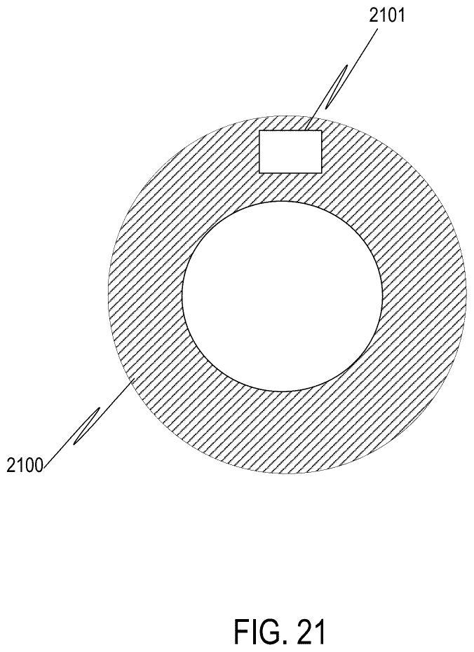

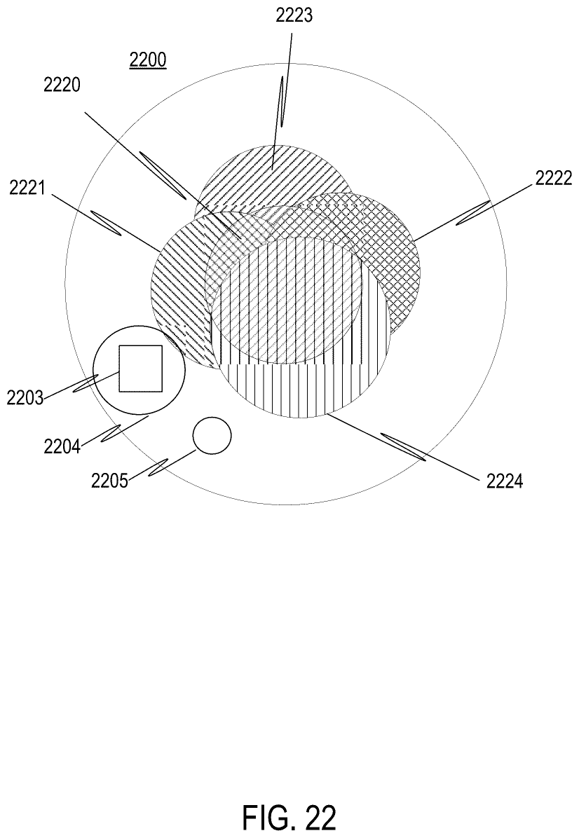

Referring to FIG. 22, in some varied embodiments, an electrical component, sensing element or non-electrical component 2203 may be added as “an insert” itself. As illustrated, an example of a printed composite lens 2200 may have various optical interfaces 2220-2224 printed upon the lens structure to impart optical activity of various kinds. The printed composite lens 2200 may also have an electrical or non-electrical component or insert component 2203 which may be a sensing element may be added.

In some embodiments, a receiving cavity 2204 may be printed into a lens base, such as with the printing techniques as described herein. A therapeutic agent and/or an electroactive element or other insert component 2203 may be placed in the cavity 2204 and the insert component 2203 (therapeutic agent, electrical or non-electrical component, sensor, and/or power source), may be further printed upon to encapsulate the insert component 2203. In some examples, features 2205 such as pores, gaps or regions with different polymer characteristics may be designed into the encapsulation to facilitate interaction of the insert component 2203 with an ocular environment, such as, for example, with aqueous and vitreous fluid or other ocular fluid.

### Methods for Printed Lens Products Including Insert Components.

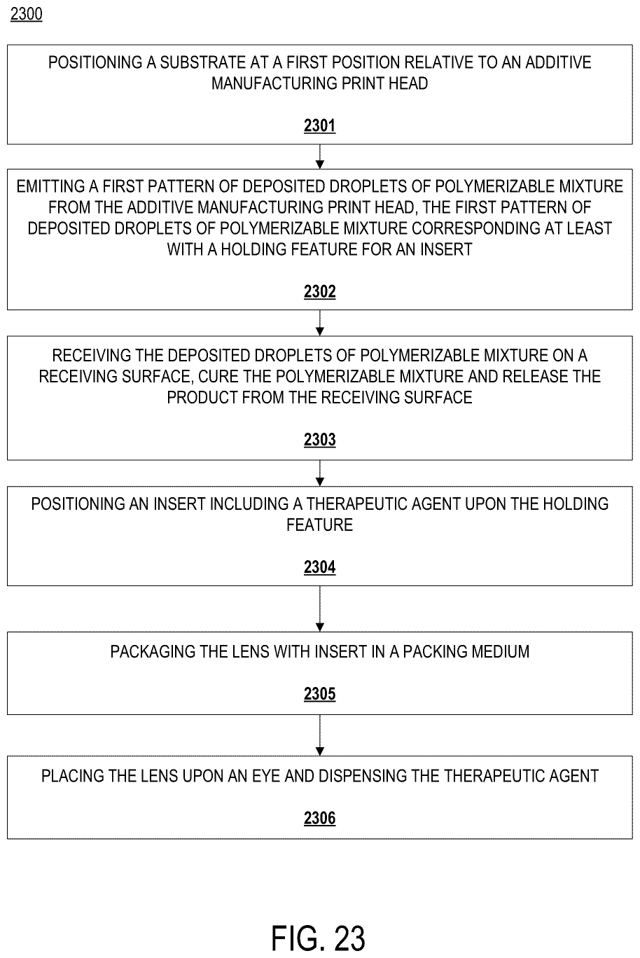

Proceeding to FIG. 23, an exemplary method flow 2300 is illustrated for steps to form a composite lens product including an insert. At step 2301, the method may begin by positioning a substrate at a first position relative to an additive manufacturing print head.

At step 2302, the method may include emitting a first pattern of deposited droplets of polymerizable mixture from the additive manufacturing print head, the first pattern of deposited droplets of polymerizable mixture corresponding at least with a holding feature, such as a lens base, for an insert.

At step 2303, the method includes the step of receiving the deposited droplets of polymerizable mixture on a receiving surface, curing the polymerizable mixture and releasing the product from the receiving surface.

At step 2304, the method includes the step of positioning an insert including a therapeutic agent upon the holding feature. The insert may also optionally include one or more of: a lens, an annular support, and a discrete component.

At step 2305, the method includes the step of packaging the lens with the insert in a packing medium.

At step 2306 the method includes the step of placing the lens upon an eye and dispensing the therapeutic agent.

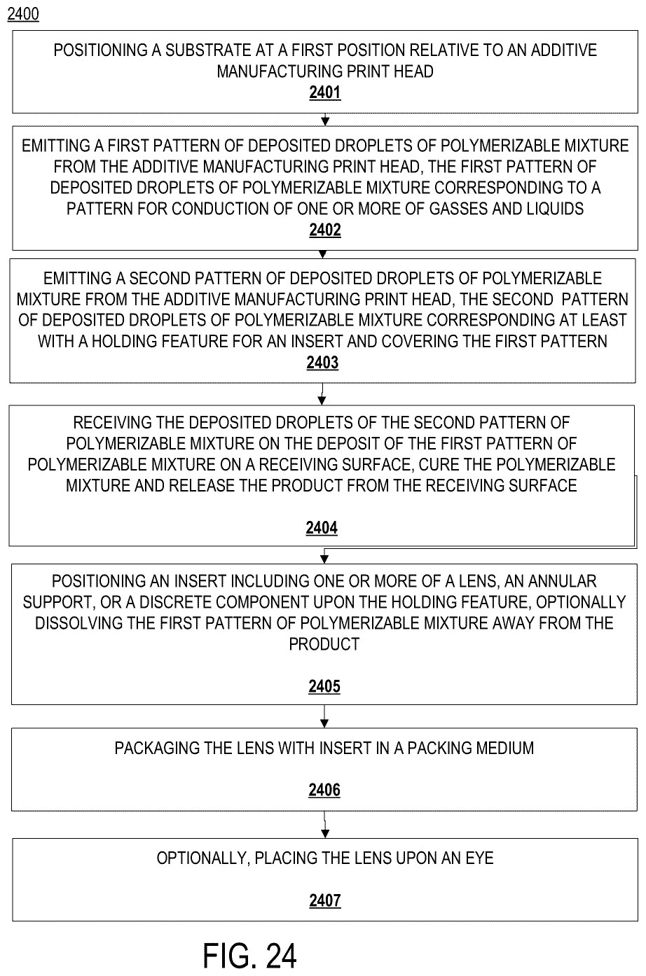

Referring now to FIG. 24, an exemplary method flow 2400 is illustrated for steps to form a composite lens product including an insert.

At step 2401, the method may begin by positioning a substrate at a first position relative to an additive manufacturing print head.

At step 2402, the method includes the step of emitting a first pattern of deposited droplets of polymerizable mixture from the additive manufacturing print head, where the first pattern of deposited droplets of polymerizable mixture may correspond to a pattern for conduction of one or more of gasses and liquids, such as oxygen.

At step 2403, the method includes the step of emitting a second pattern of deposited droplets of polymerizable mixture from the additive manufacturing print head, the second pattern of deposited droplets of polymerizable mixture corresponding at least with a holding feature for an insert and covering the first pattern.

At step 2403 the method includes the step of receiving the deposited droplets of the second pattern of polymerizable mixture on the deposit of the first pattern of polymerizable mixture on a receiving surface, curing the polymerizable mixture and releasing the product from the receiving surface.

At step 2405, the method may include positioning an insert including one or more of a lens, an annular support, or a discrete component upon the holding feature, optionally dissolving the first pattern of polymerizable mixture away from the product.

At step 2406, in some examples, the method may include packaging the lens with insert in a packing medium.

At step 2407, in some examples, the method may optionally include placing the lens upon an eye.

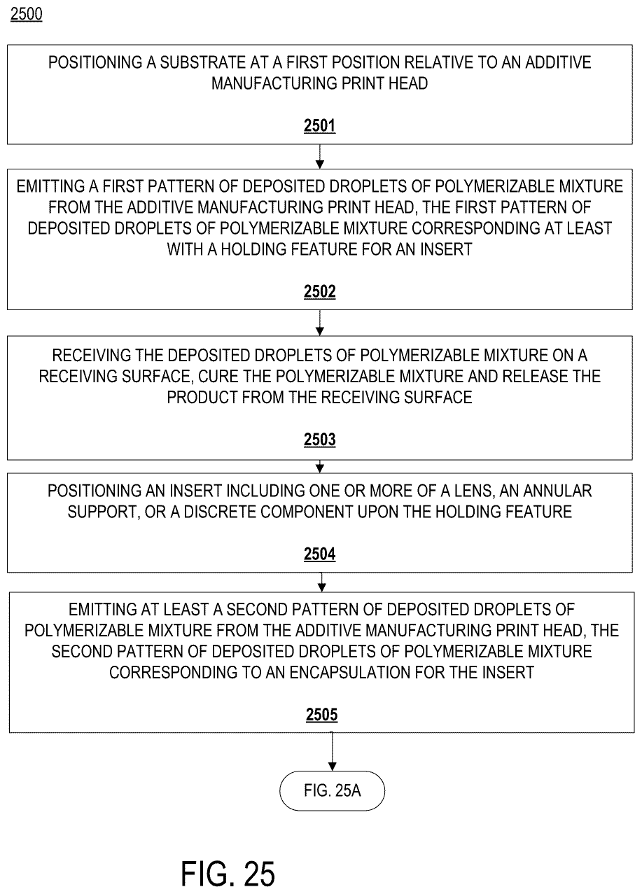

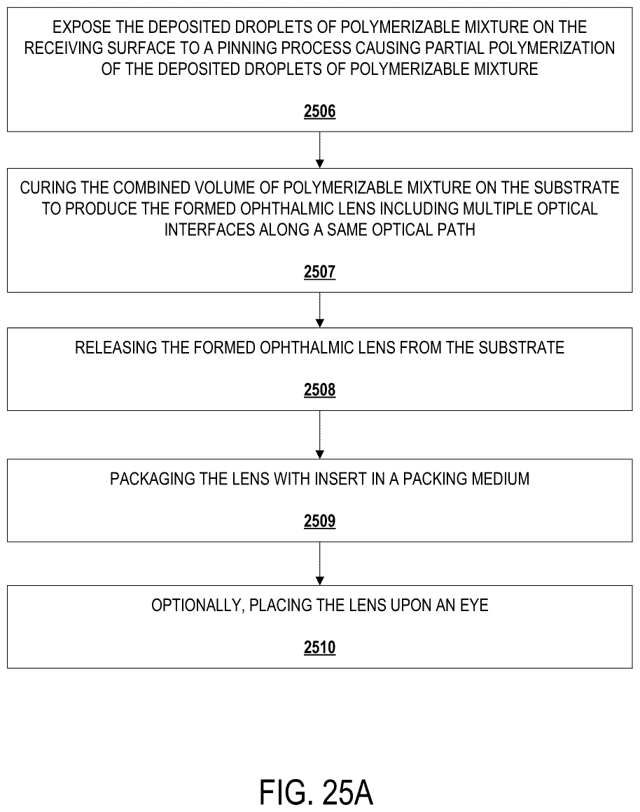

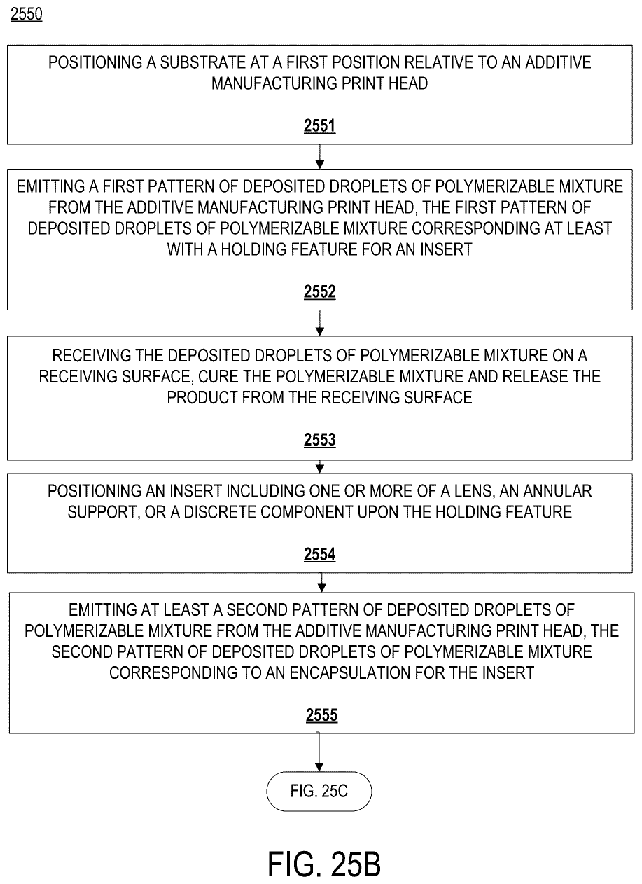

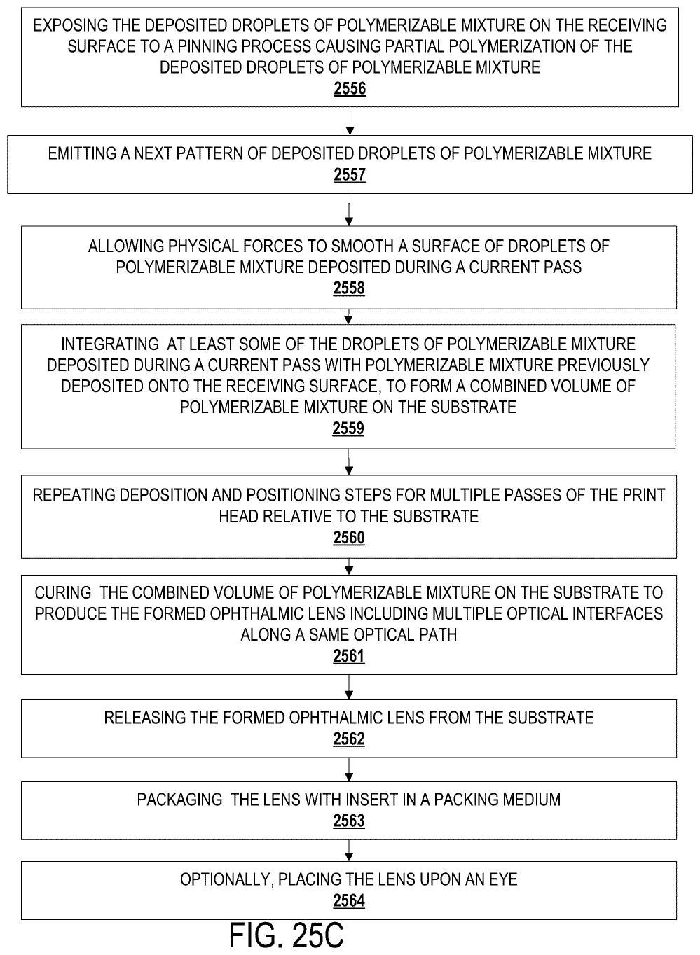

Referring now to FIGS. 25, 25A, 25B, 25C, an exemplary method flow 2500 is illustrated for steps to form a composite lens product including an insert.

At step 2501, the method may include positioning a substrate at a first position relative to an additive manufacturing print head. In some examples, the method may include, at step 2502, emitting a first pattern of deposited droplets of polymerizable mixture from the additive manufacturing print head, the first pattern of deposited droplets of polymerizable mixture corresponding at least with a holding feature for an insert.

The method may include at step 2503, receiving the deposited droplets of polymerizable mixture on a receiving surface, curing the polymerizable mixture and releasing the product from the receiving surface.

At step 2504, the method may include positioning an insert including one or more of a lens, an annular support, or a discrete component upon the holding feature.

The method may include, at step 2505, emitting at least a second pattern of deposited droplets of polymerizable mixture from the additive manufacturing print head, the second pattern of deposited droplets of polymerizable mixture corresponding to an encapsulation for the insert. The method may continue as illustrated in FIG. 25A.

At step 2506, the method may include exposing the deposited droplets of polymerizable mixture on the receiving surface to a pinning process causing partial polymerization of the deposited droplets of polymerizable mixture.

The method may include, at step 2507, curing the combined volume of polymerizable mixture on the substrate to produce the formed ophthalmic lens including multiple optical interfaces along a same optical path.

At step 2508, the method may include releasing the formed ophthalmic lens from the substrate.

In some embodiments, the method at step 2509 may include packaging the lens with insert in a packing medium. And, in some embodiments, the method may optionally include, at step 2510 placing the lens upon an eye.

Referring now to FIG. 25B, an exemplary method flow 2550 is illustrated for steps to form a composite lens product including an insert.

The method may include, at step 2551, positioning a substrate at a first position relative to an additive manufacturing print head.

The method may include, at step 2552, emitting a first pattern of deposited droplets of polymerizable mixture from the additive manufacturing print head, the first pattern of deposited droplets of polymerizable mixture corresponding at least with a holding feature for an insert.

The method may include, at step 2553, receiving the deposited droplets of polymerizable mixture on a receiving surface, curing the polymerizable mixture and releasing the product from the receiving surface.

At step 2554, the method may include positioning an insert including one or more of a lens, an annular support, or a discrete component upon the holding feature. In some examples, the method may include emitting at least a second pattern of deposited droplets of polymerizable mixture from the additive manufacturing print head, where the second pattern of deposited droplets of polymerizable mixture may correspond to an encapsulation of the insert.

The method may continue in reference to FIG. 25C, at step 2556, by exposing the deposited droplets of polymerizable mixture on the receiving surface to a pinning process causing partial polymerization of the deposited droplets of polymerizable mixture.

The method may include, at step 2557, emitting a next pattern of deposited droplets of polymerizable mixture. The next pattern of deposited droplets may include a same energy transmissibility pattern or a different energy transmissibility pattern than previously deposited droplets.

The method may include, at step 2558, allowing physical forces to smooth a surface of droplets of polymerizable mixture deposited during a current pass. In some examples, the method at step 2559 may continue with integrating at least some of the droplets of polymerizable mixture deposited during a current pass with polymerizable mixture previously deposited onto the receiving surface, to form a combined volume of polymerizable mixture on the substrate. In some examples, the method may continue with one or more repeated deposition processes and positioning steps for multiple passes of the print head relative to the substrate. At step 2561, the method may include curing the combined volume of polymerizable mixture on the substrate to produce the formed ophthalmic lens including multiple optical interfaces along a same optical path. In some examples, the method may include at step 2562, releasing the formed ophthalmic lens from the substrate. The method may include, at step 2563, packaging the lens with insert in a packing medium. In some optional examples, the method may include at step 2564, placing the lens upon an eye. Various modifications and reordering of the various steps in the various method examples may be included as methods consistent with the present specification.

### Therapeutic Agent Delivery

Printing Patterns of Therapeutic Materials Upon or within a Lens Body

In some examples, a therapeutic agent may be delivered to a patient via a lens produced utilizing the equipment and procedures described herein. In some examples, an additive manufacturing apparatus may be used to deliver both a polymerizable mixture to form a structure of a lens as well as apparatus to deliver therapeutic materials which may include pharmaceuticals, nutraceuticals, extracts, concentrates, minerals, botanicals, vitamins, lubricants, chemicals, and/or other physiologically related materials. The means to deliver the therapeutic material may occur in different forms.

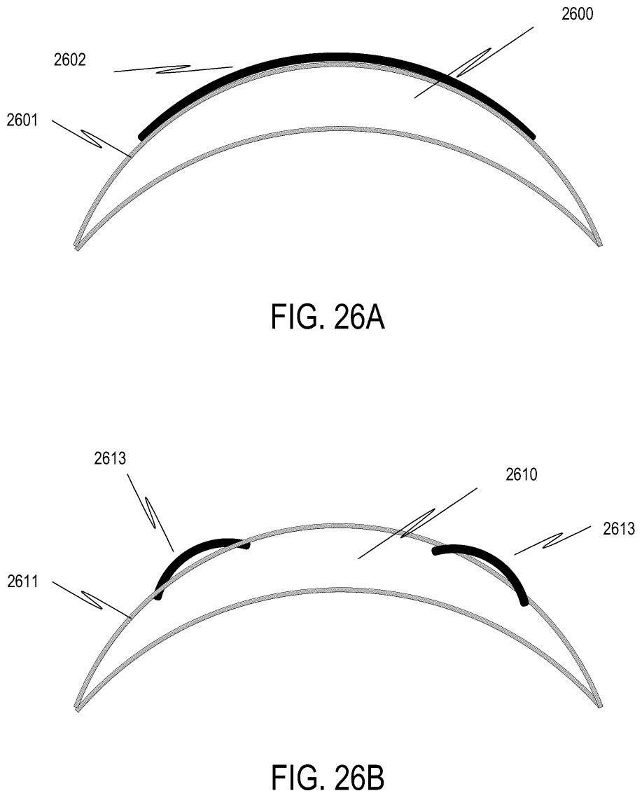

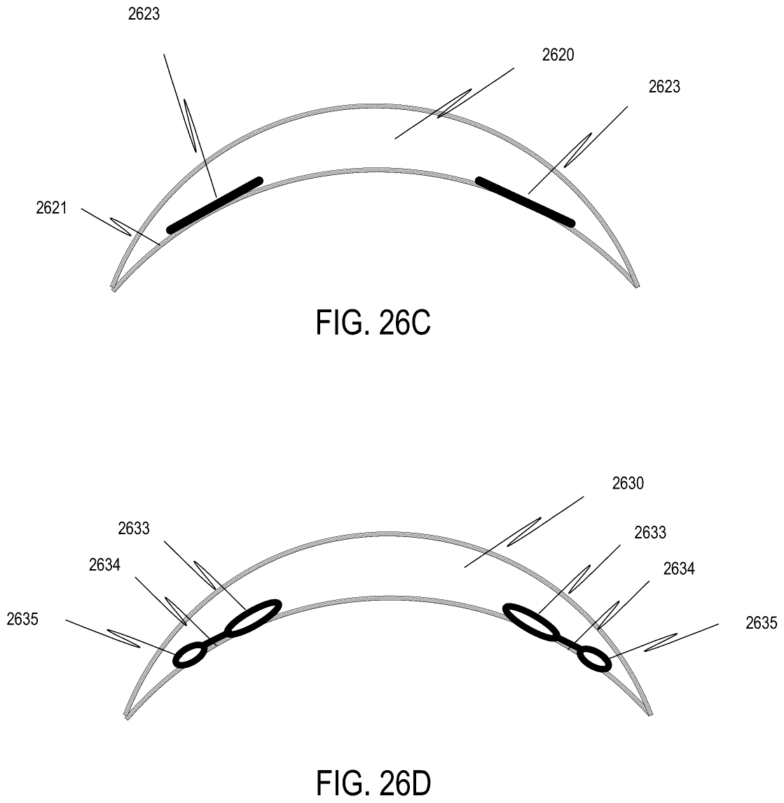

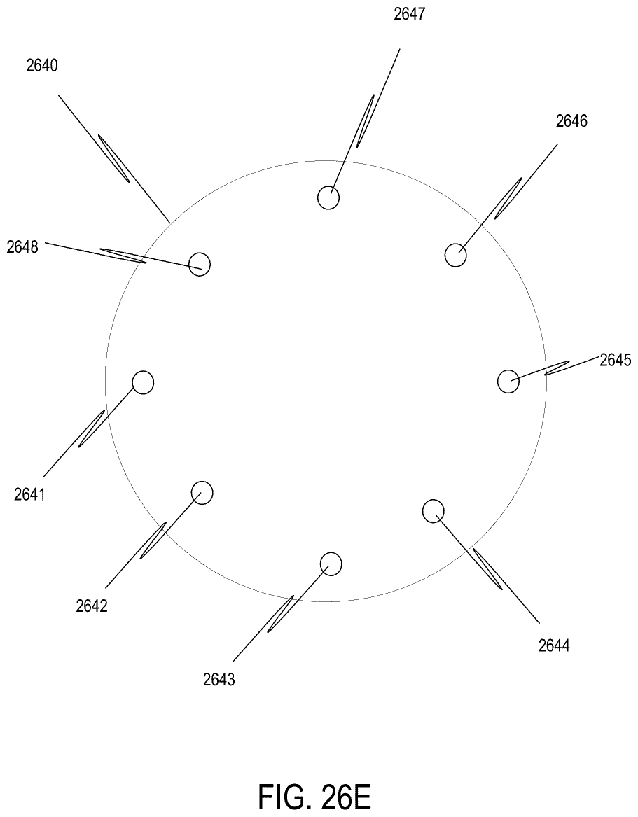

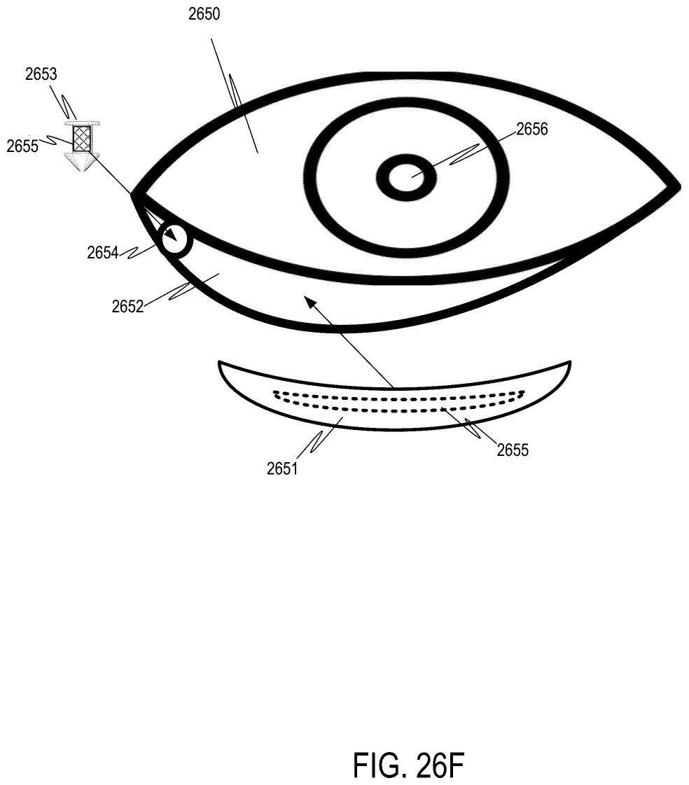

Referring to FIGS. 26A-C in some examples, a therapeutic material may be directly printed into a mass of a lens as the lens is being formed, and/or onto a surface of the lens being formed or already formed. The therapeutic material may be in the form of a powder, a liquid, or a dissolved formulation with the therapeutic material and a solvent. FIGS. 26A-C illustrate a non-exhaustive set of examples of different types of lenses with incorporated drug delivery aspects.

FIG. 26A illustrates an exemplary lens with a full coating over a body of an optical lens. A lens body 2600 may be printed according to the various examples as have been described herein. The lens body 2600 may include an optic zone with structures consistent with a desired prescription for a user. The lens body 2600 may have a surface 2601 resulting from the formation process. As described in following sections, a therapeutic agent 2602 may be imparted into and/or onto the lens body 2600 such that it is one or more of: integrated into the lens body 2600, encapsulated entirely or partially by the lens body 2600, on a portion of the surface of the lens body 2600, and substantially covers an entire surface of the lens body 2600. FIG. 26A illustrates a therapeutic agent on a convex top surface of a lens. Embodiments may also include results from a reverse curve on a forming mandrel such that the therapeutic agent may be printed or otherwise imparted to the inner surface of the lens.

Referring now to FIG. 26 B, an exemplary lens with an annular coating is illustrated. As described herein, additive manufacturing may be functional to impart a therapeutic agent 2613 onto a surface 2611 of a lens body 2610 and/or integrated partially or fully into the lens body 2610. In some embodiments, deposition may be performed such that a pattern, such as, for example, an annular distribution of the therapeutic material may be formed. In some examples, the annular location may be limited to regions of the lens body 2610 outside of an optic zone of the lens. In such manner, the therapeutic agent may not interact with image light or other energy proceeding through the contact lens, while still distributing the therapeutic material into the eye environment of a user. Distributing the therapeutic agent into the eye environment may be accomplished, for example via eluding, dissolving, dissipating, or otherwise distributing the therapeutic agent into the ocular environment.

Referring now to FIG. 26C, an exemplary lens with incorporated absorbent regions is illustrated. An exemplary lens body 2620, may be printed such that an inside portion 2621 of the lens may include regions 2623 with a different material printed. The different material may be a different form of the material used to form the lens body 2620 in some examples. In some other examples, the different material may be a different composition as described in following sections. The result may be to form regions with absorbent properties. The absorbent region may be able to absorb therapeutic agents when the lens body is soaked in a solution containing the therapeutic agent. When worn by a user, therapeutic material may diffuse out from the absorbent region and into the eye environment for a purpose of the therapeutic material.

Referring now to FIG. 26D an exemplary lens with a different means for treatment with therapeutic release structures is illustrated. Specific examples are discussed in following sections, but a lens base 2630 may include storage features 2635 where a therapeutic agent may be stored. In the illustrated example another storage feature 2633 may store a gas. The gas may be activated to flow through a tube 2634 to force out the therapeutic agent from the storage feature 2633. Various other examples of activating a flow are discussed herein, and a result of this type of example is that an activation causes a release of a therapeutic agent stored within the lens product.

Referring now to FIG. 26F, in some embodiments, an article may be formed that according to the manufacturing process steps and using the apparatus described herein that does not include an ophthalmic lens, but does include an ophthalmic device, such as, by way of non-limiting example, one or both of: an ophthalmic insert 2651 that includes and/or supports a therapeutic agent 2655; and a punctal plug 2653 that includes and/or supports a therapeutic agent 2655 such that the therapeutic agent is dispensable into an ophthalmic region 2650 of the patient.

The punctal plug 2653 may be of a size and shape to snugly fit in a punctum 2654. In some embodiments, the punctal plug 2653 may be of a size and shape designed to generally fit in a punctum 2654, such as punctum plugs available in various predetermined sizes, such as, for example: small, medium, and large punctal plugs 2653.

In other embodiments, a punctal plug 2653 may be generated using the additive manufacturing processes and apparatus disclosed herein to generate a punctal plug 2653 specific to a patient and the size and shape of the patient's punctum. Preferably, the punctal plug includes a hydrogel material supporting or having a therapeutic agent incorporated into the punctal plug 2653; however, other materials are within the scope of the present invention.

An ophthalmic insert 2651 may also be generated in multiple standard sizes and/or custom to a particular patient's ocular area. The ophthalmic insert 2651 may support or have incorporated or integrated into it one or more therapeutic agents 2655.

In some preferred embodiments, an ophthalmic insert 2651 may be of a size and shape to fit beneath a lower eye lid 2652 of a patient. The ophthalmic insert 2651 may be kept outside of path of sight 2656 in the ophthalmic region 2650.

A therapeutic material comprising a therapeutic agent may be printed in various manners. In examples, where a pattern is employed for the location of the therapeutic material, printing of the therapeutic material, such as a composite solid form, may be programmed to occur in a defined pattern. In some examples, such a pattern may be programmed across the surface of the lens. In some other examples, a center region of the lens that includes an optic zone may be avoided for placement of the therapeutic material, as the therapeutic material may interact with light energy passing through the lens in undesirable ways.

In some embodiments, a pattern of deposition of a therapeutic agent may be designed in a grid pattern across the surface or across the annular surface defined when the center is avoided for patterning. In some examples, geometric elements such as circles, ellipses, rectangles, squares, or other irregular elements may be defined into the pattern for placement of therapeutic material. For example, referring to FIG. 26E, an exemplary pattern of circular elements 2641-2648 designed to be deployed across the annular region outside an optic zone (where image light passes through the lens to the retina) is illustrated in concert with a lens base 2640 printed using the principles as described herein. Other shapes are also within the scope of the present invention.

In some examples, a lens may be formed in layered progression where a number of layers of polymerizable material may be deposited according to a planned pattern, and pinned in place (albeit not fully cured). Subsequently a layer comprising a therapeutic material may next be printed or added to the surface of the growing lens. In some examples, this next layer with therapeutic material may be a mixture of the same polymerizable material used for the initial layers along with co-dissolved therapeutic materials. In other examples, a layer of the therapeutic material may be deposited across the lens face or across a subregion of the lens face, such as in a non-limiting example across an annular region external to the optic zone. The process may be repeated, adding additional structural layers and additional therapeutic material layers to form a fully formed lens product. In some examples, the layer of therapeutic material may be a single layer that is sandwiched between structural layers of pinned polymerizable material. In some examples, the layers of structural layers before the printing of a therapeutic layer may be fully cured before the therapeutic layer is dispersed. In some examples, the polymerizable layers in the varied deposition of layers of polymerizable material and therapeutic materials may be formed with the polymerizable layers are formed from different compositions. For example, one of the polymerizable layers may be formed from a monomer mixture that imparts a generally open polymer structure which may allow for diffusion of the therapeutic material through the layers more easily when employed.

In some examples, the therapeutic material may be mixed with a solvent and the solvent may evaporate or otherwise dissipate. In other examples, the solvent may be water based, and the water may be incorporated into the matrix formed by the polymerization of polymerizable material. For therapeutic materials which are water soluble, the therapeutic material may leach out of the lens as it is exposed to water-based solutions. Accordingly in some examples, the therapeutic material may be included in any packing solution, or alternatively, a lens may be stored in a dried form and then hydrated in solution before use. The amount of a therapeutic material may be titrated to ensure that after any leaching out of the lens that occurs before a user uses the lens may result in a remaining amount of therapeutic material as required for its effective usc.

In other examples, the therapeutic material may be utilized in a composite solid form, wherein the therapeutic material is surrounded by an encapsulation and release layer, wherein the surrounding material may be designed to dissolve at a defined rate. The composite solid may be printed in a solid form, such as with electrostatic printing in a non-limiting example. In other examples, the composite sample may be formed into an emulsion that may be printed. In other examples, the emulsion, mixture, or dissolved liquid may be printed as a form of “ink” onto the lens base or a structural intermediate of the lens base. In some examples the encapsulation material of the therapeutic composite structure may dissolve in aqueous solution. The time to complete dissolution may be controlled by controlling the thickness of encapsulation layers surrounding the therapeutic agent. Thus, if a lens is hydrated before use, the timed release of the therapeutic agent may be configured to last at least as long as a timed and typical hydration process. In some examples, composite structures with different characteristics of the encapsulation layer such as thickness or composition may be used to release therapeutic material over an extended period of time at different onset timings for a particular composite material element.

The various forms of printing or dispensing of therapeutic agents may lay out the therapeutic agent in various patterns as has been described. The design of patterns may be motivated based on the base need of the therapeutic material. For example, if the therapeutic material works by diffusing across the user's eye lens surface, then a pattern that fills the entire surface or annular surface may be used. In other examples, such as treatment of a corneal abrasion, in a non-limiting example, the location of therapeutic material may be designed to be in the particular region. In some examples, the lens may have a customized design of the placement of therapeutic material regions. In some examples, where a particular region is designed, the lens may have design elements that orient the contact lens on the surface of the eye. For example, protrusions may interact with eyelids of a user and orient the lens physically.

In some examples, the therapeutic material may be mixed within polymerizable mixture, and its pattern of location printed into the lens similarly to the printing of plain polymerizable mixture. In some of these examples, another print head may be used to print the polymerizable mixture with included therapeutic material. In other examples, a single print head may be fed different sources of printing material, and at times will be fed polymerizable mixture mixed with therapeutic material.

In some examples, the therapeutic material may be added to a formed lens body by needle injection into the body of the lens. In some of these examples, the body of the needle may carry the dose of the therapeutic material on its surface and leave the therapeutic material in the body of the lens during a penetration of the lens body. In other examples, a syringe type dispenser may dispense onto the lens surface or into the lens body. The syringe may include a mixture of polymerizable mixture with the therapeutic material or a solution of the therapeutic material.

### Incorporation of Structural Elements to Store and Deliver Therapeutic Material

In some examples, the therapeutic material may be contained within a release structural element within the lens structure. In such examples, the release of the therapeutic material may be activated in other means than dissolution in non-limiting examples. In some examples, a pressure exerted upon the release structural element may cause a release. The pressure may be applied in a number of ways including, non-limiting examples of a user pressing upon the lens through an eyelid of the user. In another example, the release structural element may have a protrusion above the surface of the lens which may have a force exerted upon the release structural element with each eyelid blink of the user.

In some examples, patterns within the lens or other ophthalmic device may form structures which may be filled with therapeutic material by a soaking process of the lens in a mixture containing the therapeutic. In some examples, patterns within the lens may form vias and pockets which may absorb the therapeutic material when the lens body is soaked. In some alternatives, there may be numerous passes during the printing including polymerizable mixture to form a fixed structure as well as passes with dissolvable material. Pockets, vias and the like may be formed through a multistep process, Dissolvable material may be printed in between passes of polymerizable mixtures to form the “negative structure,” such as vias and buried pockets, when a finished lens is placed in an aqueous solvent that may be used to dissolve away the dissolvable material. The pockets and vias may be used to conduct the therapeutic agent and to store it. In some examples, pockets may be filled with syringes as described previously. In other examples, the pockets may be filled by soaking the structure in a solution containing the therapeutic agent.

In some examples, the via and pocket processes may create complex structures such as combinations of pockets, vias and valve-type structures that limit flow of material to a single direction. In a non-limiting example, a large pocket may be combined with a second pocket which may be interconnected with a tube structure. In some examples, the tube structure may include valved to constrain flow from the first large pocket to the second pocket. In addition, there may be a second tube that runs from the second pocket to the edge of the lens body. This second tube may also constrain movement of internal material between the second pocket and edge of the lens body. In the examples, a dose of the therapeutic agent may be contained in the second pocket while an amount of gas may be filled into the first pocket. In an exemplary usage, a user of the contact lens may place the lens upon their eye and subsequently provide a gentle pressure onto the lens, such as by pressing upon their eyelid while the eye is closed. The pressure may force the gas through the first tube and then force the therapeutic agent from the second pocket into designed regions of the user's eye.

### Incorporation of Absorbing Material for Therapeutic Agent Delivery

In some examples, a pattern of material may be printed during the formation of the lens body of a different composition than the bulk of the body of the lens printed with a first composition of polymerizable material. The different composition may include characteristics that allow the portions of material of different composition to absorb therapeutic materials or therapeutics when the lens body is immersed and “soaked” in a solution containing the therapeutic materials. In some of these examples, the regions of different composition may be formed by use of a different type of polymerizable material, where the material may have different crosslinking characteristics or different chemical functional groups bound to the monomers of the polymerizable material. In some examples, the different characteristics may impart an absorbent characteristic much like a sponge acts. In some examples the different material may be printed onto the growing lens structure that has these characteristics of being able to absorb, in a reversable manner, therapeutic materials that a lens body is immersed in.

Lenses with absorbent features may be soaked in a hydrating aqueous solution containing a co-dissolved therapeutic agent. In some other examples, the lens may be soaked in packing solution containing the co-dissolved therapeutic agent. The absorbent regions may soak up or absorb significant amounts of the solutions, such that when the lens is removed from the packing solution a dose of therapeutic material absorbed in the absorbent features is brought to the user's eye surface. In some examples, natural diffusion of the therapeutic agent from the absorbent features into the tear fluid of the user's eye may allow for dosing of the eye with the therapeutic agent.

In some examples, the absorbing material may be designed to act in temperature sensitive manners such that as a lens is worn on a user's eye it may warm towards the body temperature of the user. The rise in temperature may activate the absorbing material in the sense that the temperature rise may increase a release process of absorbed therapeutic materials into the eye environment. In some examples, when the lens is kept at reduced temperatures during storage and periods before use, the body temperature of the user may activate release of increased levels of the therapeutic material.

### Optic Bandage

In some examples, the lenses produced according to the various descriptions herein may function as a form of optic bandage. An injury such as a scratch to the cornea of a user may be treated with this form of optic bandage. In some examples, the printing processes, as described herein, may be used to form a contact lens with included therapeutic materials. The therapeutic materials may include in a non-limiting sense, steroids, antibiotics, lubricants, and other therapeutic agents that may be functional to support a wound to a user's eye. In some examples, the lens may otherwise function normally to improve a vision aspect of the user. In other examples, the lens may include printing of materials to render the optic zone of the lens opaque or dark as part of the function of the bandage. In such examples, the lens may include printing to render the optic zone dark as well as cosmetic printing on the top surface to render features such as an iris and the like as a cosmetic aspect. In some examples, an image of the user's eye may be obtained with an image capturing device and said image may be utilized to render the cosmetic aspect of the optic bandage.

### Electronics Based Release of Therapeutic Material

In some examples, the lenses produced according to the various descriptions herein may include electronic elements. The electronic elements may include means to control release of the therapeutic agent based on a signal of a user. For example, an electronic element may comprise a means to receive an RF signal from the environment. The RF signal may provide a level of power to the electronic device as well as include control signals. The control signals may be operant to signal the electronic element to engage a release of stored therapeutic agent within the contact lens. In some examples, the storage of the therapeutic agent may be within the electronic element itself. In a non-limiting example, power either stored from the RF signal or from an energy storage component of the electronic element may cause a boundary such as a thin metal layer to be eliminated by melting. In other examples, the electronic element may actuate a pumping action or release a valve. Referring to the previous example of a lens with pockets that can be used to force therapeutic agents to release, the electronic element may control a component to exert a force on a pocket to engage a release. In non-limiting examples, the force may come from piezo electric action, or from electrodynamic forces across a set of capacitor plates. Other means of pumping may also be employed. An external signaling device such as a fob, smart device or other communication enabled device may be used to activate the release of therapeutic material. Printing of reactive material may be used to encapsulate such electronic devices into the body of such a lens with therapeutic capability.

Methods of Drug Delivery with Contact Lenses

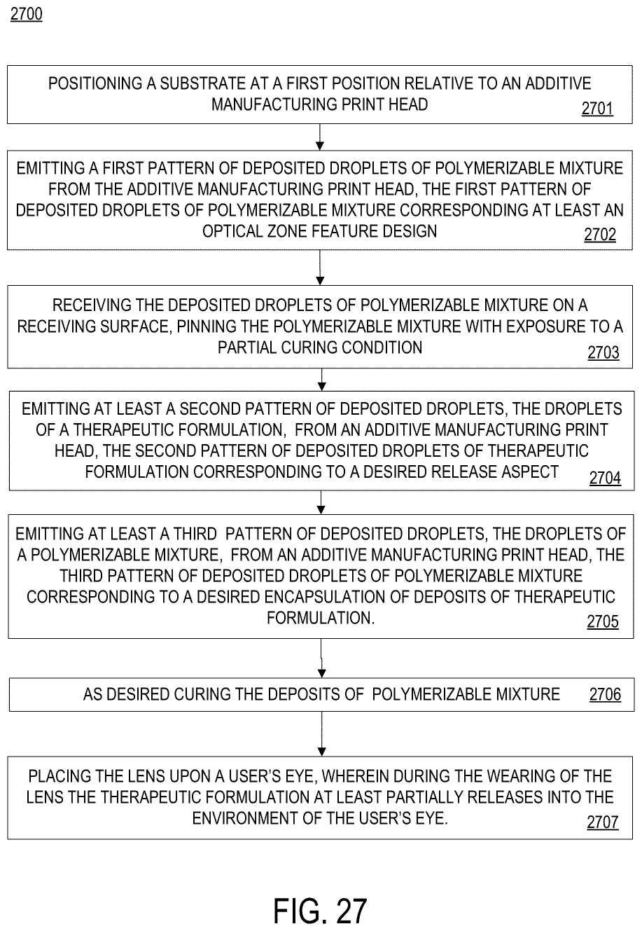

Referring now to FIG. 27, an exemplary process flow diagram for delivering a drug with a contact lens utilizing printing is illustrated. Beginning at step 2701, the method may include positioning a substrate at a first position relative to an additive manufacturing print head. At step 2702, the method may include emitting a first pattern of deposited droplets of polymerizable mixture from the additive manufacturing print head, the first pattern of deposited droplets of polymerizable mixture corresponding at least an optical zone feature design. At step 2703, the method may include receiving the deposited droplets of polymerizable mixture on a receiving surface, pinning the polymerizable mixture with exposure to a partial curing condition. At step 2704, the method may include emitting at least a second pattern of deposited droplets, the droplets of a therapeutic formulation, from an additive manufacturing print head, the second pattern of deposited droplets of therapeutic formulation corresponding to a desired release aspect. At step 2705, the method may include optionally emitting at least a third pattern of deposited droplets, the droplets of a polymerizable mixture, from an additive manufacturing print head, the third pattern of deposited droplets of polymerizable mixture corresponding to a desired encapsulation of deposits of therapeutic formulation. At step 2706, the method may include, as desired, curing the deposits of polymerizable mixture. At step 2707, the method may include optionally placing the lens upon a user's eye, wherein during the wearing of the lens the therapeutic formulation at least partially releases into the environment of the user's eye.

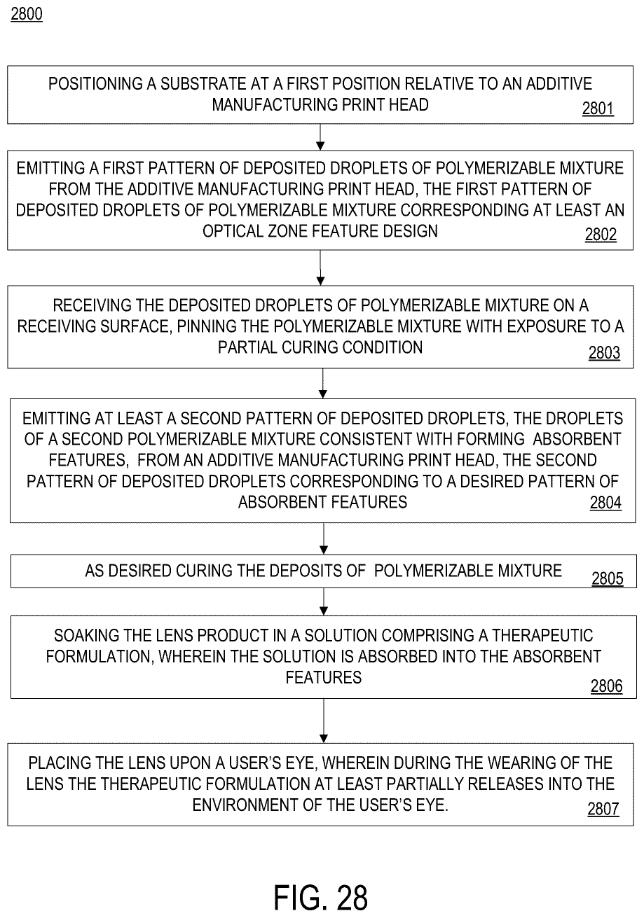

Referring to FIG. 28, a method of printing a lens base with an absorbent material, soaking the lens in a solution containing a therapeutic agent, placing the lens on a user's eye, and dispensing the therapeutic agent is illustrated. At step 2801, the method may include positioning a substrate at a first position relative to an additive manufacturing print head. At step 2802, the method may include emitting a first pattern of deposited droplets of polymerizable mixture from the additive manufacturing print head, the first pattern of deposited droplets of polymerizable mixture corresponding at least an optical zone feature design. At step 2803, the method may include receiving the deposited droplets of polymerizable mixture on a receiving surface, pinning the polymerizable mixture with exposure to a partial curing condition. At step 2804, the method may include emitting at least a second pattern of deposited droplets, the droplets of a second polymerizable mixture consistent with forming absorbent features, from an additive manufacturing print head. At step 2805, the method may include, as desired, curing the deposits of polymerizable mixture. At step 2806, the method may include, soaking the lens product in a solution comprising a therapeutic formulation, wherein the solution is absorbed into the absorbent features. At step 2807, the method may include optionally placing the lens upon a user's eye, wherein during the wearing of the lens the therapeutic formulation at least partially releases into the environment of the user's eye.

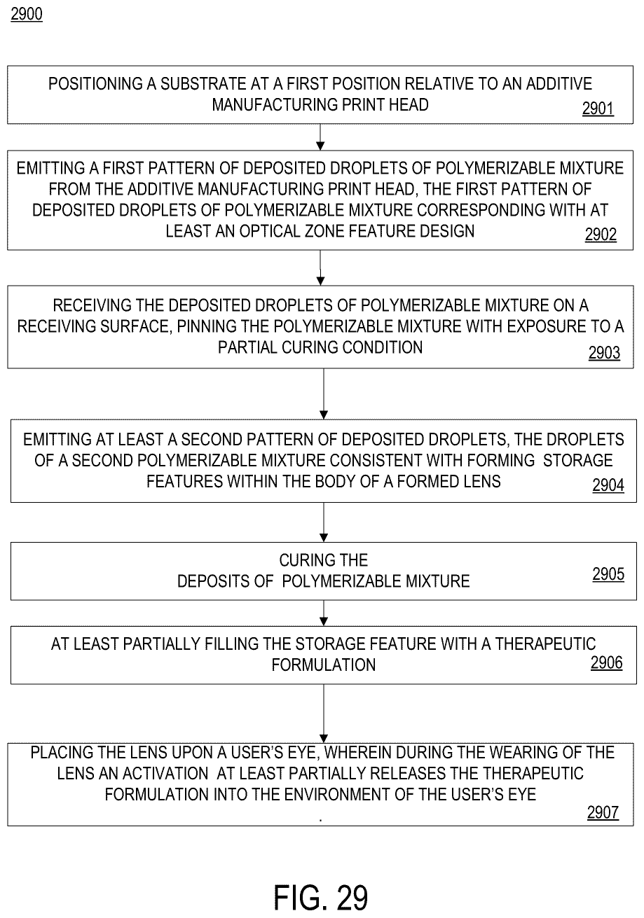

Referring to FIG. 29, a method of printing a lens base with a storage feature, filling the storage feature with a therapeutic agent, placing the lens on a user's eye, and activating a release of the therapeutic agent from the storage feature is illustrated. At step 2901, the method may include positioning a substrate at a first position relative to an additive manufacturing print head. At step 2902, the method may include emitting a first pattern of deposited droplets of polymerizable mixture from the additive manufacturing print head, the first pattern of deposited droplets of polymerizable mixture corresponding at least an optical zone feature design. At step 2903, the method may include receiving the deposited droplets of polymerizable mixture on a receiving surface, pinning the polymerizable mixture with exposure to a partial curing condition. At step 2904, the method may include Emitting at least a second pattern of deposited droplets, the droplets of a second polymerizable mixture consistent with forming storage features within the body of a formed lens. At step 2905, the method may include, as desired, planning a curing process and curing the deposits of polymerizable mixture. At step 2906, the method may include at least partially filling the storage feature with a therapeutic formulation. At step 2907, the method may include optionally placing the lens upon a user's eye, wherein during the wearing of the lens an activation at least partially releases the therapeutic formulation into the environment of the user's eye.

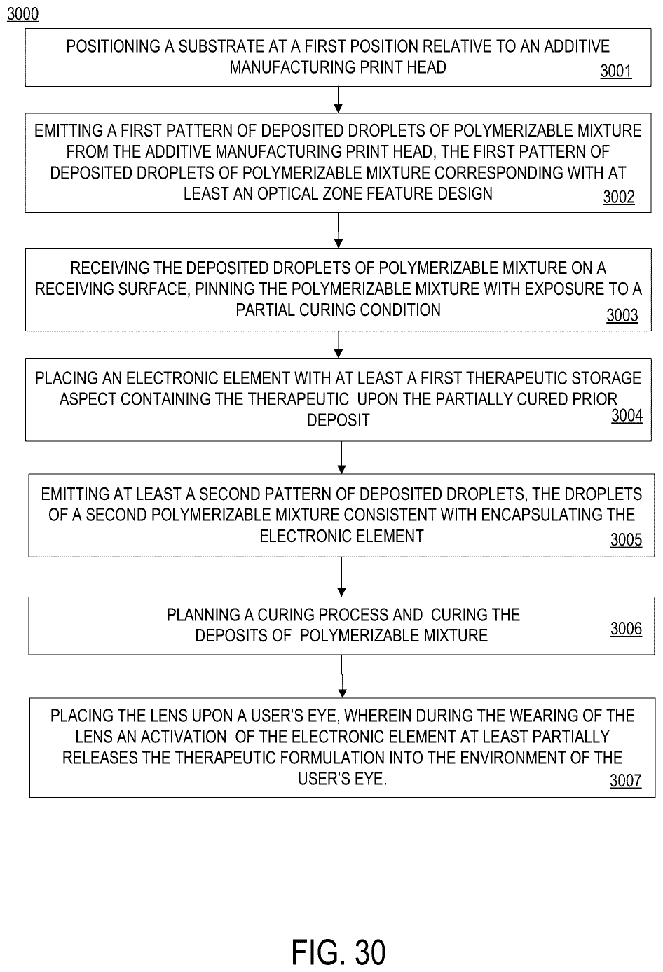

Referring to FIG. 30, a method of printing a lens base with an incorporated electronic element, wherein the electronic element includes a stored therapeutic agent. The method also may include placing the lens on a user's eye, activating the electronic element with a wireless communication such as RF, IR, Vis, or Sound energy in a non-limiting set of examples. The method may also include releasing the therapeutic agent from the electronic device. At step 3001, the method may include positioning a substrate at a first position relative to an additive manufacturing print head. At step 3002, the method may include emitting a first pattern of deposited droplets of polymerizable mixture from the additive manufacturing print head, the first pattern of deposited droplets of polymerizable mixture corresponding at least an optical zone feature design. At step 3003, the method may include receiving the deposited droplets of polymerizable mixture on a receiving surface, pinning the polymerizable mixture with exposure to a partial curing condition. At step 3004, the method may include placing an electronic element with at least a first therapeutic storage aspect containing the therapeutic upon the partially cured prior deposit. At step 3005, emitting at least a second pattern of deposited droplets, the droplets of a second polymerizable mixture consistent with encapsulating the electronic element. At step 3006, the method may include, as desired, planning a curing process and curing the deposits of polymerizable mixture. At step 3007, the method may include optionally placing the lens upon a user's eye, wherein during the wearing of the lens an activation of the electronic element at least partially releases the therapeutic formulation into the environment of the user's eye.

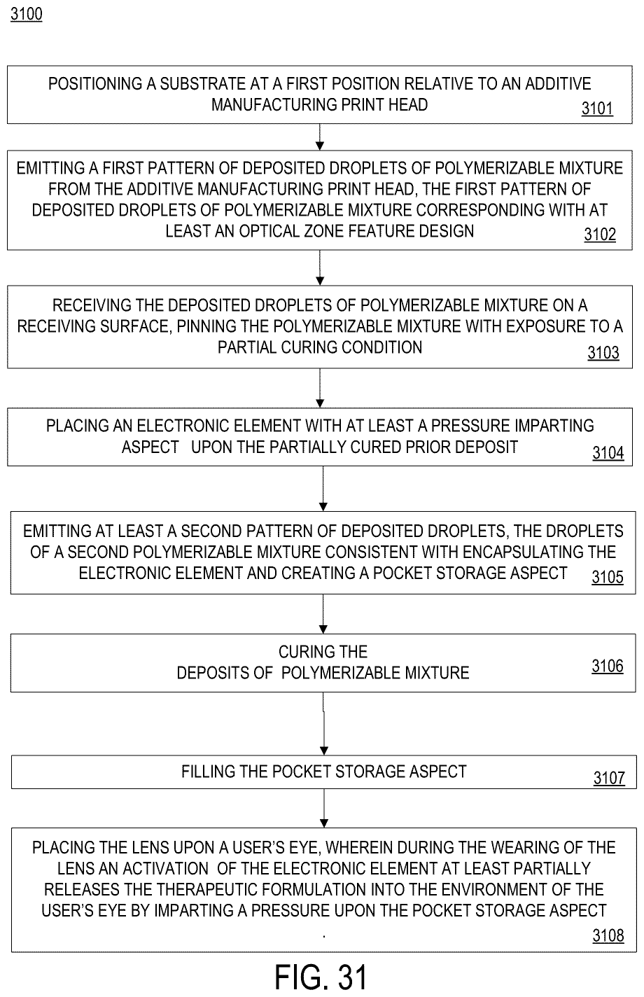

Referring now to FIG. 31, a method of printing a lens base with an incorporated electronic element and a pocket based therapeutic storage element, wherein the electronic element includes a means to impart a pressure to the therapeutic storage element is illustrated. The method may also include placing the lens on a user's eye and activating the electronic element with a wireless communication such as RF, IR, Vis Sound, and the like. The method may also include releasing the therapeutic agent from the pocket storage element. At step 3101, the method may include positioning a substrate at a first position relative to an additive manufacturing print head. At step 3102, the method may include emitting a first pattern of deposited droplets of polymerizable mixture from the additive manufacturing print head, the first pattern of deposited droplets of polymerizable mixture corresponding at least an optical zone feature design. At step 3103, the method may include receiving the deposited droplets of polymerizable mixture on a receiving surface, pinning the polymerizable mixture with exposure to a partial curing condition. At step 3104, the method may include placing an electronic element with at least a pressure imparting aspect upon the partially cured prior deposit. At step 3105, emitting at least a second pattern of deposited droplets, the droplets of a second polymerizable mixture consistent with encapsulating the electronic element and creating a pocket storage aspect. At step 3106, the method may include, optionally, planning a curing process and curing the deposits of polymerizable mixture. At step 3107, the method may include filling the pocket storage aspect. At step 3108, the method may include optionally placing the lens upon a user's eye, wherein during the wearing of the lens an activation of the electronic element at least partially releases the therapeutic formulation into the environment of the user's eye by imparting a pressure upon the pocket storage aspect.

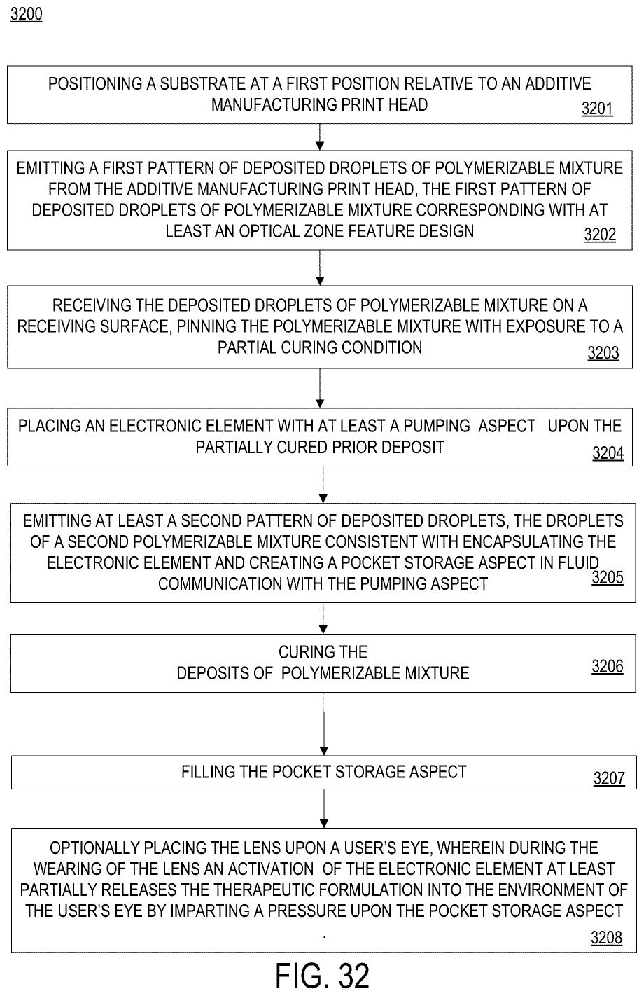

Referring now to FIG. 32, a method of printing a lens base with an incorporated electronic element with a pumping element and a pocket based storage element, placing the lens on a user's eye, activating the electronic element with a wireless communication, wherein the activating causes the pumping element to pump a therapeutic agent out of the pocket based storage element and into the environment of the eye. At step 3201, the method may include positioning a substrate at a first position relative to an additive manufacturing print head. At step 3202, the method may include emitting a first pattern of deposited droplets of polymerizable mixture from the additive manufacturing print head, the first pattern of deposited droplets of polymerizable mixture corresponding at least an optical zone feature design. At step 3203, the method may include receiving the deposited droplets of polymerizable mixture on a receiving surface, pinning the polymerizable mixture with exposure to a partial curing condition. At step 3204, the method may include placing an electronic element with at least a pumping aspect upon the partially cured prior deposit. At step 3205, emitting at least a second pattern of deposited droplets, the droplets of a second polymerizable mixture consistent with encapsulating the electronic element and creating a pocket storage aspect. At step 3206, the method may include, optionally, planning a curing process and curing the deposits of polymerizable mixture. At step 3207, the method may include filling the pocket storage aspect. At step 3208, the method may include optionally placing the lens upon a user's eye, wherein during the wearing of the lens an activation of the electronic element at least partially releases the therapeutic formulation into the environment of the user's eye by imparting a pressure upon the pocket storage aspect.

### Retinal Damage—Background

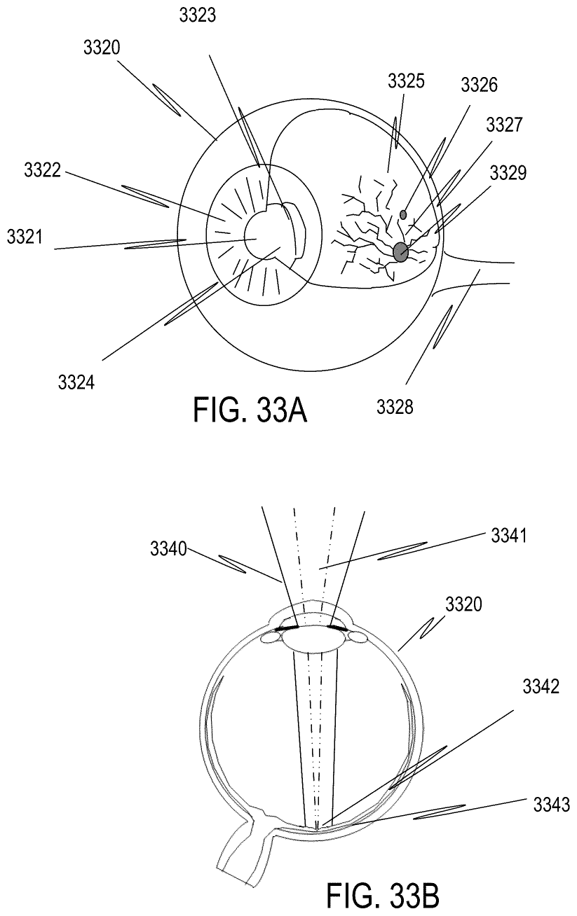

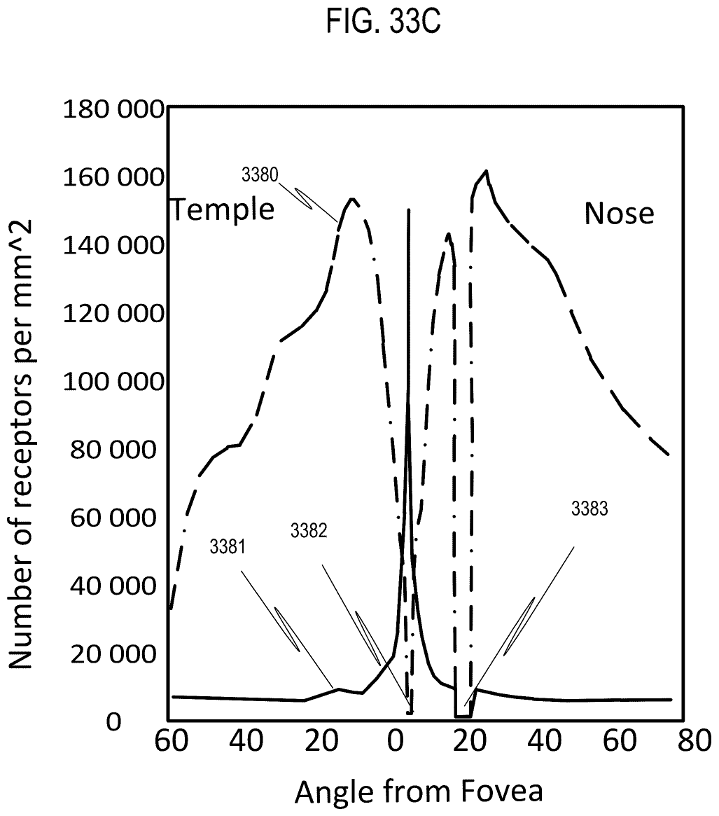

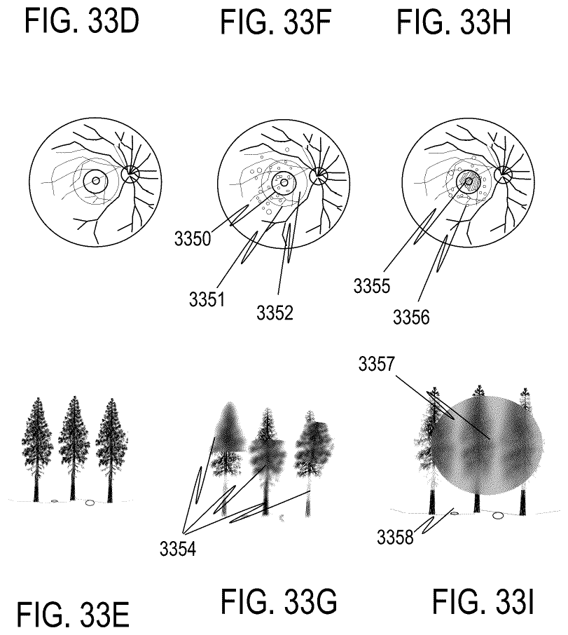

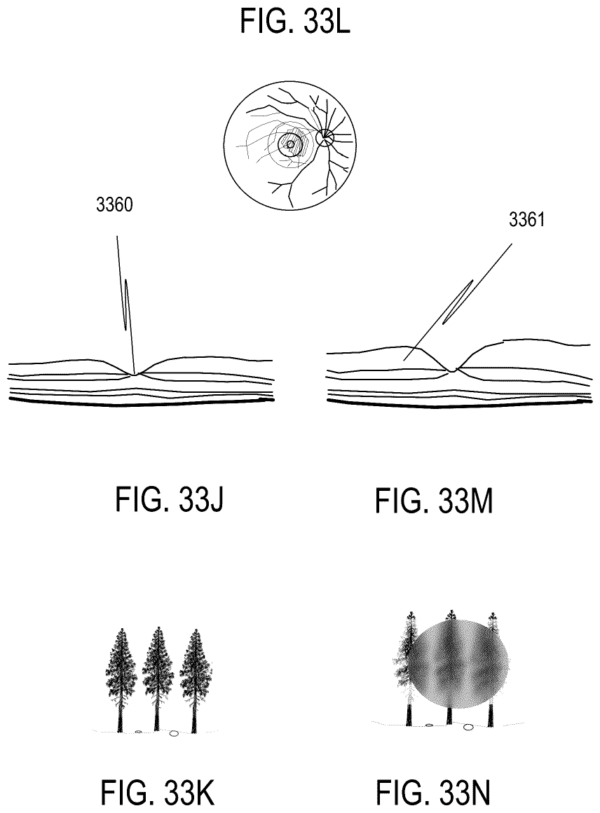

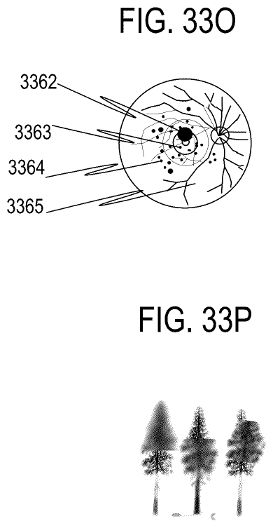

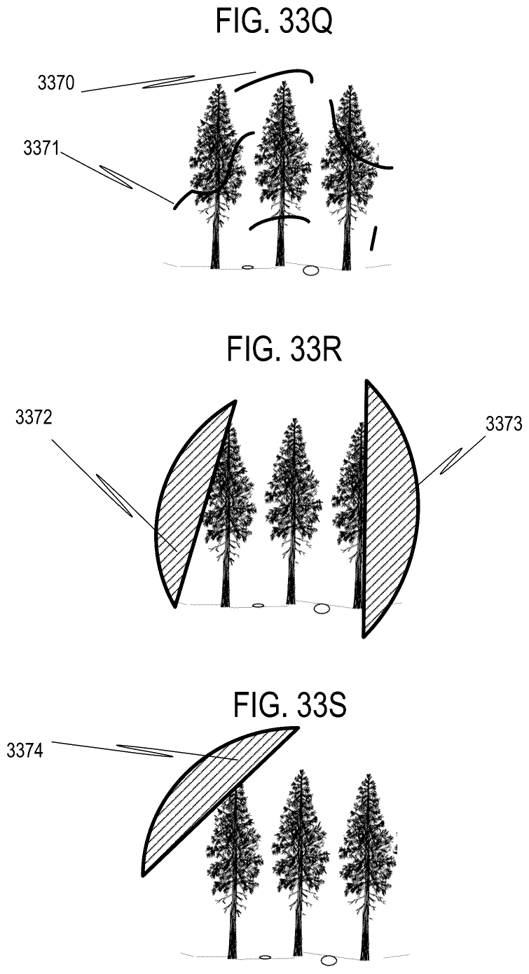

There are a number of different diseases and damage cases for the retina of a user. To understand the nature of the various disease and damage cases, review of the structure of eye and its associated retinal structures may be helpful. Referring to FIG. 33A, an illustration of the structures of the retina and other structures of the human eye 3320 is provided. At the front of the eye 3320 is structures that provide an aperture for light to proceed into the eye. A pupil 3321 is a dynamic structure that adjusts under control of the body to incident light levels. The pupil 3321 is accompanied by the iris 3322 and the cornea 3324. Light next proceeds through the crystalline lens 3323 which is also a dynamic element that changes shape under control of the body to focus light upon the back of the eye where the retina 3325 is located. The retina is a thin structure of different cell types which generally performs the function of reacting to light and passing the reaction aspect as a signal along to the brain. The retina 3325 includes a small structure, the central fovea 3326 that includes a particularly dense incorporation of light sensitive cells, including mostly cones that provides the best image resolution and color sensitivity of the retina 3325.

The remaining parts of the retina 3325 also contain cells with light sensitivity with different neural connection aspects that generally make the structures more sensitive to changes in image aspects that fall upon them such as the changes that occur when objects are moving. The rods outside the fovea respond to lower levels of light and are accordingly mostly responsible for night vision. Since the rods do not have color sensitivity, the low-level light vision is typically scales of grey. The remaining regions of the retina outside the central fovea 3326 may generally be associated with peripheral vision while the central fovea 3326 may be associated with central vision.

The various cells and structures of the retina 3325 are nourished by blood vessels 3327 within the structure of the eye and are also connected to neural cells of various kinds that connect ultimately to the optic nerve 3328 and pass neural signals to various parts of the brain. The blood vessels and nerves exit the eye around the optic disc 3329. Because the optic disc 3329 is the region of blood vessels and nerves it does not have the cells that are light sensitive and accordingly is associated with the blind spot in normal vision.

Referring now to FIG. 33B, a cross section of an eye 3320 illustrates how the structures of the eye can bring rays of light from images into focus on the various portion of the retina. The rays associated with objects in the center of vision 3341 may be focused by the lens of the eye upon the region of the central fovea 3342. The rays associated with objects in the periphery of the visual field 3340 may be focused upon the remaining parts of the retina 3343. These concepts are related in a general sense to normal vision aspects.

Proceeding to FIG. 33C, an illustration of a curve depicting cell density in the retina for both cones 3380 (solid line) and rods 3381 (dashed lines). As can be observed in the graph, the cell density of cones is highest in the central fovea 3382. Cones impart color sensitivity and are associated with the highest acuity regions of the retina in the central fovea. The density of cones falls off significantly away from the fovea. Conversely, the density of rods is nearly zero in the fovea and reaches a maximum on the perimeter of the fovea. Rods are generally larger cells and do not distinguish colors but are able to respond more quickly to stimulus. Night vision, for example, is supplemented by the cones in the periphery of the fovea. Both rods and cones have cell density of zero at the “blind spot” 3383.

Proceeding to FIG. 33D, a view of the normal retina is illustrated along with various examples of the features identified in FIG. 33A is illustrated. Along with this depiction of a normal healthy eye is an associated normal image of an exemplary landscape scene as illustrated in FIG. 33E.

Macular degeneration is a disease state which may typically occur in patients of advanced age. In some examples, it may cause blurred or reduced central vision due to the breaking down of the inner layers of the macula. The macula is the part of the retina that gives the eye clear vision in the direct line of sight. The macula surrounds and includes the central fovea. The central fovea contains only cone cells whereas the rest of the macula includes both rods and cones. Referring to FIG. 33F, age related “dry” macular degeneration may result in degradation 3350 in various regions of the macula 3351. Some regions 3352 of the macula and the retina may be relatively free of defects, in some examples. Referring now to FIG. 33G, the exemplary landscape scene is depicted with simulated image effects 3354 due to the various degeneration regions which may affect the central vision as well as having some effect in the peripheral region.

“Wet” macular degeneration is characterized by a substantial amount of damage in the middle parts of the macula with less amounts of damage in the peripheral regions. Proceeding to FIG. 33H, an exemplary illustration of the type of damage is portrayed with substantial central damage 3355. There may be locations in other regions of the macula with regional damage 3356. The effects of the damage on the macula and other portions of retina in “Wet” macular degeneration is portrayed for example in FIG. 33I. There may be significant and pervasive impact on the central vision capability as illustrated by the significant image blurring 3357 portrayed. As well, there may be regions in the periphery 3358 with largely unaffected vision. In some examples, patients with “Wet” macular degeneration, who may be technically blinded by the affliction, may train themselves to utilize their peripheral vision to gain some ability to see. For example, by moving close to an elevator button while keeping it in the peripheral vision it may be possible for a patient to recognize an indicator on the elevator button. Use of the peripheral vision may be possible in some examples, but such attempts lack a true use of image focusing and other such vision support and may be limited in function.

Another disease state of the retina is strokes of the eye. The blood flow to the retina can be important for the health of ophthalmic cells, as well as a patient's associated vision. In some embodiments, an occlusion or clot in a patient may form or move to one or more of the veins or arteries of the retina. When an occlusion occurs in the arteries the blood flow may be cut off from a portion of the retina and accordingly be damaged. Depending on the degree of the lack of blood flow and the duration, significant or complete damage can ensue to the region affected. When the damage occurs in the macula the disease may be characterized as central retinal artery occlusion (CRAO). Referring now to FIG. 33J, a cross section of a normal retina in the region of the macula is illustrated. The thin spot of the central fovea 3360 is apparent in the cross section. Referring to FIG. 33K, a normal vision result is again illustrated for reference. An arterial occlusion may damage a region of the retina as illustrated in FIG. 33L. The damage may be reflected by swelling in the region of the occlusion, which in the example, may be in the macula. The associated thickening 3361 in the retinal layers is illustrated in cross section in FIG. 33M. The damage may result in a significantly affected view for the eye as illustrated in FIG. 33N. Although such an occlusion may result in significant blindness and loss of vision acuity, in some cases there are still portions of the retina that may function for detection of light and images; however, they may be in portions of the retina that the natural vision system does not bring images to focus on.

A similar disease state of the retina involving an occlusion of blood flow may occur when an occlusion of blood flow occurs in a vein. Since such an occlusion blocks the flow of blood away from a region of the retina, the effects of such an occlusion may be different. The oxygenated blood flow from the arteries may be affected by a vein occlusion but another effect in the blood system is that pressure builds up in the vessels. In some examples, the pressure may cause effusion of blood out of the vessels and into the vitreous of the eyeball in the region of the retina. Thus, there may be regions of image effect due to damage to the cells as well as an impact on vision due to the blood deposits.

Referring now to FIG. 33O, a schematic illustration of a view of a retina that may have been affected by a coronary vein blockage is illustrated. The occlusion may impact cells in a proximate region 3362. The damage in the proximate region 3362 of the vein occlusion may be severe in some examples, and may be at least partially transitory in some other examples. There may also be leakage of blood into the eye and some deposits may form upon the retina in the macula 3363 or in the region outside the macula 3364. In some examples, the leakage from the blood vessels may diminish in size and effect over time. In some examples, there may be clear regions 3365 of the retina where the deposits have not moved. Proceeding to FIG. 33P, a simulation of the impact on the image seen with central retinal vein occlusions may be seen.

Another type of retinal damage may come from retinal detachment. Thin layers of retinal cells may pull away from their normal area of detachment. The causes of the detachment may range from eye injury and eye surgery (such as cataract surgery) to other factors such as aging, extreme myopia, familial factors, and the like. The damage may be an urgent issue, and surgery is typically performed in rapid timing to restore as much the retinal state or to prevent further progression into the macula. Even with a restoration, there may be effects to the vision as illustrated in FIGS. 33Q, 33R and 33S. As illustrated in FIG. 33Q, there may be various new floaters 3370,3371 in vision that may result from light path blockages. As illustrated in FIG. 33R, there may be various shadows 3372,3373 in vision that may result from damage as well as from light path blockages. As illustrated in FIG. 33S, there may be a shading effect 3374 in vision that may result from damage as well as from light path blockages.

### Customized Lenses for Retinal Damage Cases

As has been mentioned throughout the present disclosure, methods of forming customized ophthalmic lenses by the additive manufacturing of lens forming material may be employed for designs of a lens end product. Accordingly, there may be numerous designs of customized lenses that may be made with these techniques to provide improvement of aspects of vision for cases where a retina has been damaged.

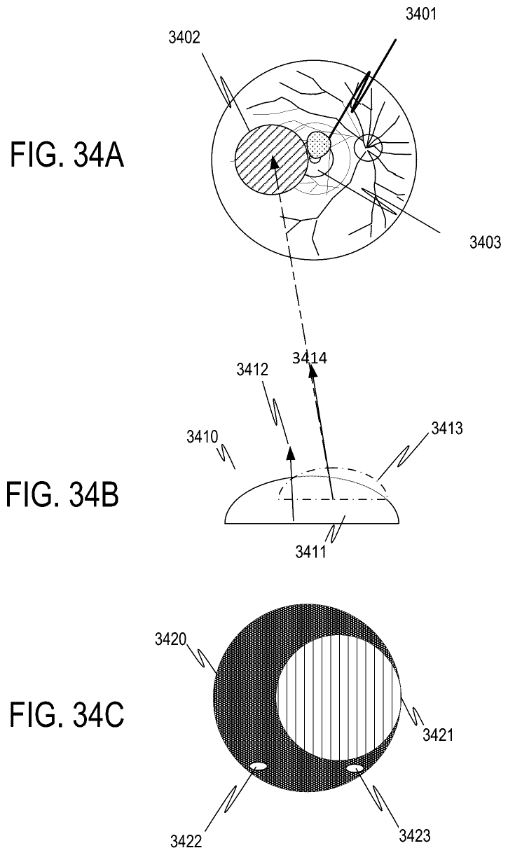

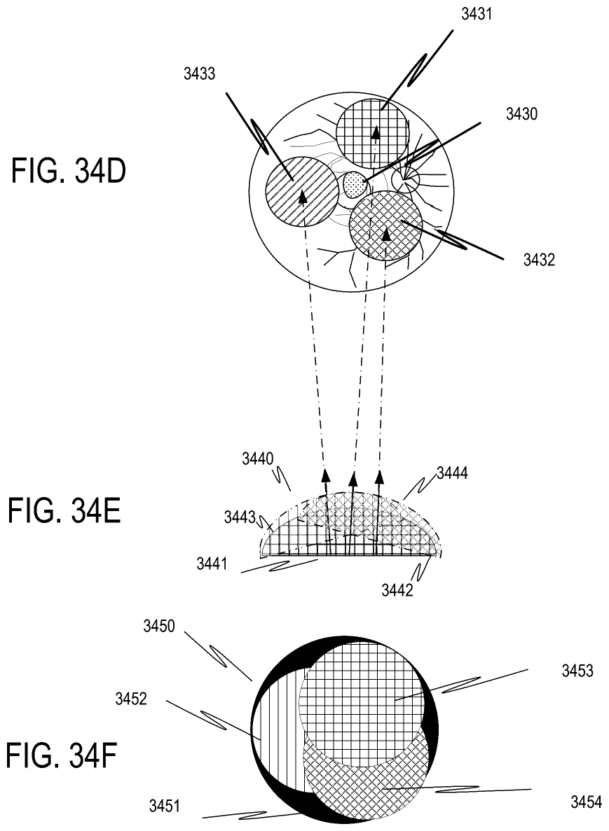

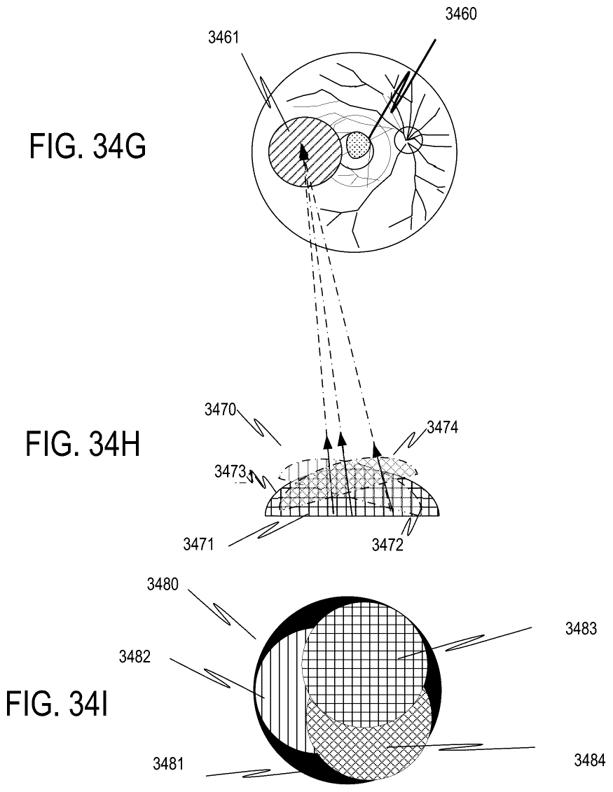

Referring now to FIG. 34A, in some exemplary embodiments, a retina may have significant damage 3401 in the macular region 3403.

Referring also to FIG. 34B, a depiction of an exemplary lens 3410 that may assist a patient with such a condition is illustrated. The exemplary lens 3410 may include an optical sub-element 3413 upon a base lens aspect 3411 to focus and direct 3414 the image (through the patient's crystalline lens) to a focal point other than the central fovea of the macular region 3403, but rather to a neighboring region 3402 that may be freer of damage. The base design 3411 of the exemplary lens 3410 may typically direct 3412 an image towards the central fovea of the macular region. The optical sub-element 3413 may then direct 3414 the image to the neighboring region 3402. Referring also to FIG. 34C, the base design 3411 is illustrated in a top view of the base design 3420 with an included top view of the optical sub-element 3421.

The optical sub-element 3413 may direct the image to a different location by a number of means. In a first example, the printed shape of the optical sub-element may be used. In a second example, a grading of the refractive index of material printed may be used to form a focusing element. In a third example, a Fresnel type structure may be employed. In some examples, the direction may be realized by a combination of these different types of examples.

There may be image rays that interact with both the base design 3411 and are directed 3412 to the central fovea of the macular region as well as to the optical sub-element 3413 where they are directed 3414 to a neighboring region 3402. Accordingly, in some examples, the base design 3420 portions that are not under the optical sub-element 3421 may include colorant to block light from being focused to the macular region. In some examples, it may provide a clearer image for a patient to process if the normal vision light path is blocked. Image redirection may include an image focused to more peripheral portions of a user's retina. As has been mentioned, these regions are typically populated with color insensitive rod cells. Accordingly, the imagery may be monochromatic and not as sharp as a normal vision, but when vision loss is significant the trade off may still be desirable.

A change in focal direction to different parts of the retina may present the patient's optical processing portions of the brain with an unfamiliar situation and learning may be required to process the imagery. Such learning in patients with significant central vision loss, does occur with the use of peripheral imaging alone. A focused image being projected onto the peripheral retina, however, may be a superior visual result.

In some embodiments, a customized lens with one or more optical sub-elements provides an enhanced vision experience when worn by a user. In some embodiments, an orientation of an ophthalmic device according to the present invention may be maintained in a static position. Structural features may be included in the ophthalmic device to stabilize the ophthalmic lens in a desired orientation as the ophthalmic device is worn.

In some embodiments, a magnification status may also be chosen and designed into an ophthalmic device since the density of rod cells in the periphery of the macular region may be reduced. Furthermore, since the rod cells may be significantly more sensitive to light levels, there may also be a level of shading incorporated into the optical sub-element.

As well, since the optical path proceeds through the patient's cornea and crystalline lens the design of the custom lens may include patient specific inputs for the sizing parameters of the crystalline lens and surface shape of the cornea. In some examples, ophthalmic refractometry measurement, keratometry, or corneal topography measurements may be used to profile the lens. The results could be used as an input to model creation for the lens manufacture. In some examples, retinal imaging techniques could be used to assess the portions of the retina that are damaged. Such a mapping of damaged portions of an eye may be quantified and referenced to map images to alternate portions of a user's eye. Input including damaged portions may be used in creating the model for manufacturing the customized lens such that it may map an image through the cornea and crystalline lens to a desired non-central portion of a patient's retina. Control commands to a printhead or other additive manufacturing machine may be generated based upon the generate optical sub-elements that direct images to the relatively less damaged portions of a user's retina, or healthy portions of the user's retina.

In some examples, the action portions of the eye including focusing with the crystalline lens and adjusting of the pupil diameter may still function to a degree with images that are projected off center of the eye. In clinical studies, a concept of a pseudo-fovea may be observed, the theory of which is that the brain responds to the lack of image data from a damaged or “experimentally blocked” central fovea by looking to other photoreceptor cells to act in a similar manner for feedback aspects. A lens of the type described herein may present a clear alternative image for brain adjustment.

The portions of the retina that are projected to at an angle off from the central fovea may be comprised dominantly with rod cells which are more sensitive at lower photon levels then the predominantly cone cells of the central fovea. Feedback functions related to focus and light level and also the basic recognition of imagery may be facilitated if the light levels to areas other than the newly targeted regions of the retina are minimized.

Coloration of portions of the lens outside the optical sub-element may be included in some embodiments of the present invention. Coloration may be accomplished, for example, via the addition of pigments, dyes, or colorants to the polymerizable mixture (PM) used for printing of those portions.

In some embodiments, coloration may be included inside the optical sub-element since less light is required by the photosensitive rod cells outside the central fovea. In some examples, a light sensitive pigment, dye, or photoactive substance may be incorporated within the sub optical element to regulate a light level that traverses the element. To accomplish this, a different polymerizable mixture (PM) may be used for printing of the optical sub-element. With colorant (including opaque shading or partially transparent colorant) outside the optical sub-element, the patient's brain may develop unique responses to a newly focused image locus resulting from viewing through the ophthalmic lens with optical sub-elements.

A patient may be trained to “see” with the altered imagery in order to facilitate vision capability in patients with damaged retinas as have been described. In particular these strategies of redirected imagery with a single optical sub-element may be particularly useful for damage cases where the central fovea and other portions of the macula may be impacted. An additional improvement may result if the lens has alignment features added to it to help maintain a registered position when worn upon the eye of the patient. Referring again to FIG. 34C exemplary alignment features 3422 and 3423 are depicted.

Referring now to FIG. 34D, an exemplary depiction of a damaged retina, where a central damage 3430 is illustrated. In some embodiments, multiple optical sub-elements may be useful for patients with damage to the retina. Accordingly, multiple regions 3431, 3432, and 3433 may be included with imagery projected upon non-damaged or less damaged regions of a patient's retina. Different projections may be made by multiple optical sub-elements.

Referring now to FIG. 34E, a cross section 3440 of a lens with multiple optical sub-elements 3442, 3443, and 3444 designed upon a standard base element 3441 is illustrated. As with the previous examples, the base element may have high levels of shading to essentially block photons from proceeding except where optical sub-elements are located.

Referring to FIG. 34F a top view of a lens 3450 with multiple optical sub-elements printed is illustrated with a colored base element 3451 and three optical sub-elements 3452, 3453 and 3454 also included. A lens of this type may be used to provide a peripheral retina portion of an eye with different views from an environment of a wearer. Different views may be presented by the optical sub-elements 3452, 3453 and 3454 to different locations. In some examples, a same view of focus may be presented to a wearer of such a lens, but with different focal planes being present. In other examples, images from the same focal plan may be presented but where different parts of the view plane are collected by the different optical sub-elements.

In some examples, a same focal plan and view plane may be presented, but different levels of shading or other colorant may be incorporated for the different optical sub-elements to allow for different sensitivity for the ambient light levels. The shading or colorant may also include photosensitive dyes that may react to the intensity of the ambient light. Multiple views may be presented to different regions of the retina. In some embodiments, the retina may be scanned with metrology tools to determine areas with least damage and light directed to these areas. As appropriate, alignment features may also be useful to maintain a relatively fixed orientation of the lens upon the eye.

Referring now to FIG. 34G, an exemplary multiple optical sub-element-based lens is illustrated with multiple optical sub-elements directed to a same focal locus. A schematic depiction of a damaged retina, where a central damage 3460 is illustrated. In some examples, there may be a single region 3461 where imagery is projected upon the non-damaged or less damaged regions of the retina. In still further examples, such as the case where thrombotic events occur on the periphery or where detachment occurs in the peripheral regions, the focal point of the single region 3461 may still be the central fovea. Different projections may be made by multiple optical sub-elements.

Referring to FIG. 34H, a cross section 3370 of a lens with multiple optical sub-elements 3472, 3473, and 3474 designed upon a standard base element 3471 is illustrated. As with previous examples, a base element may have high levels of colorant to provide shading to essentially block photons from proceeding except where optical sub-elements are located.

Referring to FIG. 34I a top view of a lens 3480 with multiple optical sub-elements 3482, 3483, 3484 formed with a colored base element 3481 and three optical sub-elements 3482, 3483, and 3484 included.

An ophthalmic device with multiple optical sub-elements 3482, 3483, 3484 may be used to present a peripheral retina portion of an eye with a same view from the environment of a wearer, via various paths of light that image rays passing through the different optical sub-elements take. In some cases of damaged eyes, there may be scarred tissue, blood deposits, and generalized floaters in the vitreous of the damaged eye that manifest as impacts to the vision of the patient. In the exemplary lenses with multiple optical sub-elements, where the different views are presented to a single location with different paths, the impact of a material blocking a ray along a path may be minimized since they travelled along a different focal path. The result may be an average of images where the information that is normally blocked by the material in the ray path is still provided along one of the alternative paths. Depending on the whether the locus of the images is the central fovea or a peripheral portion of the retina there may be levels of shading incorporated into the sub-elements during their printing.

In some embodiments, where a central fovea is damaged, a retinal scan of various metrology types may be used to determine optimal locations for an image locus in a design of an ophthalmic device. Colorant, pigments, or other shading may include photosensitive materials that react to the intensity of the ambient light. As appropriate, alignment features may also be useful to maintain a relatively fixed orientation of the lens when worn upon the eye.

Although the present description and claims occasionally refer to a mixture (such as a polymerizable mixture), an initiator, other additives, it is within the scope of this invention that the materials and compositions defined herein may comprise one, two, or more types of individual constituents. In such embodiments, a total amount of a respective constituent should correspond to an amount defined above for the individual constituent.

The(s) in the expressions: mixture(s), initiator(s), etc. indicates that one, two, or more types of the individual constituents may be present. On the other hand, when the expression one is used, only one (1) of the respective constituent is present.

It should be understood that the expression % means the percentage of the respective component by weight, unless otherwise noted.

### CONCLUSION

A number of embodiments of the present disclosure have been described. While this specification contains many specific implementation details, there should not be construed as limitations on the scope of any disclosures or of what may be claimed, but rather as descriptions of features specific to particular embodiments of the present disclosure.

Certain features that are described in this specification in the context of separate embodiments can also be implemented in combination in a single embodiment. Conversely, various features that are described in the context of a single embodiment can also be implemented in combination in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous.

Moreover, separation of various system components in the embodiments described above should not be understood as requiring such separation in all embodiments, and it should be understood that the described program components and systems can generally be integrated together in a single hardware and/or software product or packaged into multiple products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order show, or sequential order, to achieve desirable results. In certain implementations, multitasking and parallel processing may be advantageous. Nevertheless, it will be understood that various modifications may be made without departing from the spirit and scope of the claimed disclosure.

What is claimed is:

1. A method of forming an ophthalmic device for improving a vision capability, the method comprising the steps of:
a. referencing a model of an optical sub-element effective to focus light on a first portion of a retina, generating a printer control command to form the optical sub-element;
b. emitting a first volume of polymerizable mixture from a printhead as a first pattern of droplets based upon the printer control command;
c. receiving the first volume of polymerizable mixture onto a first receiving surface;
d. performing a pinning process on the first volume of polymerizable mixture;
e. emitting a second volume of polymerizable mixture from the printhead as a second pattern of droplets;
f. receiving the second volume of polymerizable mixture onto a second receiving surface comprising the first volume of polymerizable mixture to form a combined volume of polymerizable mixture;
g. performing an intermittent cure on the combined volume of polymerizable mixture, the intermittent cure forming polymer chains, including the first volume of polymerizable mixture and the second volume of polymerizable mixture; and
h. performing a final cure on the combined volume of polymerizable mixture to form the ophthalmic device.

2. The method of claim 1, additionally comprising the steps of: referencing a retinal scan, determining at least a first portion of the retina represented by the retinal scan to project an image upon; generating the printer control command for the printhead to form an optical sub element suitable to project the image upon the first portion of the retina.

3. The method of claim 1, wherein the second volume of polymerizable mixture forms the optical sub-element.

4. The method of claim 3, wherein the second volume of polymerizable mixture comprises a pigment, wherein the pigment creates a shading level for light passing through the optical sub-element.

5. The method of claim 4, additionally comprising emitting a third volume of polymerizable mixture comprising a sufficient amount of pigment to create an opaque layer blocking light from passing through areas receiving the third volume of polymerizable mixture.

6. The method of claim 5, wherein the third volume of polymerizable mixture is received upon portions of a third receiving surface not including the optical sub-element.

7. The method of claim 3, wherein the second volume of polymerizable mixture is received on the second receiving surface in a shape comprising that directs images to the first portion of the retina.

8. The method of claim 3, wherein the second volume of polymerizable mixture is received on the second receiving surface in a shape comprising a component of a Fresnel lens.

9. The method of claim 3, wherein the second volume of polymerizable mixture comprises a substance that changes an index of refraction of the second volume of polymerizable mixture.

10. The method of claim 1, further comprising the step of hydrating the ophthalmic device in a saline solution.

11. The method of claim 1, further comprising the steps of:
a. determining at least a first portion of the retina sufficiently healthy to project an image upon; and
b. with the printhead, forming at least two optical sub-elements for focusing images on the first portion of the retina.

12. The method of claim 11, wherein the second volume of polymerizable mixture comprises a colorant comprising a shading level for light passing through at least one of the at least two optical sub-elements.

13. The method of claim 12, wherein a third volume of polymerizable mixture deposited by the printhead comprises a sufficient amount of colorant to create an opaque level blocking light passing through the third volume of polymerizable mixture.

14. The method of claim 13, wherein the third volume of polymerizable mixture is deposited upon portions of the ophthalmic device that do not include the at least two optical sub-elements.

15. The method of claim 13, wherein the second volume of polymerizable mixture is used to print a shape that directs the images to the first portion of the retina sufficiently healthy to project the image upon.

16. The method of claim 15, wherein the second volume of polymerizable mixture is further processed to vary its index of refraction.

17. An apparatus for improving a vision capability, the apparatus comprising:
a base lens structure formed of a polymerized mixture, wherein the base lens structure comprises a size to fit upon a user's eye, and wherein a lower face of the base lens structure comprises a shape defined by a receiving surface upon which a polymerizable mixture is deposited;
an optical sub-element formed to direct images to a region not centered on a central axis of the lower face of the base lens structure; and
when worn by a user, the base lens structure and optical sub-elements focus the images to a portion of a retina not centered upon a central fovea of the user's eye.

18. The apparatus for improving a vision capability of claim 17, wherein a design of the optical sub-element is based upon a retinal scan of the user.

19. The apparatus of claim 17, comprising multiple optical sub-elements directing the images to multiple portions of the retina.

20. The apparatus of claim 19, comprising a portion opaque to light.
